(19) United States
(12) Patent Application Publication
(10) Pub. No.: US 2025/0053375 A1
(43) Pub. Date: Feb. 13, 2025

(54) DEVICE, METHOD, AND GRAPHICAL USER INTERFACE FOR ENABLING CONVERSATION PERSISTENCE ACROSS TWO OR MORE INSTANCES OF A DIGITAL ASSISTANT

(71) Applicant: Apple Inc., Cupertino, CA (US)

(72) Inventors: David CARSON, San Francisco, CA (US); Evan DIBIASE, Pittsburgh, PA (US); Thomas R. GRUBER, Santa Cruz, CA (US); Marco IACONO, San Francisco, CA (US); Daniel KEEN, San Jose, CA (US); Stephen O. LEMAY, Palo Alto, CA (US); Donald W. PITSCHEL, San Francisco, CA (US); Harry J. SADDLER, Berkeley, CA (US)

(21) Appl. No.: 18/812,994

(22) Filed: Aug. 22, 2024

Related U.S. Application Data
(63) Continuation of application No. 17/343,288, filed on Jun. 9, 2021, now Pat. No. 12,073,147.
Application No. 17/343,288 is a continuation of application No. 16/204,178, filed on Nov. 29, 2018, now Pat. No. 11,048,473.
Application No. 16/204,178 is a continuation of application No. 14/298,714, filed on Jun. 6, 2014, now Pat. No. 10,185,542.
(60) Provisional application No. 61/832,898, filed on Jun. 9, 2013.

(51) Int. Cl. G06F 3/16; G06F 3/04842; G06F 16/33

(52) U.S. Cl. CPC G06F 3/167; G06F 3/04842; G06F 16/3344

(57) ABSTRACT

An electronic device with one or more processors and memory includes a procedure for enabling conversation persistence across two or more instances of a digital assistant. In some embodiments, the device displays a first dialogue in a first instance of a digital assistant user interface. In response to a request to display a user interface different from the digital assistant user interface, the device displays the user interface different from the digital assistant user interface. In response to a request to invoke the digital assistant, the device displays a second instance of the digital assistant user interface, including displaying a second dialogue in the second instance of the digital assistant user interface, where the first dialogue remains available for display in the second instance of the digital assistant user interface.

### CROSS-REFERENCE TO RELATED APPLICATION

This application is a continuation of U.S. Ser. No. 17/343,288, filed on Jun. 9, 2021, entitled DEVICE, METHOD, AND GRAPHICAL USER INTERFACE FOR ENABLING CONVERSATION PERSISTENCE ACROSS TWO OR MORE INSTANCES OF A DIGITAL ASSISTANT, which is a continuation of U.S. Ser. No. 16/204,178, filed on Nov. 29, 2018, now U.S. Pat. No. 11,048,473, entitled DEVICE, METHOD, AND GRAPHICAL USER INTERFACE FOR ENABLING CONVERSATION PERSISTENCE ACROSS TWO OR MORE INSTANCES OF A DIGITAL ASSISTANT, which is a continuation of U.S. Ser. No. 14/298,714, filed on Jun. 6, 2014, now U.S. Pat. No. 10,185,542, entitled DEVICE, METHOD, AND GRAPHICAL USER INTERFACE FOR ENABLING CONVERSATION PERSISTENCE ACROSS TWO OR MORE INSTANCES OF A DIGITAL ASSISTANT, which claims priority from U.S. Provisional Ser. No. 61/832,898, filed on Jun. 9, 2013, entitled DEVICE, METHOD, AND GRAPHICAL USER INTERFACE FOR ENABLING CONVERSATION PERSISTENCE ACROSS TWO OR MORE INSTANCES OF A DIGITAL ASSISTANT. The entire contents of each of these applications are hereby incorporated by reference in their entireties for all purposes.

### TECHNICAL FIELD

The disclosed embodiments relate generally to digital assistant systems, and more specifically, to context and/or conversation persistence.

### BACKGROUND

Just like human personal assistants, digital assistant systems can perform requested tasks and provide requested advice, information, or services. A digital assistant system's ability to fulfill a user's request is dependent on the digital assistant system's correct comprehension of the request or instructions. Recent advances in natural language processing have enabled users to interact with digital assistant systems using natural language, in spoken or textual forms. Such digital assistant systems can interpret the user's input to infer the user's intent, translate the inferred intent into actionable tasks and parameters, execute operations or deploy services to perform the tasks, and produce output that is intelligible to the user. Ideally, the output produced by a digital assistant system should fulfill the user's intent expressed during the natural language interaction between the user and the digital assistant system.

The ability of a digital assistant system to produce satisfactory responses to user requests depends on the natural language processing, knowledge base, and artificial intelligence available to the digital assistant system. Moreover, while numerous third party systems and services currently exist, there is no efficient means for a digital assistant system to enable context and/or conversation persistence across two or more non-continuous instances of a digital assistant.

### SUMMARY

The embodiments disclosed herein provide methods, devices, systems, and non-transitory computer readable storage media for operating a digital assistant so as to enable context and/or conversation persistence.

Accordingly, some embodiments provide a method of operating a digital assistant, performed at an electronic device having a display, one or more processors and memory storing one or more programs for execution by the one or more processors, the method comprising displaying a first dialogue in a first instance of a digital assistant user interface. In response to a request to display a user interface different from the digital assistant user interface, the method includes displaying the user interface different from the digital assistant user interface. In response to a request to invoke the digital assistant, the method further includes displaying a second instance of the digital assistant user interface, including displaying a second dialogue in the second instance of the digital assistant user interface, where the first dialogue remains available for display in the second instance of the digital assistant user interface.

In some embodiments, the method further comprising, prior to displaying the first instance of the digital assistant user interface: detecting a prior request to invoke the digital assistant; detecting a speech input; and providing a transcription of the speech input, where the first dialogue includes the transcription of the speech input.

In some embodiments, the method further comprising, in response to the request to display the user interface different from the digital assistant user interface, ceasing to display the digital assistant user interface.

In some embodiments, the method further comprising: displaying a first affordance in the second instance of the digital assistant user interface; detecting a user selection of the first affordance; and in response to the user selection of the first affordance, displaying at least a portion of the first dialogue in the second instance of the digital assistant user interface.

In some embodiments, the method further comprising, displaying at least a portion of the first dialogue in the second instance of the digital assistant user interface.

In some embodiments, the method further comprising: displaying a second affordance corresponding to a respective sub-portion of the first dialogue; detecting a user selection of the second affordance; and in response to the user selection of the second affordance, ceasing to display at least some of the respective sub-portion of the first dialogue.

In some embodiments, the method further comprising, in response to the user selection of the second affordance, excluding context data associated with the sub-portion of the first dialogue from a context history of the digital assistant.

In some embodiments, the method further comprising: storing context data associated with the first dialogue in a context history of the digital assistant; determining whether the request to invoke the digital assistant satisfies a first predetermined condition; and in accordance with a determination that the request to invoke the digital assistant satisfies the first predetermined condition, invoking the stored context data while displaying the second instance of the digital assistant user interface.

In some embodiments, the first predetermined condition is satisfied when the request to invoke the digital assistant is received within a predetermined context expiration time period.

In some embodiments, the method further comprising, deleting the context data associated with the first dialogue from the context history upon expiration of the predetermined context expiration time period.

In some embodiments, the first predetermined condition is not satisfied when the electronic device is locked.

In some embodiments, the second dialogue includes a user query to the digital assistant, and the method further comprises: storing context data associated with the first dialogue in a context history of the digital assistant; and while displaying the second instance of the digital assistant user interface, in accordance with a determination that a predetermined context condition has been satisfied, responding to the user query to the digital assistant using the stored context data while determining a response to the user query.

In some embodiments, the predetermined context condition is satisfied when, in response to a user action performed during display of the second instance of the digital assistant user interface, at least a portion of the first dialogue is displayed in the second instance of the digital assistant user interface.

In some embodiments, the method further comprising: determining whether the request to invoke the digital assistant satisfies a second predetermined condition; in accordance with a determination that the request to invoke the digital assistant satisfies the second predetermined condition, displaying the second instance of the digital assistant user interface, including displaying the second dialogue in the second instance of the digital assistant user interface, wherein the first dialogue remains available for display in the second instance of the digital assistant user interface; and in accordance with a determination that the request to invoke the digital assistant does not satisfy the second predetermined condition, displaying the second instance of the digital assistant user interface without making the first dialogue available for display in the second instance of the digital assistant user interface.

In some embodiments, the second predetermined condition is satisfied when the request to invoke the digital assistant is received within a predetermined conversation expiration time period.

In some embodiments, the method further comprising: storing context data associated with the first dialogue in a context history of the digital assistant; determining whether the request to invoke the digital assistant satisfies a first predetermined condition, wherein the first predetermined condition is satisfied when the request to invoke the digital assistant is received within a predetermined context expiration time period; in accordance with a determination that the request to invoke the digital assistant satisfies the first predetermined condition, invoking the stored context data while displaying the second instance of the digital assistant user interface; and deleting the context data associated with the first dialogue from the context history upon expiration of the predetermined context expiration time period, where the predetermined context expiration time period is shorter than the predetermined conversation expiration time period.

In some embodiments, the second predetermined condition is not satisfied when the electronic device is locked.

In some embodiments, the second predetermined condition comprises a condition that is satisfied when the request to invoke the digital assistant is received prior to detection of a predetermined number of user interactions with the electronic device after displaying the first dialogue.

In some embodiments, the request to display the user interface different from the digital assistant user interface corresponds to a user input to display the user interface different from the digital assistant user interface.

In some embodiments, the user input to display the user interface different from the digital assistant user interface corresponds to a request to launch an application.

In some embodiments, the user interface different from the digital assistant user interface does not correspond to the digital assistant.

In some embodiments, the user interface different from the digital assistant user interface is associated with an application distinct from the digital assistant.

Some embodiments provide a method of operating a digital assistant, performed at two or more electronic devices each having a display, one or more processors and memory storing one or more programs for execution by the one or more processors, the method comprising, displaying a first dialogue in a first user interface of a digital assistant at a first device. At a second device different from the first device, the method further comprising, displaying a second dialogue in a second user interface of the digital assistant in response to a request to invoke the digital assistant on the second device, where the first dialogue is available for display in the second user interface.

In accordance with some embodiments, a non-transitory computer readable storage medium has stored therein instructions, which, when executed by an electronic device, cause the device to perform the operations of any of the methods described above. In accordance with some embodiments, an electronic device includes one or more processors, memory, and one or more programs; the one or more programs are stored in the memory and configured to be executed by the one or more processors and the one or more programs include instructions for performing the operations of any of the methods described above. In accordance with some embodiments, a graphical user interface on an electronic device with a display, a memory, and one or more processors to execute one or more programs stored in the memory, the graphical user interface comprising user interfaces displayed in accordance with any of the methods described above. In accordance with some embodiments, an electronic device includes means for performing the operations of any of the methods described above. In accordance with some embodiments, an information processing apparatus, for use in an electronic device includes means for performing the operations of any of the methods described above.

In accordance with some embodiments, an electronic device includes a touch screen display unit configured to display a user interface and to receive touch input and a sound receiving unit configured to receive sound input. The electronic device also includes a processing unit coupled to the touch screen display unit and the sound receiving unit. The processing unit is configured to enable display of a first dialogue in a first instance of a digital assistant user interface on the touch screen display unit. In response to a request to enable display of a user interface different from the digital assistant user interface, the processing unit is configured to enable display of the user interface different from the digital assistant user interface. In response to a request to invoke the digital assistant, the processing unit is further configured to enable display of a second instance of the digital assistant user interface on the touch screen display unit, including enabling display of a second dialogue in the second instance of the digital assistant user interface, where the first dialogue remains available for display in the second instance of the digital assistant user interface.

In accordance with some embodiments, a system includes two or more electronic devices. A first electronic device includes a touch screen display unit configured to display a user interface and to receive touch input, and a sound receiving unit configured to receive sound input. The first electronic device also includes a processing unit coupled to the touch screen display unit and the sound receiving unit. A second electronic device includes a touch screen display unit configured to display a user interface and to receive touch input and a sound receiving unit configured to receive sound input. The second electronic device also includes a processing unit coupled to the touch screen display unit and the sound receiving unit. The processing unit of the first electronic device is configured to enable display of a first dialogue in a first user interface of a digital assistant on the touch screen display unit. In response to a request to invoke the digital assistant on the second electronic device, the processing unit of the second electronic device is configured to enable display of a second dialogue in a second user interface of the digital assistant on the touch screen display unit, where the first dialogue is available for display in the second user interface.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram illustrating an environment in which a digital assistant operates in accordance with some embodiments.

FIG. 2 is a block diagram illustrating a digital assistant client system in accordance with some embodiments.

FIG. 3A is a block diagram illustrating a digital assistant system or a server portion thereof in accordance with some embodiments.

FIG. 3B is a block diagram illustrating functions of the digital assistant shown in FIG. 3A in accordance with some embodiments.

FIG. 3C is a diagram of a portion of an ontology shown in FIG. 3B in accordance with some embodiments.

FIG. 4 is a block diagram of a persistence module shown in FIG. 3B in accordance with some embodiments.

FIGS. 5A-FOO illustrate exemplary user interfaces for enabling context and/or conversation persistence in accordance with some embodiments.

FIGS. 6A-6D illustrate a flow diagram for an exemplary process of enabling context and/or conversation persistence in accordance with some embodiments.

FIG. 7 illustrates a block diagram of a system including two or more electronic devices for enabling context and/or conversation persistence in accordance with some embodiments.

FIG. 8 illustrates a flow diagram for an exemplary process of enabling context and/or conversation persistence between two or more electronic devices in accordance with some embodiments.

FIG. 9 is a functional block diagram of an electronic device in accordance with some embodiments.

FIG. 10 is a functional block diagram of an electronic device in accordance with some embodiments.

Like reference numerals refer to corresponding parts throughout the drawings.

### DESCRIPTION OF EMBODIMENTS

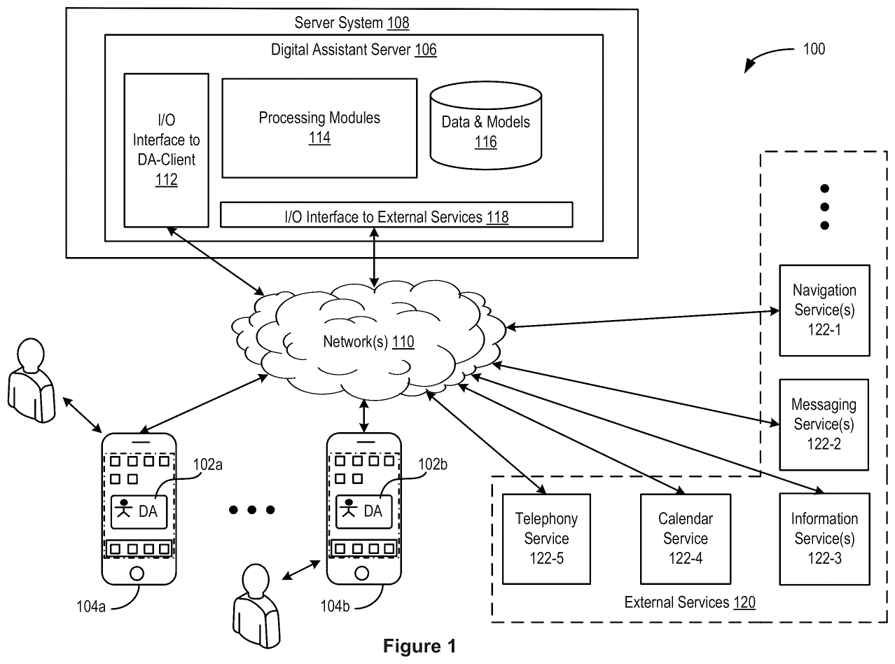

FIG. 1 is a block diagram of an operating environment 100 of a digital assistant according to some embodiments. The terms “digital assistant,” “virtual assistant,” “intelligent automated assistant,” or “automatic digital assistant,” refer to any information processing system that interprets natural language input in spoken and/or textual form to infer user intent, and performs actions based on the inferred user intent. For example, to act on an inferred user intent, the system can perform one or more of the following: identifying a task flow with steps and parameters designed to accomplish the inferred user intent; inputting specific requirements from the inferred user intent into the task flow; executing the task flow by invoking programs, methods, services, APIs, or the like; and generating output responses to the user in an audible (e.g., speech) and/or visual form.

Specifically, a digital assistant (DA) is capable of accepting a user request at least partially in the form of a natural language command, request, statement, narrative, and/or inquiry. Typically, the user request seeks either an informational answer or performance of a task by the digital assistant. A satisfactory response to the user request is either provision of the requested informational answer, performance of the requested task, or a combination of the two. For example, a user may ask the digital assistant a question, such as “Where am I right now?” Based on the user's current location, the digital assistant may answer, “You are in Central Park.” The user may also request the performance of a task, for example, “Please remind me to call Mom at 4 PM today.” In response, the digital assistant may acknowledge the request and then create an appropriate reminder item in the user's electronic schedule. During performance of a requested task, the digital assistant sometimes interacts with the user in a continuous dialogue involving multiple exchanges of information over an extended period of time. There are numerous other ways of interacting with a digital assistant to request information or performance of various tasks. In addition to providing verbal responses and taking programmed actions, the digital assistant also provides responses in other visual or audio forms (e.g., as text, alerts, music, videos, animations, etc.).

An example of a digital assistant is described in Applicant's U.S. Utility application Ser. No. 12/987,982 for “Intelligent Automated Assistant,” filed Jan. 10, 2011, the entire disclosure of which is incorporated herein by reference.

As shown in FIG. 1, in some embodiments, a digital assistant is implemented according to a client-server model. The digital assistant includes a client-side portion 102a, 102b (hereafter “DA-client 102”) executed on a user device 104a, 104b, and a server-side portion 106 (hereafter “DA-server 106”) executed on a server system 108. DA-client 102 communicates with DA-server 106 through one or more networks 110. DA-client 102 provides client-side functionalities such as user-facing input and output processing and communications with DA-server 106. DA server 106 provides server-side functionalities for any number of DA-clients 102 each residing on a respective user device 104.

In some embodiments, DA-server 106 includes a client-facing I/O interface 112, one or more processing modules 114, data and models 116, and an I/O interface to external services 118. The client-facing I/O interface facilitates the client-facing input and output processing for digital assistant server 106. One or more processing modules 114 utilize data and models 116 to determine the user's intent based on natural language input and perform task execution based on inferred user intent. In some embodiments, DA-server 106 communicates with external services 120 through the network(s) 110 for task completion or information acquisition. The I/O interface to external services 118 facilitates such communications.

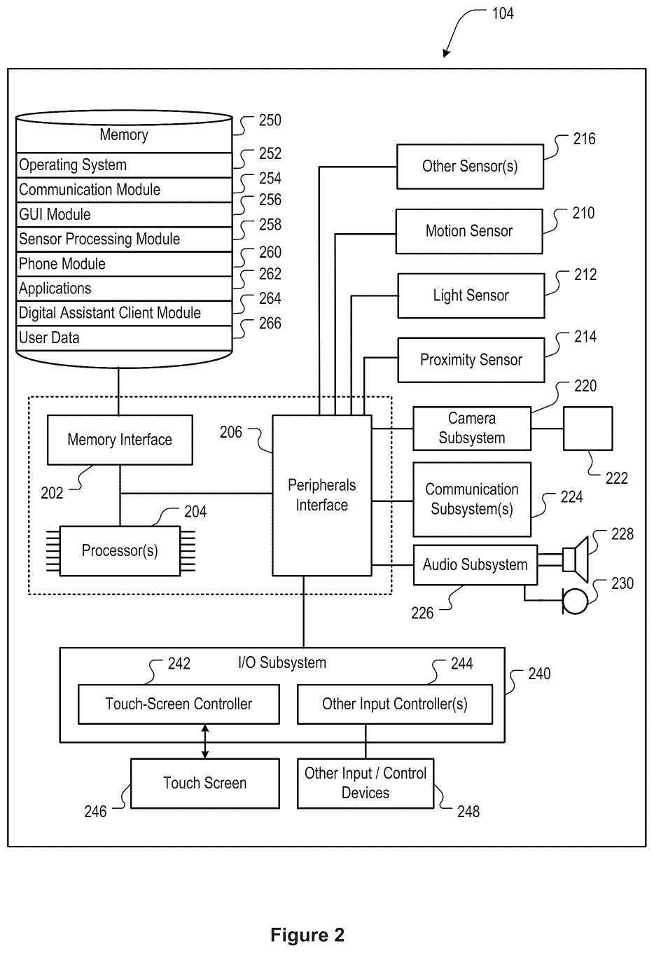

Examples of user device 104 include, but are not limited to, a handheld computer, a personal digital assistant (PDA), a tablet computer, a laptop computer, a desktop computer, a cellular telephone, a smart phone, an enhanced general packet radio service (EGPRS) mobile phone, a media player, a navigation device, a game console, a television, a remote control, or a combination of any two or more of these data processing devices or other data processing devices. More details on user device 104 are provided in reference to an exemplary user device 104 shown in FIG. 2.

Examples of the communication network(s) 110 include local area networks (“LAN”) and wide area networks (“WAN”) such as the Internet. Communication network(s) 110 are, optionally, implemented using any known network protocol, including various wired or wireless protocols, such as Ethernet, Universal Serial Bus (USB), FIREWIRE, Global System for Mobile Communications (GSM), Enhanced Data GSM Environment (EDGE), code division multiple access (CDMA), time division multiple access (TDMA), Bluetooth, Wi-Fi, voice over Internet Protocol (VOIP), Wi-MAX, or any other suitable communication protocol.

Server system 108 is implemented on one or more standalone data processing apparatuses or a distributed network of computers. In some embodiments, server system 108 also employs various virtual devices and/or services of third party service providers (e.g., third-party cloud service providers) to provide the underlying computing resources and/or infrastructure resources of server system 108.

Although the digital assistant shown in FIG. 1 includes both a client-side portion (e.g., DA-client 102) and a server-side portion (e.g., DA-server 106), in some embodiments, the functions of a digital assistant is implemented as a standalone application installed on a user device. In addition, the division of functionalities between the client and server portions of the digital assistant can vary in different embodiments. For example, in some embodiments, DA-client 102 is a thin-client that provides only user-facing input and output processing functions, and delegates all other functionalities of the digital assistant to a backend server.

FIG. 2 is a block diagram of a user-device 104 in accordance with some embodiments. User device 104 includes a memory interface 202, one or more processors 204, and a peripherals interface 206. The various components in user device 104 are coupled by one or more communication buses or signal lines. User device 104 includes various sensors, subsystems, and peripheral devices that are coupled to the peripherals interface 206. The sensors, subsystems, and peripheral devices gather information and/or facilitate various functionalities of user device 104.

For example, a motion sensor 210, a light sensor 212, and a proximity sensor 214 are coupled to the peripherals interface 206 to facilitate orientation, light, and proximity sensing functions. One or more other sensors 216, such as a positioning system (e.g., a GPS receiver), a temperature sensor, a biometric sensor, a gyroscope, a compass, an accelerometer, and the like, are also connected to peripherals interface 206, to facilitate related functionalities.

In some embodiments, a camera subsystem 220 and an optical sensor 222 are utilized to facilitate camera functions, such as taking photographs and recording video clips. Communication functions are facilitated through one or more wired and/or wireless communication subsystems 224, which can include various communication ports, radio frequency receivers and transmitters, and/or optical (e.g., infrared) receivers and transmitters. An audio subsystem 226 is coupled to speakers 228 and a microphone 230 to facilitate voice-enabled functions, such as voice recognition, voice replication, digital recording, and telephony functions.

In some embodiments, an I/O subsystem 240 is also coupled to peripheral interface 206. I/O subsystem 240 includes a touch screen controller 242 and/or other input controller(s) 244. Touch-screen controller 242 is coupled to a touch screen 246. Touch screen 246 and the touch screen controller 242 can, for example, detect contact and movement or break thereof using any of a plurality of touch sensitivity technologies, such as capacitive, resistive, infrared, surface acoustic wave technologies, proximity sensor arrays, and the like. Other input controller(s) 244 can be coupled to other input/control devices 248, such as one or more buttons, rocker switches, a thumb-wheel, an infrared port, a USB port, and/or a pointer device such as a stylus.

In some embodiments, memory interface 202 is coupled to memory 250. Memory 250 can include high-speed random access memory and/or non-volatile memory, such as one or more magnetic disk storage devices, one or more optical storage devices, and/or flash memory (e.g., NAND or NOR).

In some embodiments, the memory 250 stores an operating system 252, a communication module 254, a graphical user interface module 256, a sensor processing module 258, a phone module 260, and applications 262. Operating system 252 includes instructions for handling basic system services and for performing hardware dependent tasks. Communication module 254 facilitates communicating with one or more additional devices, one or more computers and/or one or more servers. Graphical user interface module 256 facilitates graphic user interface processing. Sensor processing module 258 facilitates sensor-related processing and functions. Phone module 260 facilitates phone-related processes and functions. Application module 262 facilitates various functionalities of user applications, such as electronic-messaging, web browsing, media processing, navigation, imaging and/or other processes and functions.

As described in this specification, memory 250 also stores client-side digital assistant instructions (e.g., in a digital assistant client module 264) and various user data 266 (e.g., user-specific vocabulary data, preference data, and/or other data such as the user's electronic address book, to-do lists, shopping lists, etc.) to provide the client-side functionalities of the digital assistant.

In various embodiments, digital assistant client module 264 is capable of accepting voice input (e.g., speech input), text input, touch input, and/or gestural input through various user interfaces (e.g., I/O subsystem 244) of user device 104. Digital assistant client module 264 is also capable of providing output in audio (e.g., speech output), visual, and/or tactile forms. For example, output can be provided as voice, sound, alerts, text messages, menus, graphics, videos, animations, vibrations, and/or combinations of two or more of the above. During operation, digital assistant client module 264 communicates with the digital assistant server using communication subsystems 224.

In some embodiments, digital assistant client module 264 utilizes the various sensors, subsystems and peripheral devices to gather additional information from the surrounding environment of user device 104 to establish a context associated with a user, the current user interaction, and/or the current user input. In some embodiments, digital assistant client module 264 provides the context information or a subset thereof with the user input to the digital assistant server to help infer the user's intent. In some embodiments, the digital assistant also uses the context information to determine how to prepare and deliver outputs to the user.

In some embodiments, the context information that accompanies the user input includes sensor information, such as lighting, ambient noise, ambient temperature, images or videos of the surrounding environment, and the like. In some embodiments, the context information also includes the physical state of user device 104 (e.g., device orientation, device location, device temperature, power level, speed, acceleration, motion patterns, cellular signals strength, etc.). In some embodiments, information related to the software state of user device 104 (e.g., running processes, installed programs, past and present network activities, background services, error logs, resources usage, etc.) is provided to the digital assistant server as context information associated with a user input.

In some embodiments, digital assistant client module 264 selectively provides information (e.g., user data 266) stored on user device 104 in response to requests from the digital assistant server. In some embodiments, digital assistant client module 264 also elicits additional input from the user via a natural language dialogue or other user interfaces upon request by digital assistant server 106. Digital assistant client module 264 passes the additional input to digital assistant server 106 to help digital assistant server 106 in intent inference and/or fulfillment of the user's intent expressed in the user request.

In various embodiments, memory 250 includes additional instructions or fewer instructions. Furthermore, various functions of user device 104 may be implemented in hardware and/or in firmware, including in one or more signal processing and/or application specific integrated circuits.

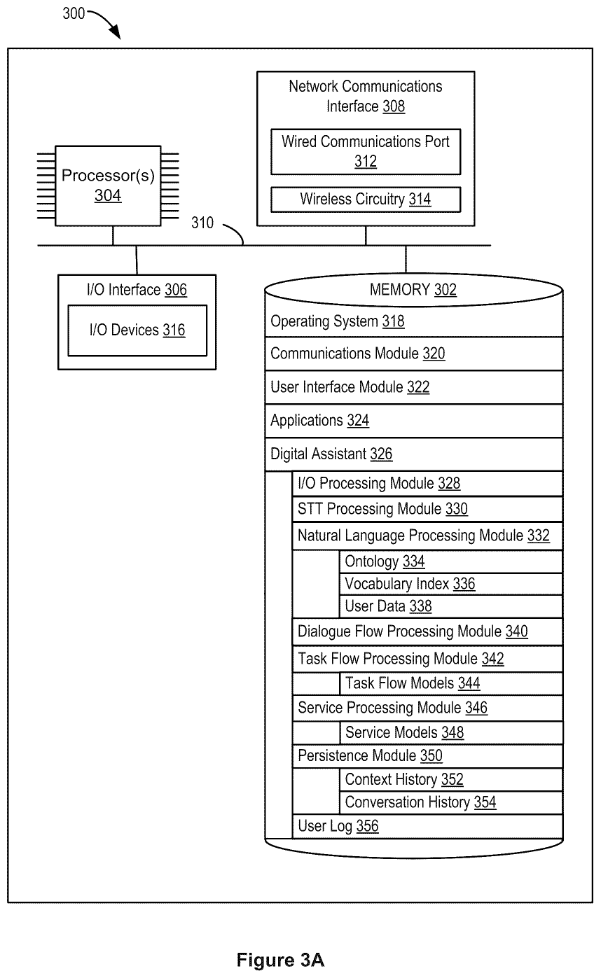

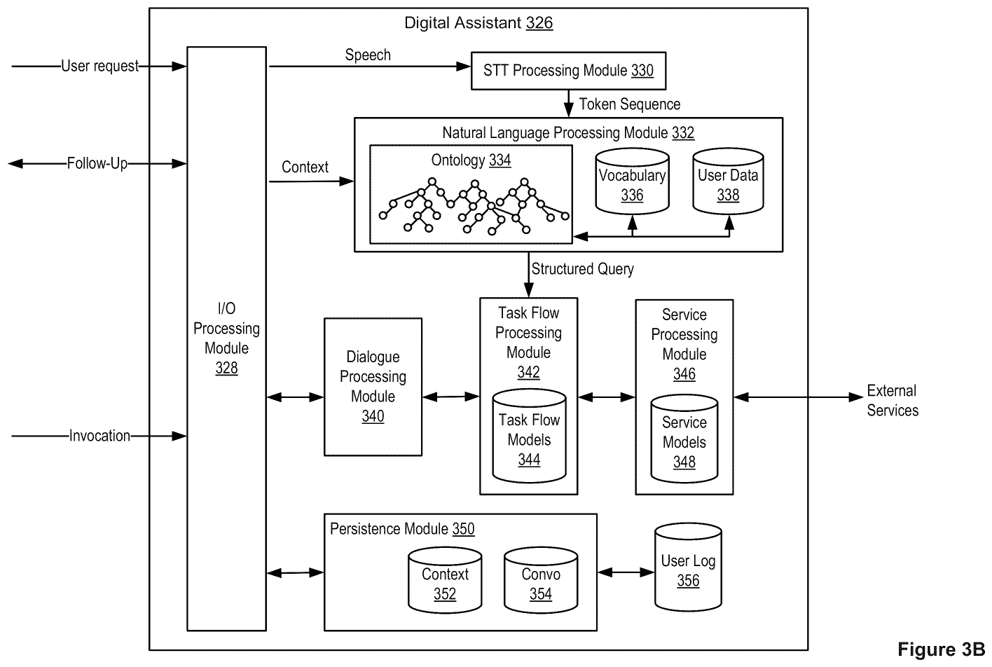

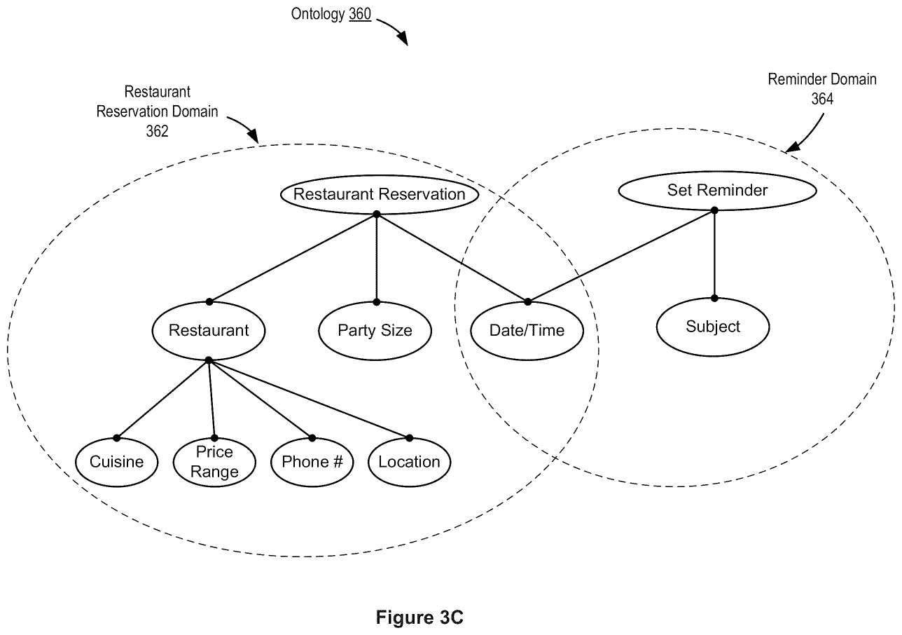

FIG. 3A is a block diagram of an example digital assistant system 300 in accordance with some embodiments. In some embodiments, digital assistant system 300 is implemented on a standalone computer system. In some embodiments, digital assistant system 300 is distributed across multiple computers. In some embodiments, some of the modules and functions of the digital assistant are divided into a server portion and a client portion, where the client portion resides on a user device (e.g., user device 104) and communicates with the server portion (e.g., server system 108) through one or more networks (e.g., network(s) 110). In some embodiments, digital assistant system 300 is an embodiment of server system 108 (and/or digital assistant server 106) shown in FIG. 1. It should be noted that digital assistant system 300 is only one example of a digital assistant system, and that digital assistant system 300 may have more or fewer components than shown, may combine two or more components, or may have a different configuration or arrangement of the components. The various components shown in FIG. 3A may be implemented in hardware, software instructions for execution by one or more processors, firmware, including one or more signal processing and/or application specific integrated circuits, or a combination of thereof.

Digital assistant system 300 includes memory 302, one or more processors 304, an input/output (I/O) interface 306, and a network communications interface 308. These components communicate with one another over one or more communication buses or signal lines 310.

In some embodiments, memory 302 includes a non-transitory computer readable storage medium, such as high-speed random access memory and/or a non-volatile storage medium (e.g., one or more magnetic disk storage devices, flash memory devices, or other non-volatile solid-state memory devices).

In some embodiments, I/O interface 306 couples input/output devices 316 of digital assistant system 300, such as displays, keyboards, touch screens, and microphones, to user interface module 322. I/O interface 306, in conjunction with user interface module 322, receives user inputs (e.g., voice input, keyboard inputs, touch inputs, etc.) and processes them accordingly. In some embodiments, digital assistant system 300 includes any of the components and I/O and communication interfaces described with respect to user device 104 in FIG. 2 (e.g., when the digital assistant is implemented on a standalone user device). In some embodiments, digital assistant system 300 represents the server portion of a digital assistant implementation, and interacts with the user through a client-side portion residing on a user device (e.g., user device 104 shown in FIG. 2).

In some embodiments, network communications interface 308 includes wired communication port(s) 312 and/or wireless transmission and reception circuitry 314. Wired communication port(s) receive and send communication signals via one or more wired interfaces such as Ethernet, Universal Serial Bus (USB), FIREWIRE, and the like. Wireless circuitry 314 receives and sends RF signals and/or optical signals from/to communications networks and other communications devices. The wireless communications, optionally, use any of a plurality of communications standards, protocols and technologies, such as GSM, EDGE, CDMA, TDMA, Bluetooth, Wi-Fi, VOIP, Wi-MAX, or any other suitable communication protocol. Network communications interface 308 enables communication between digital assistant system 300 and other devices via one or more networks (e.g., the Internet, an intranet, a wireless network, such as a cellular telephone network, a wireless local area network (LAN) or a metropolitan area network (MAN)).

In some embodiments, memory 302, or the computer readable storage media of memory 302, stores programs, modules, instructions, and data structures including all or a subset of: an operating system 318, a communications module 320, a user interface module 322, one or more applications 324, and a digital assistant module 326. One or more processors 304 execute these programs, modules, and instructions, and reads/writes from/to the data structures.

Operating system 318 (e.g., Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communications between various hardware, firmware, and software components.

Communications module 320 facilitates communications over network communications interface 308 between digital assistant system 300 and other devices. For example, communication module 320, optionally, communicates with communication interface 254 of user device 104 shown in FIG. 2. Communications module 320 also includes various components for handling data received by wireless circuitry 314 and/or wired communications port 312.

User interface module 322 receives commands and/or inputs from a user via I/O interface 306 (e.g., from a keyboard, touch screen, pointing device, controller, and/or microphone), and generates user interface objects on a display. User interface module 322 also prepares and delivers outputs (e.g., speech, sound, animation, text, icons, vibrations, haptic feedback, light, etc.) to the user via I/O interface 306 (e.g., through displays, audio channels, speakers, touch-pads, etc.).

The one or more applications 324 include programs and/or modules that are configured to be executed by the one or more processors 304. For example, if the digital assistant system is implemented on a standalone user device, one or more applications 324, optionally, include user applications, such as games, a calendar application, a navigation application, or an email application. If digital assistant system 300 is implemented on a server farm, the one or more applications 324, optionally, include resource management applications, diagnostic applications, or scheduling applications.

Memory 302 also stores digital assistant module 326 (or the server portion of a digital assistant). In some embodiments, digital assistant module 326 includes the following sub-modules, or a subset or superset thereof: an input/output processing module 328, a speech-to-text (STT) processing module 330, a natural language processing module 332, a dialogue flow processing module 340, a task flow processing module 342, a service processing module 346, and a background processing module 350. Each of these modules has access to one or more of the following data and models of the digital assistant 326, or a subset or superset thereof: ontology 334, vocabulary index 336, user data 338, task flow models 344, service models 348, and user log 352.

In some embodiments, using the processing modules, data, and models implemented in digital assistant module 326, digital assistant system 300 performs at least some of the following: identifying a user's intent expressed in a natural language input received from the user; actively eliciting and obtaining information needed to fully infer the user's intent (e.g., by disambiguating words, names, intentions, etc.); determining the task flow for fulfilling the inferred intent; and executing the task flow to fulfill the inferred intent. In some embodiments, the digital assistant also takes appropriate actions when a satisfactory response was not or could not be provided to the user for various reasons.

In some embodiments, as shown in FIG. 3B, I/O processing module 328 interacts with the user through the I/O devices 316 in FIG. 3A or with a user device (e.g., user device 104 in FIG. 1) through the network communications interface 308 in FIG. 3A to obtain user input (e.g., a speech input) and to provide responses (e.g., as speech outputs) to the user input. I/O processing module 328, optionally, obtains context information associated with the user input from the user device, along with or shortly after the receipt of the user input. The context information includes user-specific data, vocabulary, and/or preferences relevant to the user input. In some embodiments, the context information also includes software and hardware states of the device (e.g., user device 104 in FIG. 1) at the time the user request is received, and/or information related to the surrounding environment of the user at the time that the user request was received. In some embodiments, I/O processing module 328 also sends follow-up questions to, and receives answers from, the user regarding the user request. When a user request is received by I/O processing module 328 and the user request contains a speech input, I/O processing module 328 forwards the speech input to the speech-to-text (STT) processing module 330 for speech-to-text conversion.

STT processing module 330 receives speech input (e.g., a user utterance captured in a voice recording) through I/O processing module 328. In some embodiments, STT processing module 330 uses various acoustic and language models to recognize the speech input as a sequence of phonemes, and ultimately, a sequence of words or tokens written in one or more languages. The speech-to-text processing module 330 can be implemented using any suitable speech recognition techniques, acoustic models, and language models such as Hidden Markov Models, Dynamic Time Warping (DTW) based speech recognition, and other statistical and/or analytical techniques. In some embodiments, speech-to-text processing can be performed at least partially by a third party service or on the user's device. Once STT processing module 330 obtains the result of the speech-to-text processing (e.g., a sequence of words or tokens), STT processing module 330 passes the result to natural language processing module 332 for intent inference.

More details on the speech-to-text processing are described in U.S. Utility application Ser. No. 13/236,942 for “Consolidating Speech Recognition Results,” filed on Sep. 20, 2011, the entire disclosure of which is incorporated herein by reference.

Natural language processing module 332 (sometimes herein also called a “natural language processor”) of the digital assistant takes the sequence of words or tokens (or token sequence) generated by speech-to-text processing module 330, and attempts to associate the token sequence with one or more actionable intents recognized by the digital assistant. An “actionable intent” represents a task that can be performed by the digital assistant and has an associated task flow implemented in task flow models 344. The associated task flow is a series of programmed actions and steps that the digital assistant takes in order to perform the task. The scope of a digital assistant's capabilities is dependent on the number and variety of task flows that have been implemented and stored in task flow models 344 or, in other words, on the number and variety of actionable intents that the digital assistant recognizes. The effectiveness of the digital assistant, however, is also dependent on the digital assistant's ability to infer the correct actionable intent(s) from the user request expressed in natural language.

In some embodiments, in addition to the token sequence obtained from STT processing module 330, natural language processor 332 also receives context information associated with the user request (e.g., from I/O processing module 328). Natural language processor 332, optionally, uses the context information to clarify, supplement, and/or further define the information contained in the token sequence received from STT processing module 330. The context information includes, for example, user preferences, hardware and/or software states of the user device, sensor information collected before, during, or shortly after the user request, prior interactions (e.g., dialogue) between the digital assistant and the user, and the like.

In some embodiments, the natural language processing is based on ontology 334. Ontology 334 is a hierarchical structure containing many nodes, each node representing either an “actionable intent” or a “property” relevant to one or more of the “actionable intents” or other “properties.” As noted above, an “actionable intent” represents a task that the digital assistant is capable of performing (i.e., it is actionable or can be acted on). A “property” represents a parameter associated with an actionable intent or a sub-aspect of another property. A linkage between an actionable intent node and a property node in ontology 334 defines how a parameter represented by the property node pertains to the task represented by the actionable intent node.

In some embodiments, ontology 334 is made up of actionable intent nodes and property nodes. Within ontology 334, each actionable intent node is linked to one or more property nodes either directly or through one or more intermediate property nodes. Similarly, each property node is linked to one or more actionable intent nodes either directly or through one or more intermediate property nodes. For example, as shown in FIG. 3C, ontology 334 optionally includes a “restaurant reservation” node—an actionable intent node. Property nodes “restaurant,” “date/time” (for the reservation), and “party size” are each directly linked to the actionable intent node (e.g., the “restaurant reservation” node). In addition, property nodes “cuisine,” “price range,” “phone number,” and “location” are sub-nodes of the property node “restaurant,” and are each linked to the “restaurant reservation” node through the intermediate property node “restaurant.” For another example, as shown in FIG. 3C, ontology 334 may also include a “set reminder” node (e.g., another actionable intent node). Property nodes “date/time” (for the setting the reminder) and “subject” (for the reminder) are each linked to the “set reminder” node. Since the property “date/time” is relevant to both the task of making a restaurant reservation and the task of setting a reminder, the property node “date/time” is linked to both the “restaurant reservation” node and the “set reminder” node in ontology 334.

An actionable intent node, along with its linked property nodes, is sometimes described as a “domain.” In the present discussion, each domain is associated with a respective actionable intent, and refers to the group of nodes (and the relationships therebetween) associated with the particular actionable intent. For example, ontology 334 shown in FIG. 3C includes an example of a restaurant reservation domain 362 and an example of a reminder domain 364 within ontology 334. The restaurant reservation domain includes the actionable intent node “restaurant reservation,” property nodes “restaurant,” “date/time,” and “party size,” and sub-property nodes “cuisine,” “price range,” “phone number,” and “location.” Reminder domain 364 includes the actionable intent node “set reminder,” and property nodes “subject” and “date/time.” In some embodiments, ontology 334 is made up of many domains. Each domain optionally shares one or more property nodes with one or more other domains. For example, the “date/time” property node is optionally associated with many different domains (e.g., a scheduling domain, a travel reservation domain, a movie ticket domain, etc.), in addition to restaurant reservation domain 362 and reminder domain 364.

While FIG. 3C illustrates two example domains within ontology 334, other domains (or actionable intents) include, for example, “initiate a phone call,” “find directions,” “schedule a meeting,” “send a message,” and “provide an answer to a question,” and so on. A “send a message” domain is associated with a “send a message” actionable intent node, and optionally further includes property nodes such as “recipient(s),” “message type,” and “message body.” The property node “recipient” is optionally further defined, for example, by the sub-property nodes such as “recipient name” and “message address.”

In some embodiments, the ontology 334 includes all the domains (and hence actionable intents) that the digital assistant is capable of understanding and acting upon. In some embodiments, ontology 334 is optionally modified, such as by adding or removing entire domains or nodes, or by modifying relationships between the nodes within ontology 334.

In some embodiments, nodes associated with multiple related actionable intents are optionally clustered under a “super domain” in ontology 334. For example, a “travels” super domain optionally includes a cluster of property nodes and actionable intent nodes related to travel. The actionable intent nodes related to travel optionally include “airline reservation,” “hotel reservation,” “car rental,” “get directions,” “find points of interest,” and so on. The actionable intent nodes under the same super domain (e.g., the “travels” super domain) sometimes have many property nodes in common. For example, the actionable intent nodes for “airline reservation,” “hotel reservation,” “car rental,” “get directions,” “find points of interest” sometimes share one or more of the property nodes “start location,” “destination,” “departure date/time,” “arrival date/time,” and “party size.”

In some embodiments, each node in ontology 334 is associated with a set of words and/or phrases that are relevant to the property or actionable intent represented by the node. The respective set of words and/or phrases associated with each node is the so-called “vocabulary” associated with the node. The respective set of words and/or phrases associated with each node can be stored in vocabulary index 336 in association with the property or actionable intent represented by the node. For example, returning to FIG. 3B, the vocabulary associated with the node for the property of “restaurant” optionally includes words such as “food,” “drinks,” “cuisine,” “hungry,” “eat,” “pizza,” “fast food,” “meal,” and so on. For another example, the vocabulary associated with the node for the actionable intent of “initiate a phone call” optionally includes words and phrases such as “call,” “phone,” “dial,” “call this number,” “make a call to,” and so on. The vocabulary index 336, optionally, includes words and phrases in different languages.

Natural language processor 332 receives the token sequence (e.g., a text string) from speech-to-text processing module 330, and determines what nodes are implicated by the words in the token sequence. In some embodiments, if a word or phrase in the token sequence is found to be associated with one or more nodes in ontology 334 (via vocabulary index 336), the word or phrase will “trigger” or “activate” those nodes. Based on the quantity and/or relative importance of the activated nodes, natural language processor 332 will select one of the actionable intents as the task that the user intended the digital assistant to perform. In some embodiments, the domain that has the most “triggered” nodes is selected. In some embodiments, the domain having the highest confidence value (e.g., based on the relative importance of its various triggered nodes) is selected. In some embodiments, the domain is selected based on a combination of the number and the importance of the triggered nodes. In some embodiments, additional factors are considered in selecting the node as well, such as whether the digital assistant has previously correctly interpreted a similar request from a user.

In some embodiments, the digital assistant also stores names of specific entities in vocabulary index 336, so that when one of these names is detected in the user request, natural language processor 332 will be able to recognize that the name refers to a specific instance of a property or sub-property in the ontology. In some embodiments, the names of specific entities are names of businesses, restaurants, people, movies, and the like. In some embodiments, the digital assistant searches and identifies specific entity names from other data sources, such as the user's address book, a movies database, a musicians database, and/or a restaurant database. In some embodiments, when natural language processor 332 identifies that a word in the token sequence is a name of a specific entity (e.g., a name in the user's address book), that word is given additional significance in selecting the actionable intent within the ontology for the user request.

For example, when the words “Mr. Santo” are recognized in a user request and the last name “Santo” is found in vocabulary index 336 as one of the contacts in the user's address book, then it is likely that the user request corresponds to a “send a message” or an “initiate a phone call” domain. For another example, when the words “ABC Café” are found in a user request and the term “ABC Café” is found in the vocabulary index 336 as the name of a particular restaurant in the user's city, then it is likely that the user request corresponds to a “restaurant reservation” or a “find restaurants” domain.

User data 338 includes user-specific information, such as user-specific vocabulary, user preferences, user address or home location, user's default and secondary languages, user's address book, and other short-term or long-term information for each user. In some embodiments, natural language processor 332 uses the user-specific information to supplement the information contained in a user input to further define the user intent. For example, for a user request “invite my friends to my birthday party,” natural language processor 332 is able to access user data 338 to determine who the “friends” are and when and where the “birthday party” would be held, rather than requiring the user to provide such information explicitly in his/her request.

Other details of searching an ontology based on a token string is described in U.S. Utility application Ser. No. 12/341,743 for “Method and Apparatus for Searching Using An Active Ontology,” filed Dec. 22, 2008, the entire disclosure of which is incorporated herein by reference.

In some embodiments, once natural language processor 332 identifies an actionable intent (or domain) based on the user request, natural language processor 332 generates a structured query to represent the identified actionable intent. In some embodiments, the structured query includes parameters for one or more nodes within the domain for the actionable intent, and at least some of the parameters are populated with the specific information and requirements specified in the user request. For example, the user states to the DA, “Make me a dinner reservation at a sushi place at 7.” In this case, natural language processor 332 may be able to correctly identify the actionable intent to be “restaurant reservation” based on the user input. According to the ontology, a structured query for a “restaurant reservation” domain optionally includes parameters such as {Cuisine}, {Time}, {Date}, {Party Size}, and the like. In some embodiments, based on the information contained in the user's utterance, natural language processor 332 generates a partial structured query for the restaurant reservation domain, where the partial structured query includes the parameters {Cuisine=“Sushi”} and {Time=“7 PM”}. In this example, the user's utterance, however, contains insufficient information to complete the structured query associated with the domain. Therefore, other necessary parameters such as {Party Size} and {Date} are not specified in the structured query based on the information currently available. In some embodiments, natural language processor 332 populates some parameters of the structured query with received context information. For example, in some embodiments, if the user requested a sushi restaurant “near me,” natural language processor 332 populates a {location} parameter in the structured query with GPS coordinates from user device 104.

In some embodiments, natural language processor 332 passes the structured query (including any completed parameters) to task flow processing module 342 (sometimes herein also called a “task flow processor”). Task flow processor 342 is configured to receive the structured query from natural language processor 332, complete the structured query, if necessary, and perform the actions required to “complete” the user's ultimate request. In some embodiments, the various procedures necessary to complete these tasks are provided in task flow models 344. In some embodiments, task flow models 344 include procedures for obtaining additional information from the user, and task flows for performing actions associated with the actionable intent.

As described above, in order to complete a structured query, task flow processor 342 sometimes needs to initiate additional dialogue with the user in order to obtain additional information, and/or disambiguate potentially ambiguous utterances. When such interactions are necessary, task flow processor 342 invokes dialogue processing module 340 (sometimes herein also called a “dialogue processor”) to engage in a dialogue with the user. In some embodiments, dialogue processor 340 determines how (and/or when) to ask the user for the additional information, and receives and processes the user responses. The questions are provided to and answers are received from the users through I/O processing module 328. In some embodiments, dialogue processor 340 presents dialogue output to the user via audio and/or visual output, and receives input from the user via spoken or physical (e.g., clicking) responses. Continuing with the example above, when task flow processor 342 invokes dialogue flow processor 340 to determine the “party size” and “date” information for the structured query associated with the domain “restaurant reservation,” dialogue flow processor 335 generates questions, such as “For how many people?” and “On which day?,” to pass to the user. Once answers are received from the user, the dialogue flow processor 340 can then populate the structured query with the missing information, or pass the information to task flow processor 342 to complete the missing information from the structured query.

Once task flow processor 342 has completed the structured query for an actionable intent, task flow processor 342 proceeds to perform the ultimate task associated with the actionable intent. Accordingly, task flow processor 342 executes the steps and instructions in the task flow model according to the specific parameters contained in the structured query. For example, the task flow model for the actionable intent of “restaurant reservation,” optionally, includes steps and instructions for contacting a restaurant and actually requesting a reservation for a particular party size at a particular time. For example, using a structured query, such as {restaurant reservation, restaurant=ABC Café, date=3/12/2012, time=7 PM, party size=5}, task flow processor 342, optionally, performs the steps of: (1) logging onto a server of the ABC Café or a restaurant reservation system such as OPENTABLE®; (2) entering the date, time, and party size information in a form on the website; (3) submitting the form; and (4) making a calendar entry for the reservation in the user's calendar.

In some embodiments, task flow processor 342 employs the assistance of a service processing module 346 (sometimes herein also called a “service processor”) to complete a task requested in the user input or to provide an informational answer requested in the user input. For example, service processor 346 can act on behalf of task flow processor 342 to make a phone call, set a calendar entry, invoke a map search, invoke or interact with other user applications installed on the user device, and invoke or interact with third party services (e.g., a restaurant reservation portal, a social networking website, a banking portal, etc.). In some embodiments, the protocols and application programming interfaces (API) required by each service can be specified by a respective service model among services models 348. Service processor 346 accesses the appropriate service model for a service and generates requests for the service in accordance with the protocols and APIs required by the service according to the service model.

For example, if a restaurant has enabled an online reservation service, the restaurant can submit a service model specifying the necessary parameters for making a reservation and the APIs for communicating the values of the necessary parameter to the online reservation service. When requested by task flow processor 342, service processor 346 can establish a network connection with the online reservation service using the web address stored in the service model, and send the necessary parameters of the reservation (e.g., time, date, party size) to the online reservation interface in a format according to the API of the online reservation service.

In some embodiments, natural language processor 332, dialogue processor 340, and task flow processor 342 are used collectively and iteratively to infer and define the user's intent, obtain information to further clarify and refine the user intent, and finally generate a response (e.g., an output to the user, or the completion of a task) to fulfill the user's intent.

In some embodiments, after all of the tasks needed to fulfill the user's request have been performed, digital assistant 326 formulates a confirmation response, and sends the response to the user through the I/O processing module 328. If the user request seeks an informational answer, the confirmation response presents the requested information to the user. In some embodiments, the digital assistant also requests the user to indicate whether the user is satisfied with the response produced by digital assistant 326.

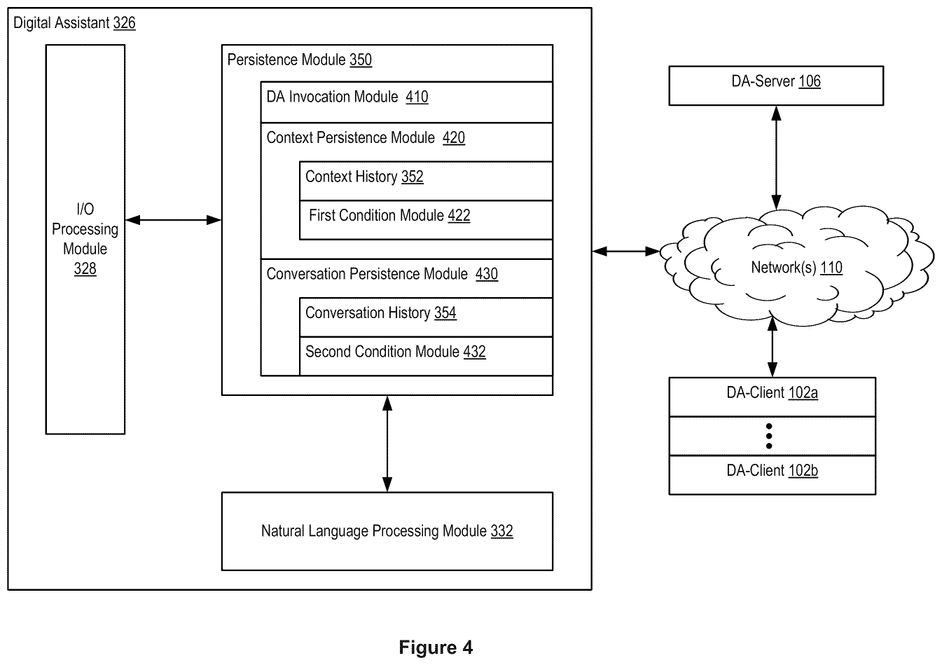

In some embodiments, the digital assistant 326 includes a persistence module 350 with context history 352 and conversation history 354. The persistence module 350 is configured to enable conversation and/or context persistence across two or more non-continuous instances of a digital assistant. Persistence module 350 is discussed in more detail below with reference to FIG. 4.

More details on the digital assistant can be found in the U.S. Utility application Ser. No. 12/987,982, entitled “Intelligent Automated Assistant,” filed Jan. 18, 2010, and also in U.S. Utility Application No. 61/493,201, entitled “Generating and Processing Data Items That Represent Tasks to Perform,” filed Jun. 3, 2011, the entire disclosures of which are incorporated herein by reference.

FIG. 4 illustrates a block diagram of a persistence module 350 included in digital assistant 326 in accordance with some embodiments. Persistence module 350 includes a digital assistant (DA) invocation module 410, a context persistence module 420, and a conversation persistence module 430. DA invocation module is configured to detect a user request to invoke the DA. For example, the detection of a long press on home button 509 of user device 104 or the reception of a predefined speech input (e.g., a speech input stating, “Hey, Siri”) invokes the DA.

More details on the audibly invoking a digital assistant are described in U.S. Provisional Application Ser. No. 61/762,260 (Attorney Docket No. P18041USP1/063266-5819-PR), filed on Feb. 7, 2013, entitled “Voice Trigger for a Digital Assistant,” the entire disclosure of which is incorporated herein by reference.

Context persistence module 420 is configured to enable the persistence of contextual information across more than one instance of the DA. In some embodiments, context information from a previous instance (or session) of a DA user interface is used in intent inference by natural language processor 332 during a subsequent instance of the DA user interface. For example, while in a first instance of a DA user interface, a user asks the DA, “What is the weather in New York City?” In response to the user request, the DA indicates the current temperature and prevailing weather in New York City. Subsequently, the user leaves the first instance of the DA user interface, goes to a user interface different from the DA user interface (e.g., the home screen of the device, the lock screen of the device, or an application separate from the DA), and re-enters the DA user interface in a second instance of the DA user interface at a time following (or later than) exiting the first instance of the DA user interface. While in the second instance of the DA user interface, the user asks the DA, “What about in DC?” The DA is enabled to use contextual information corresponding to the dialogue between the user and the DA from the first instance of the DA user interface to answer the user's question in the second instance of the DA user interface. For example, the DA maintains the “weather” context while in the second instance of the DA user interface and responds to the user's request by visually and/or audibly presenting the current temperature and prevailing weather in Washington, DC.

Context persistence module 420 includes context history 352 and a first condition module 422. Context history 352 is a short term, or cache, memory that stores contextual information from one or more previous instances of the DA. In some embodiments, context history 352 is separate from user log 356 and only stores contextual information related to dialogue between the DA and the user. In some embodiments, context history 352 is stored in DA-server 106 of server system 108 (e.g., in data 116 of DA-sever 106). First condition module 422 triggers the usage of contextual information stored in context history 352 in a second instance of a DA as long as a first predetermined condition is satisfied. In some embodiments, the first predetermined condition is a context expiration time period (e.g., one minute). For example, contextual information from a first instance of a DA is used in a second instance of the DA as long as the second instance of the DA is invoked within one minute of leaving the first instance of the DA. In some embodiments, if the first predetermined condition is not satisfied (e.g., the content expiration time period expires), the contextual information related to the first instance of the DA is deleted from context history 352.

Conversation persistence module 430 is configured to enable the persistence of conversation (or dialogue) information across more than one instance of the DA. In some embodiments, conversation information including at least a portion of a transcript of a dialogue between a user and a DA in a previous instance of a DA user interface is available for display in a subsequent instance of the DA user interface. For example, while in a first instance of a DA user interface, a user asks the DA, “Show me nearby Pakistani restaurants,” and receives a list of six Pakistani restaurants within a ten mile radius of the user's current location. Subsequently, the user leaves the first instance of the DA user interface, goes to a user interface different from the DA user interface (e.g., the home screen of the device, the lock screen of the device, or an application separate from the DA), and re-enters the DA user interface in a second instance of the DA user interface. While in the second instance of the DA user interface, the list of six Pakistani restaurants is available for display. In some embodiments, a fraction of the previous dialogue between the user and the DA is displayed, or a peck through of the previous dialogue between the user and the DA is displayed under a partially transparent banner. In some embodiments, the remainder of the dialogue between the user and the DA from the first instance of the DA user interface is available for display by scrolling up while in the second instance of the DA user interface.

Conversation persistence module 430 includes conversation history 354 and a second condition module 432. Conversation history 354 is a short term, or cache, memory that stores conversation information including a transcript of a dialogue between the user and the DA from one or more previous instances of the DA. In some embodiments, conversation history 354 is a separate memory from context history 352. In some other embodiments, conversation history 354 and context history 352 are included in the same memory. In some embodiments, conversation history 354 is stored in DA-server 106 of server system 108 (e.g., in data 116 of DA-sever 106). Second condition module 432 triggers the usage of conversation information stored in conversation history 354 in a second instance of a DA as long as a second predetermined condition is satisfied. In some embodiments, the second predetermined condition is a conversation expiration time period (e.g., eight minutes). For example, conversation information (e.g., a transcript of dialogue) from a first instance of a DA is available for display in a second instance of the DA as long as the second instance of the DA is invoked within eight minutes of leaving the first instance of the DA. In some embodiments, if the second predetermined condition is not satisfied (e.g., the conversation expiration time period expires), the conversation information related to the first instance of the DA is deleted from conversation history 354.

Although FIG. 4 does not explicitly show the communication interfaces between all components of digital assistant 326 in FIG. 3B, it is to be understood that the components shown in FIG. 4 are capable of communicating with other components of digital assistant 326 in FIG. 3B either directly or through one or more other interfaces, such as application programming interfaces (APIs), database query interfaces, and/or other interfaces, protocols, and/or communication channels.

Attention is now directed towards embodiments of user interfaces (“UI”) that are, optionally, implemented on user device 104.

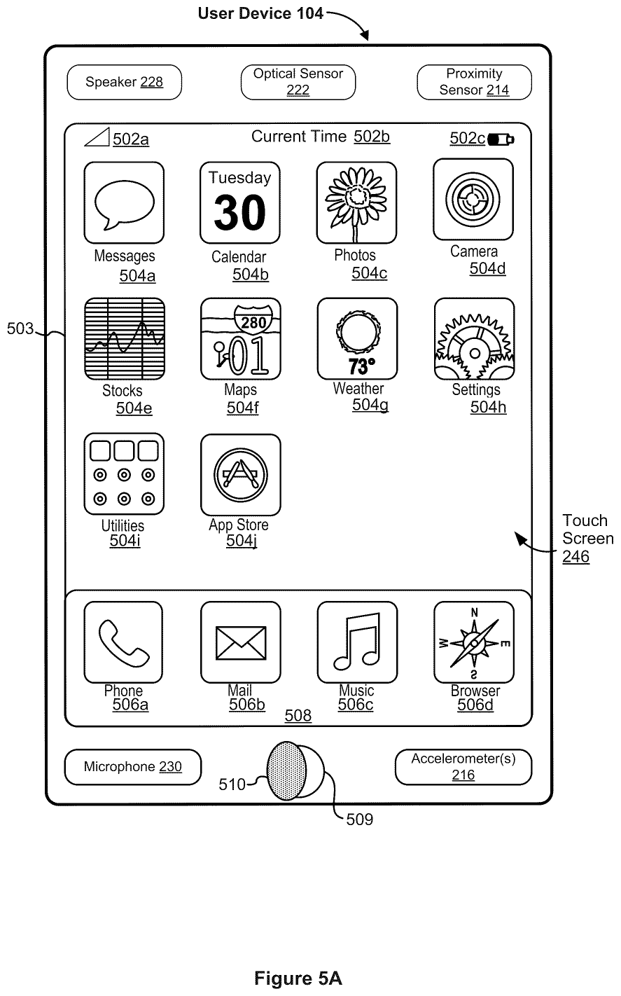

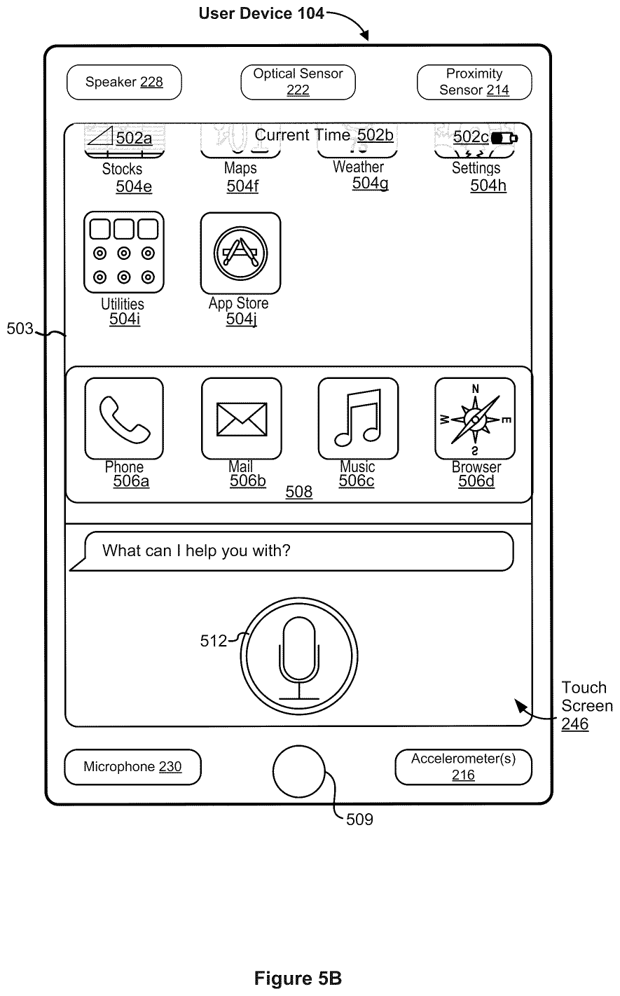

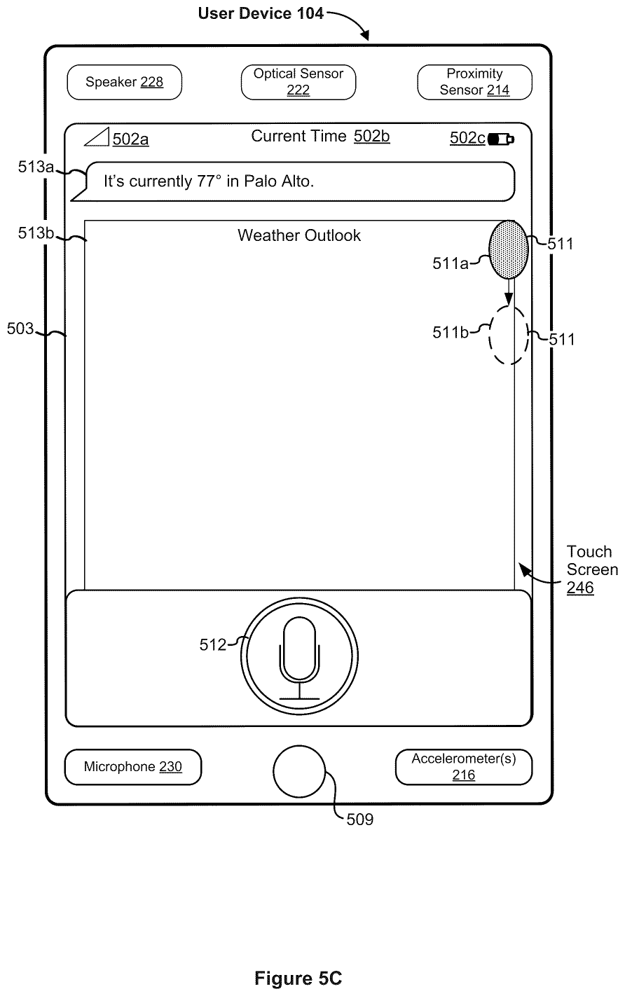

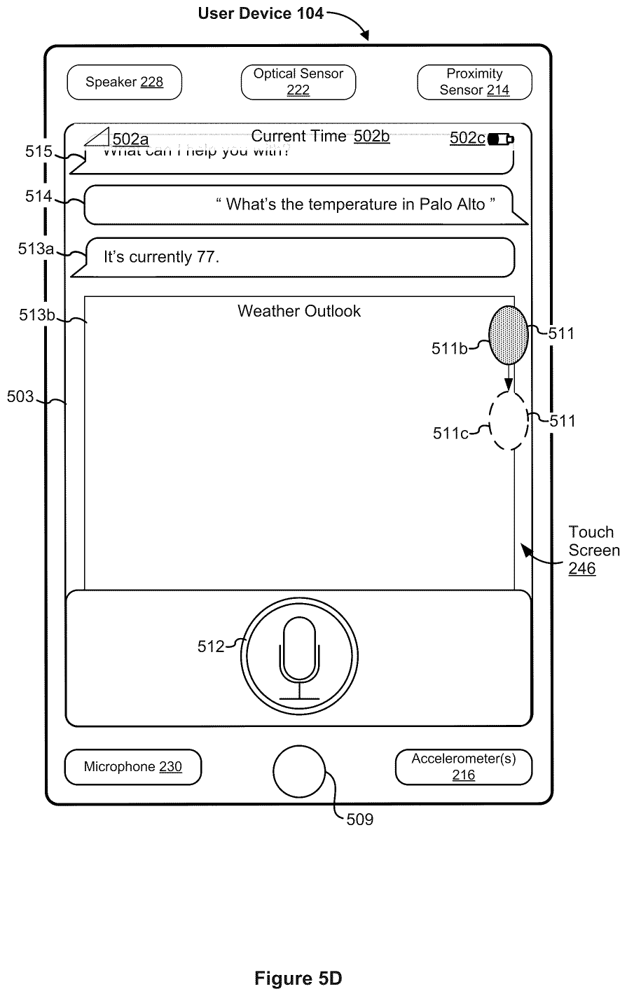

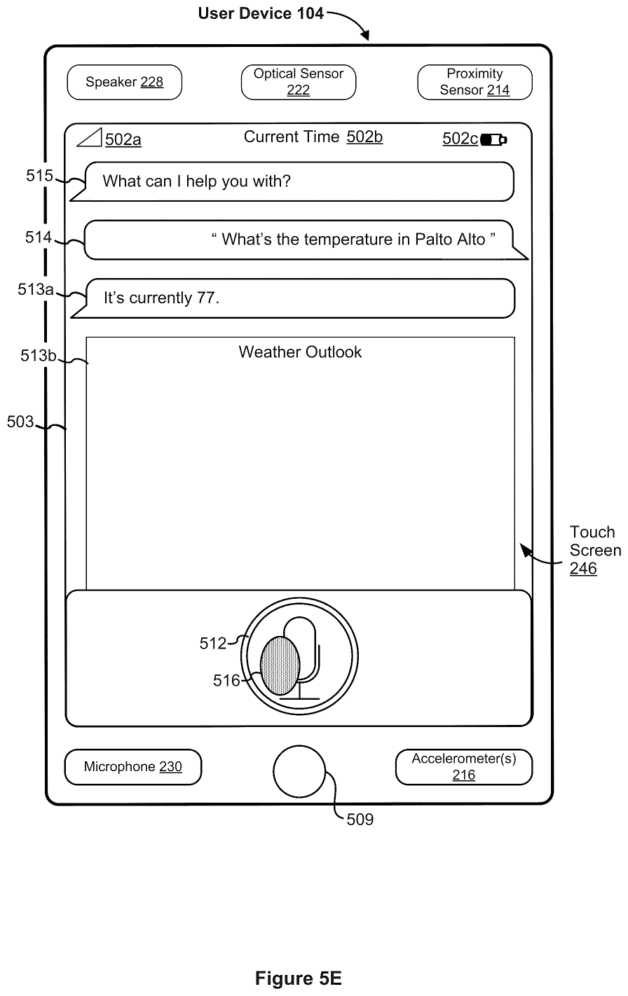

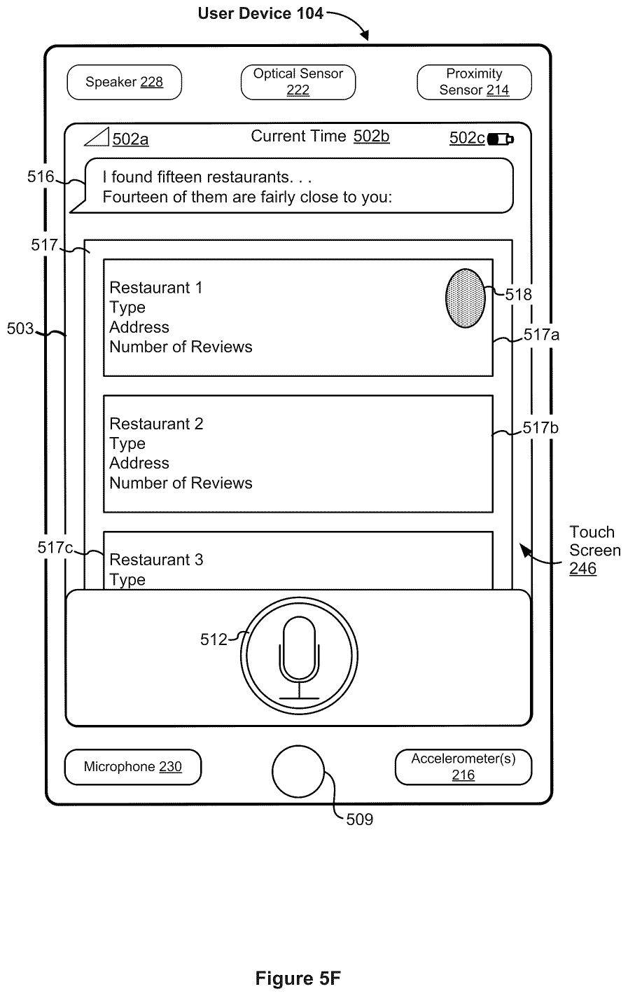

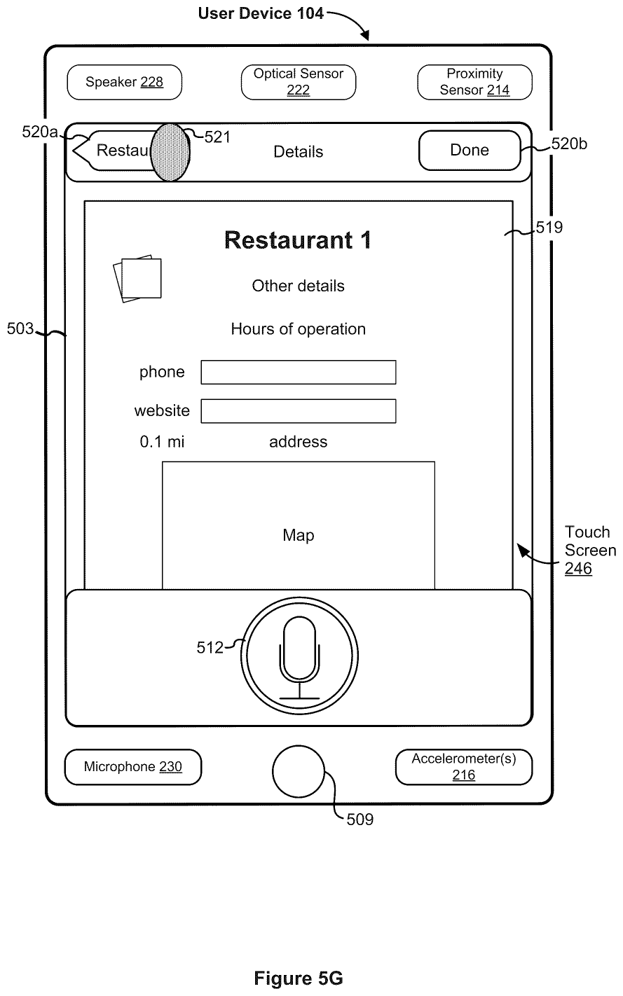

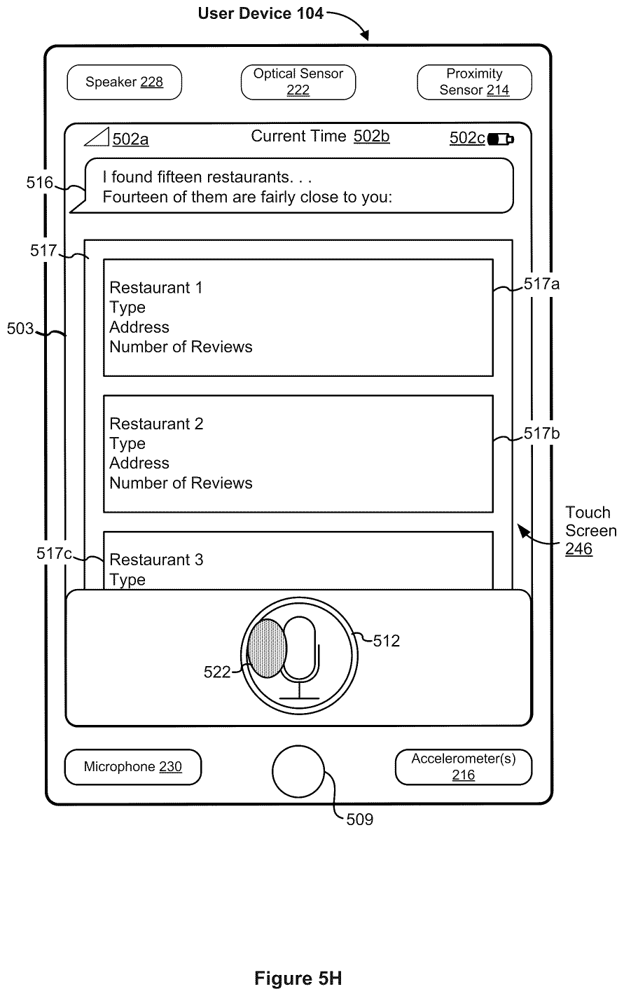

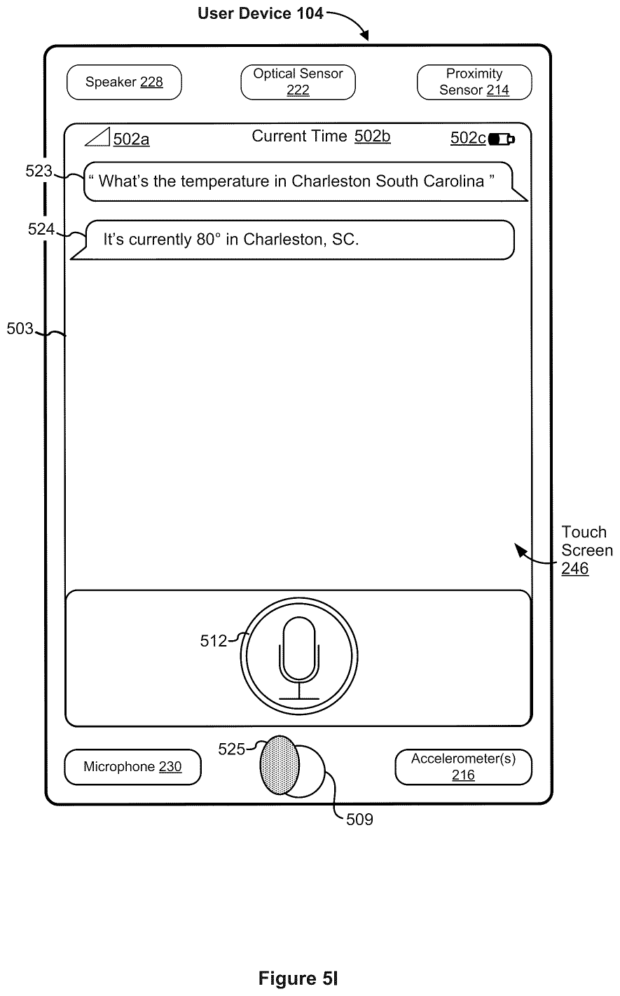

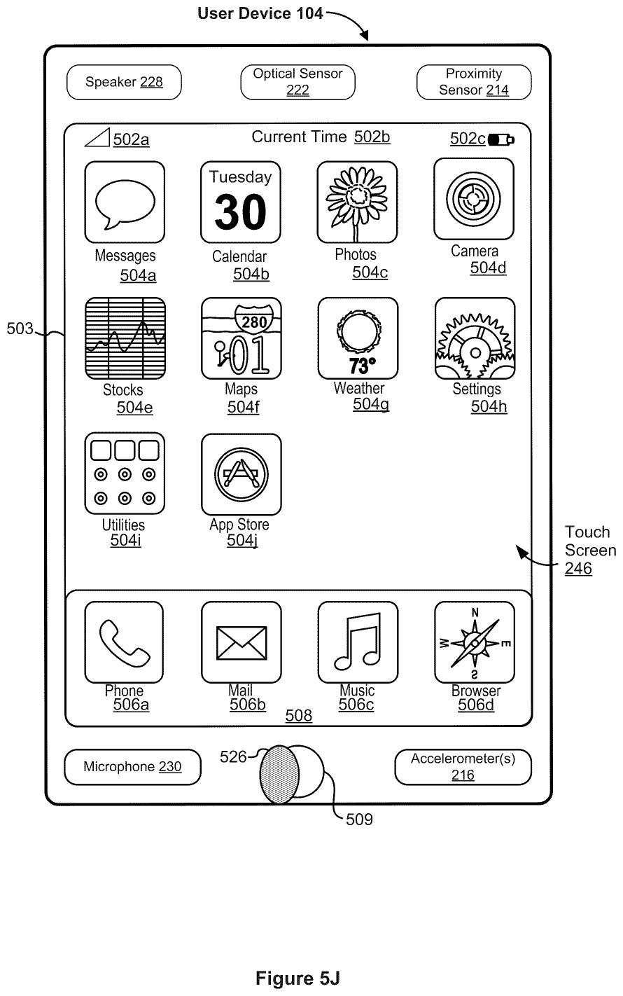

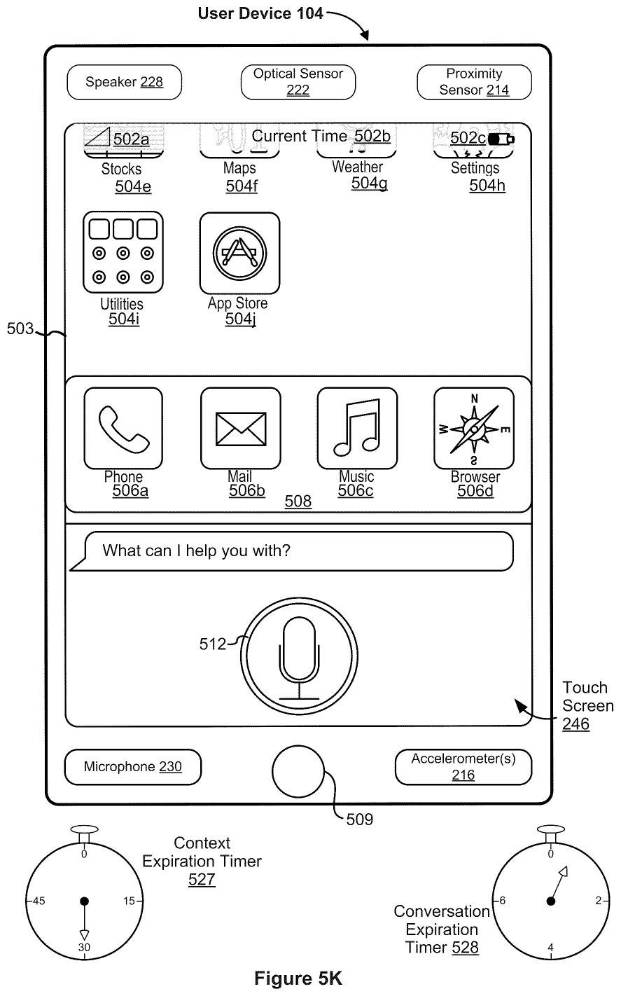

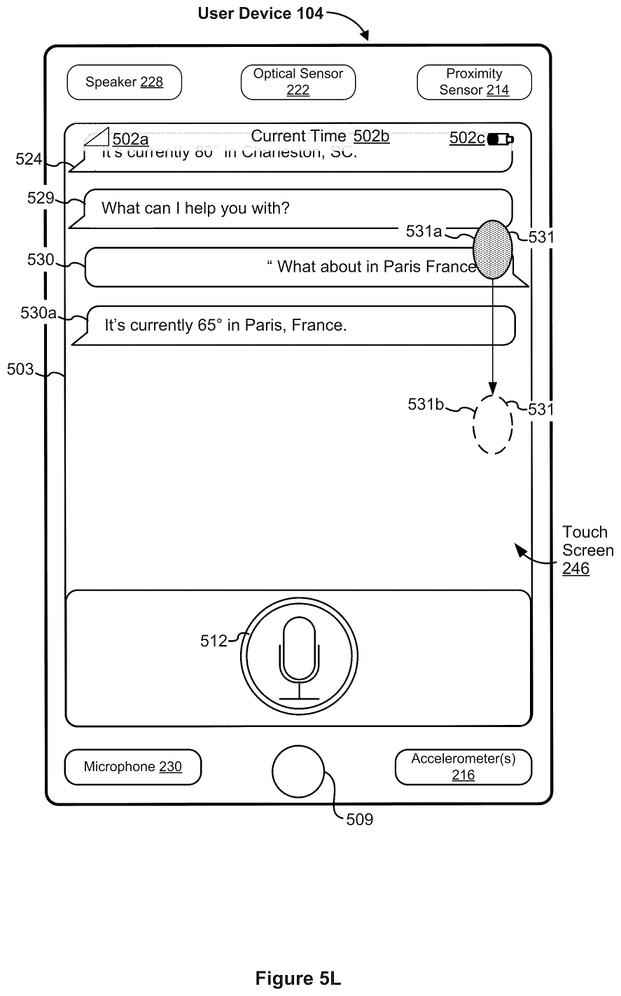

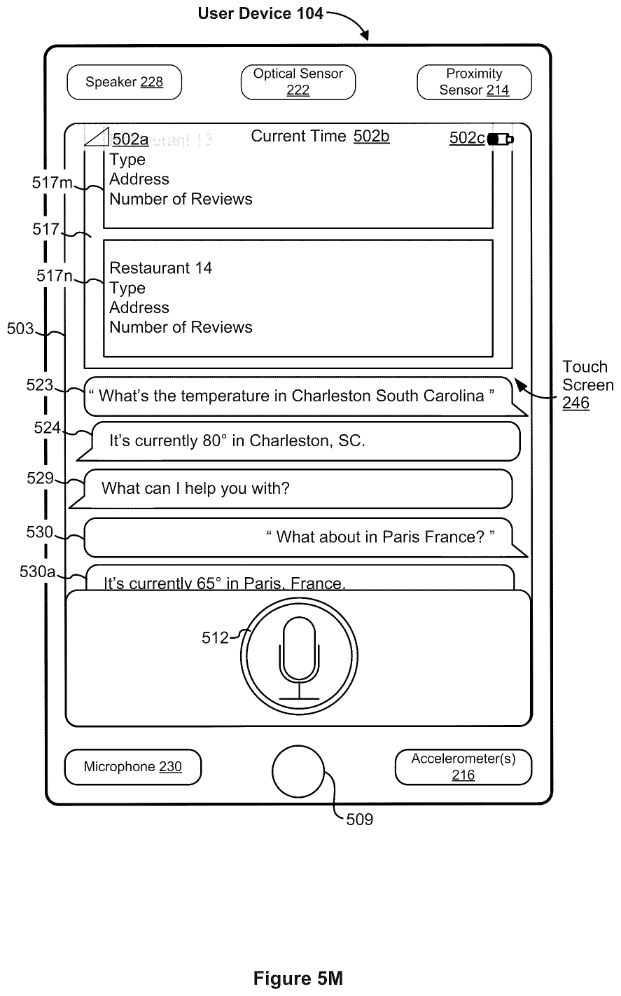

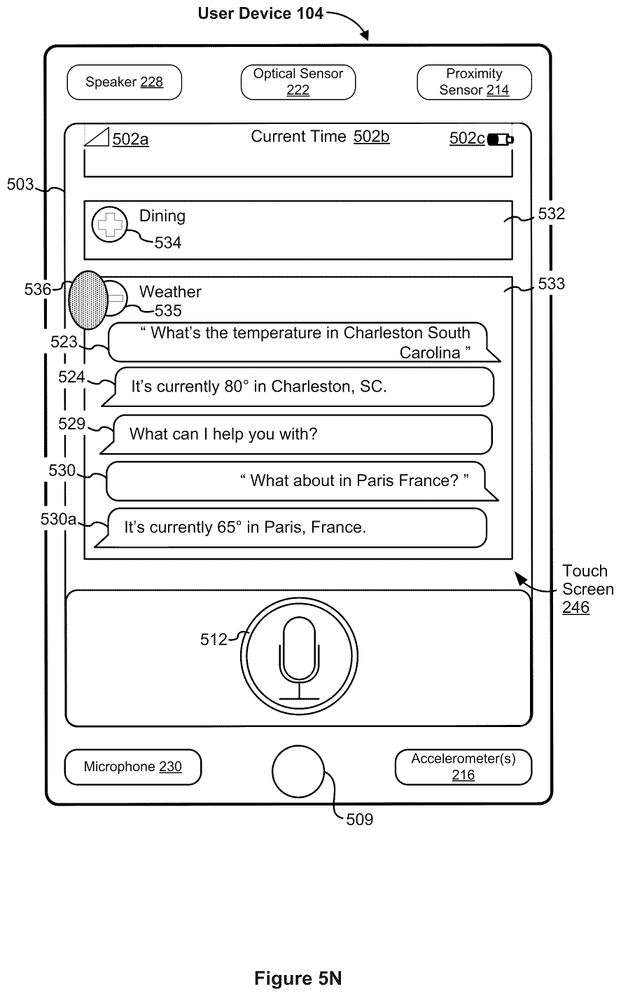

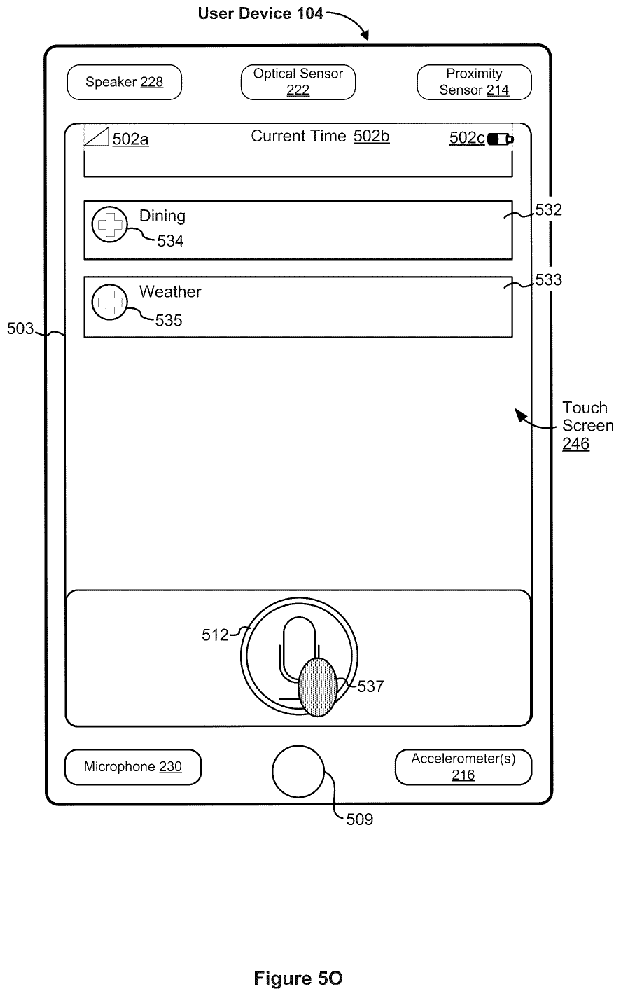

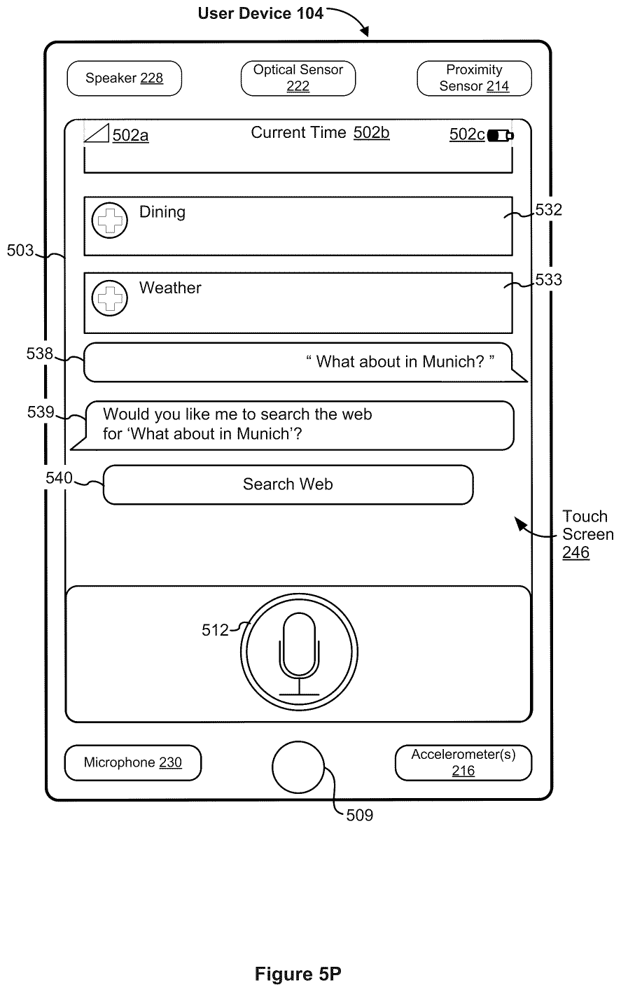

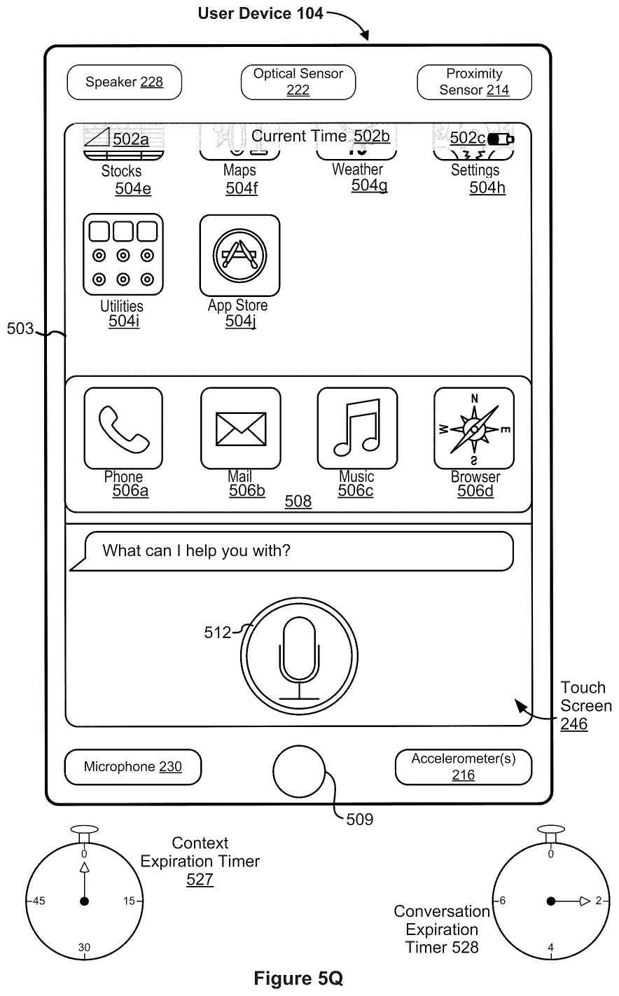

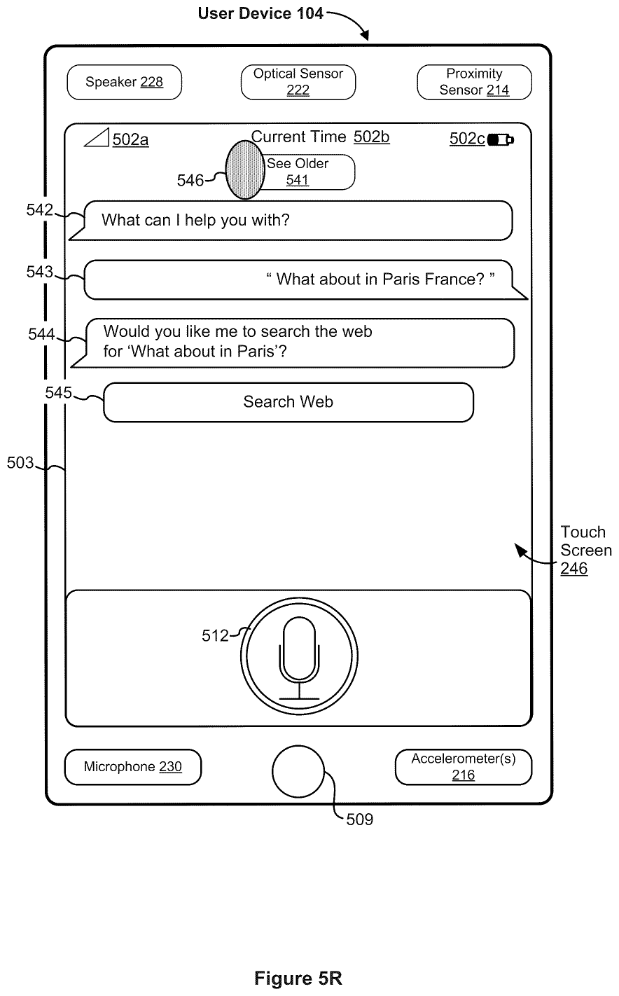

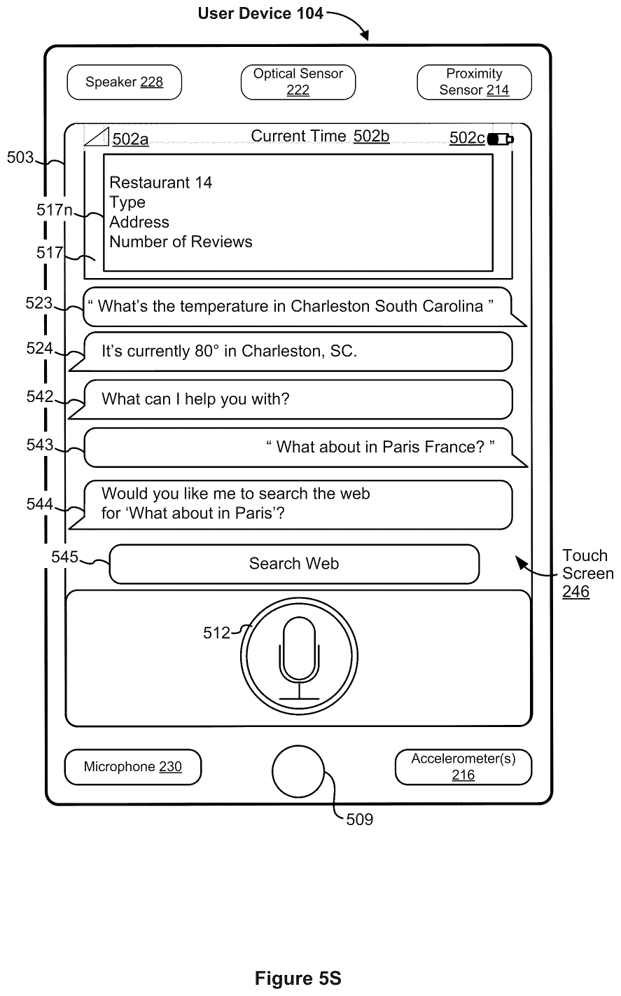

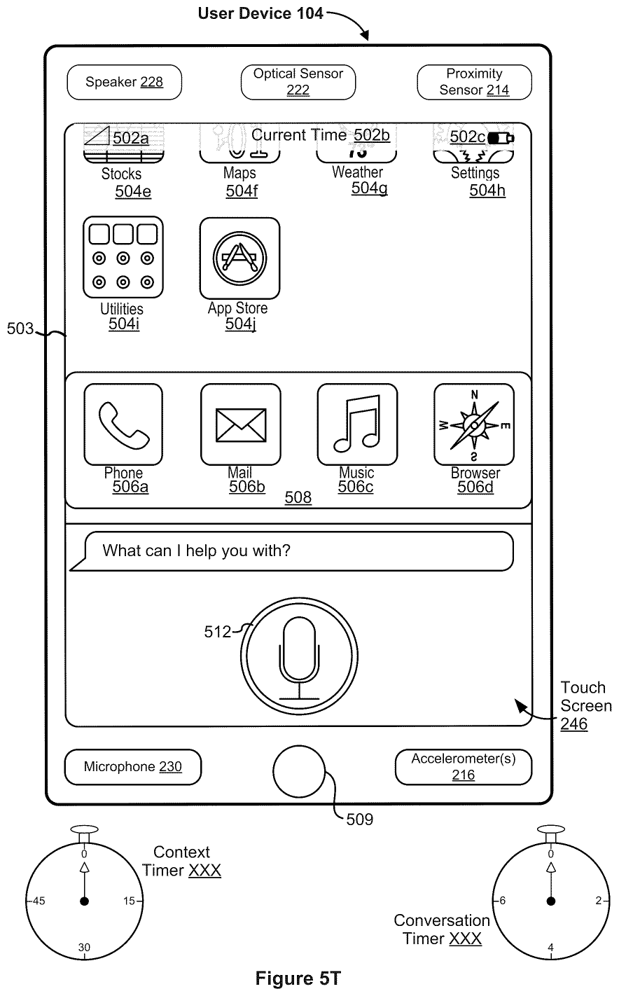

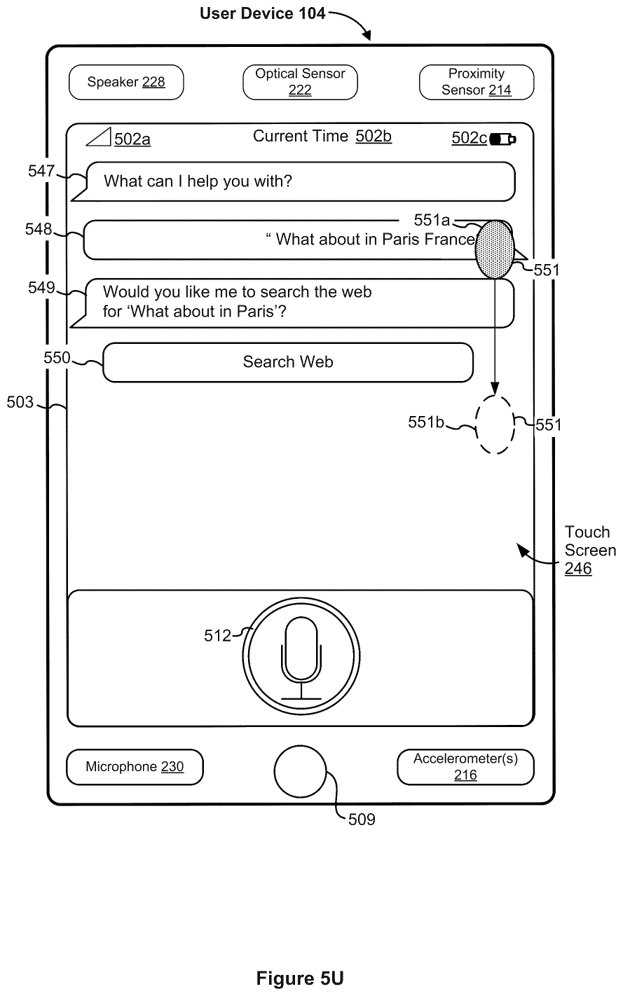

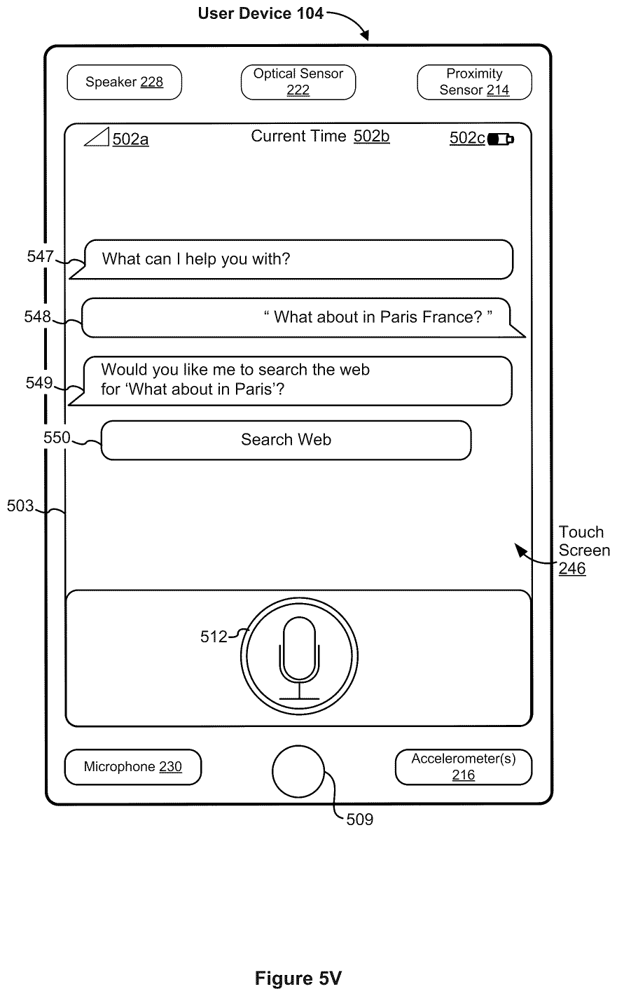

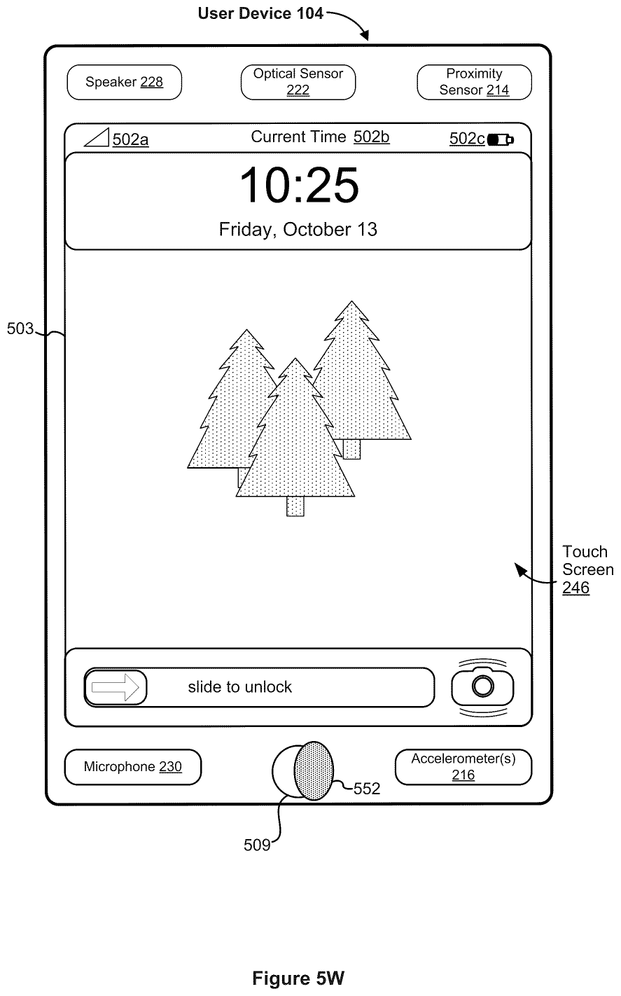

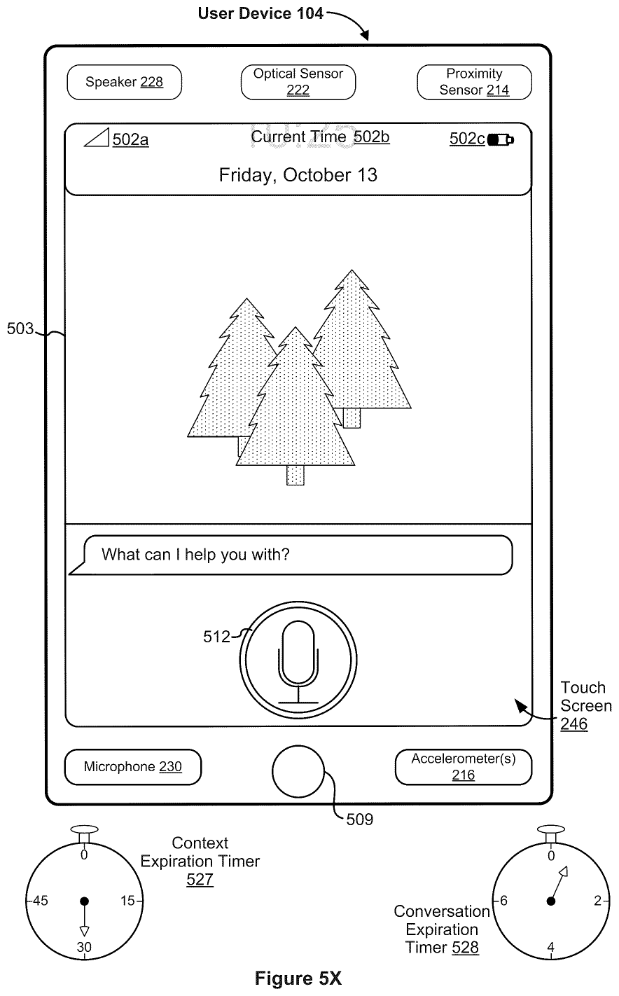

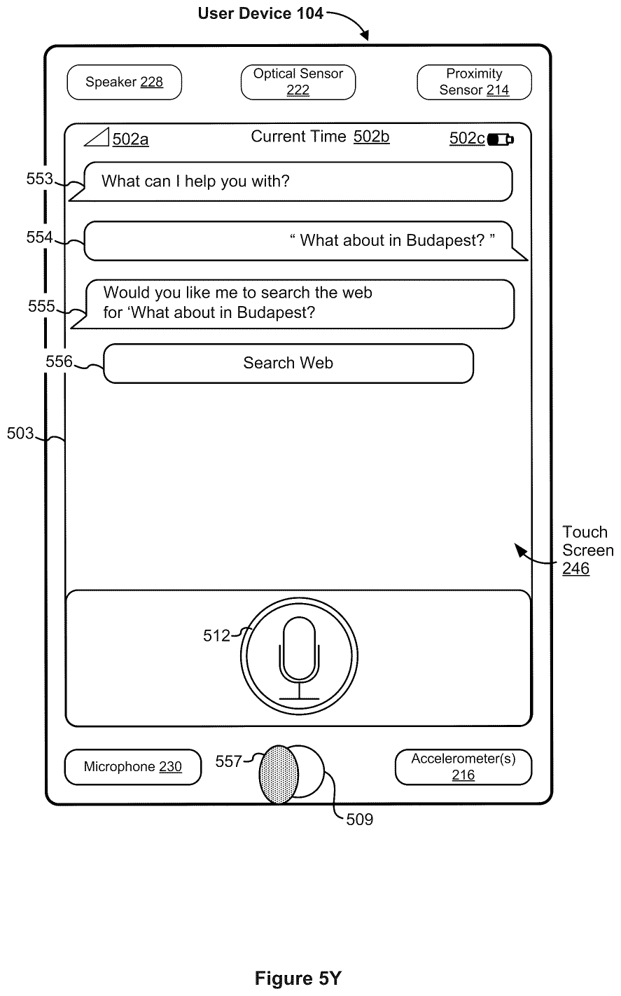

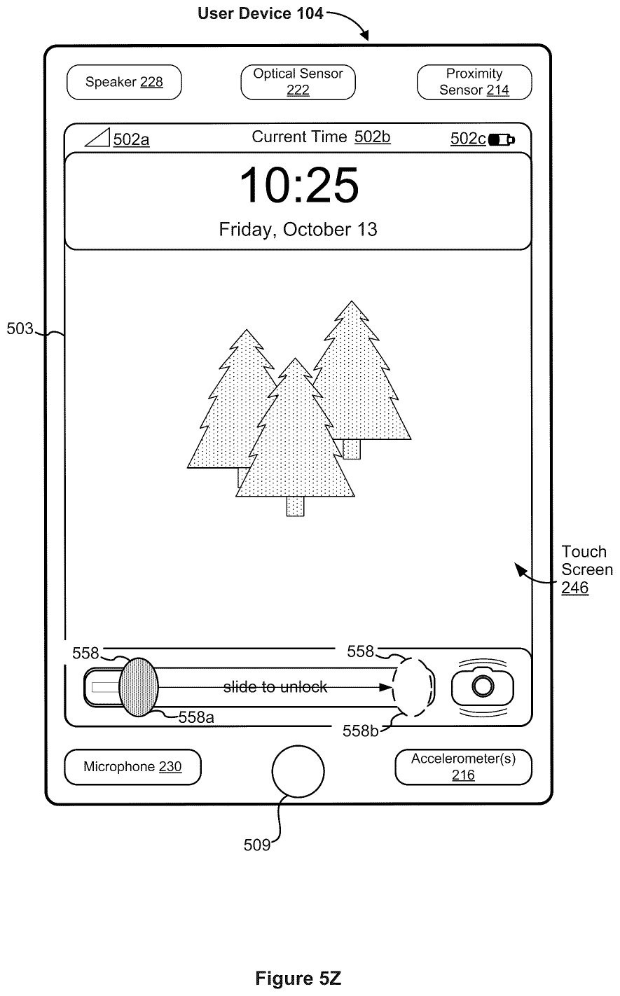

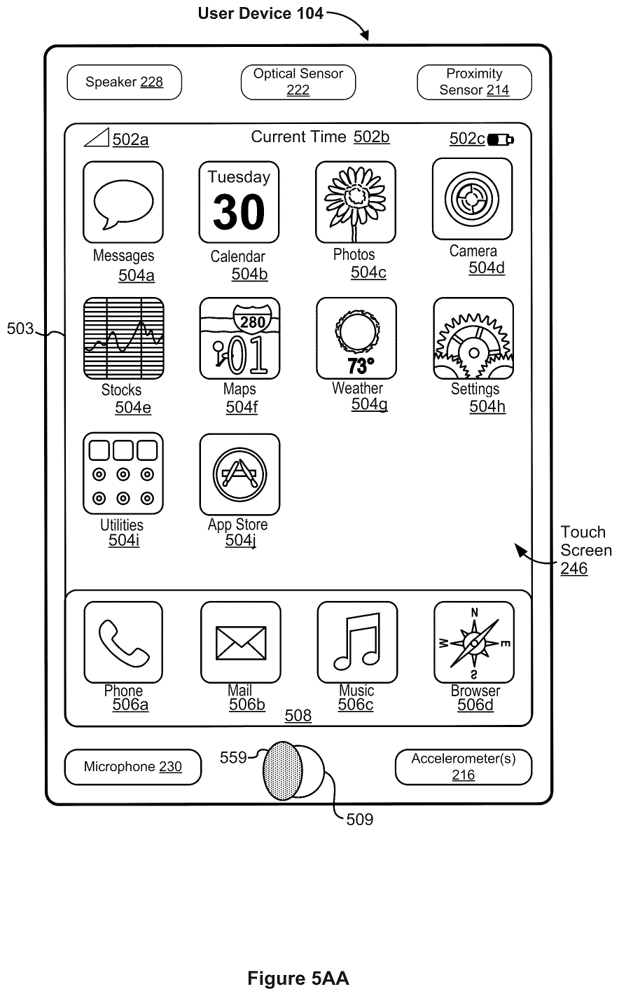

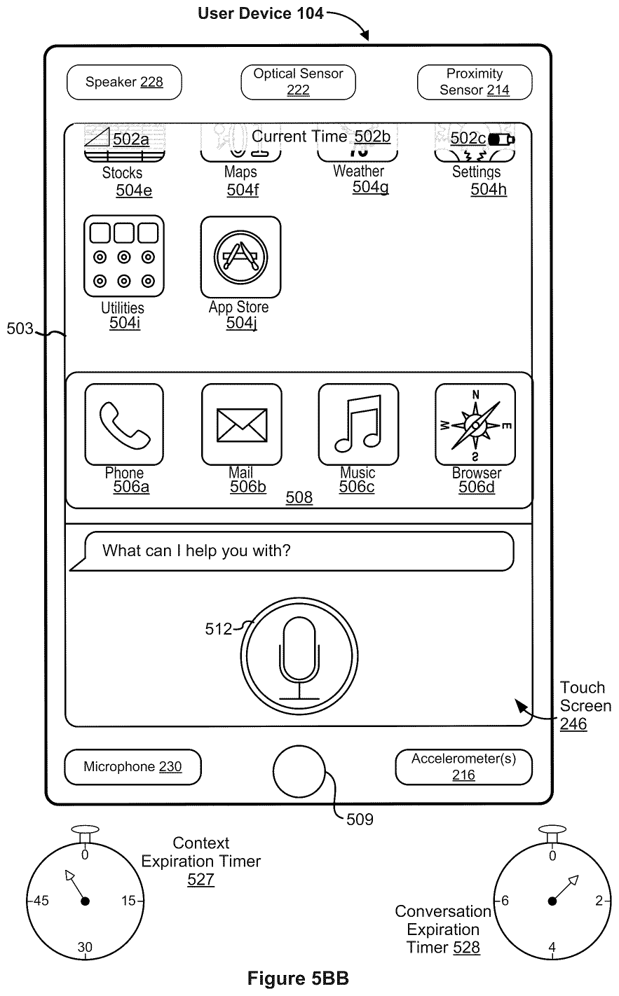

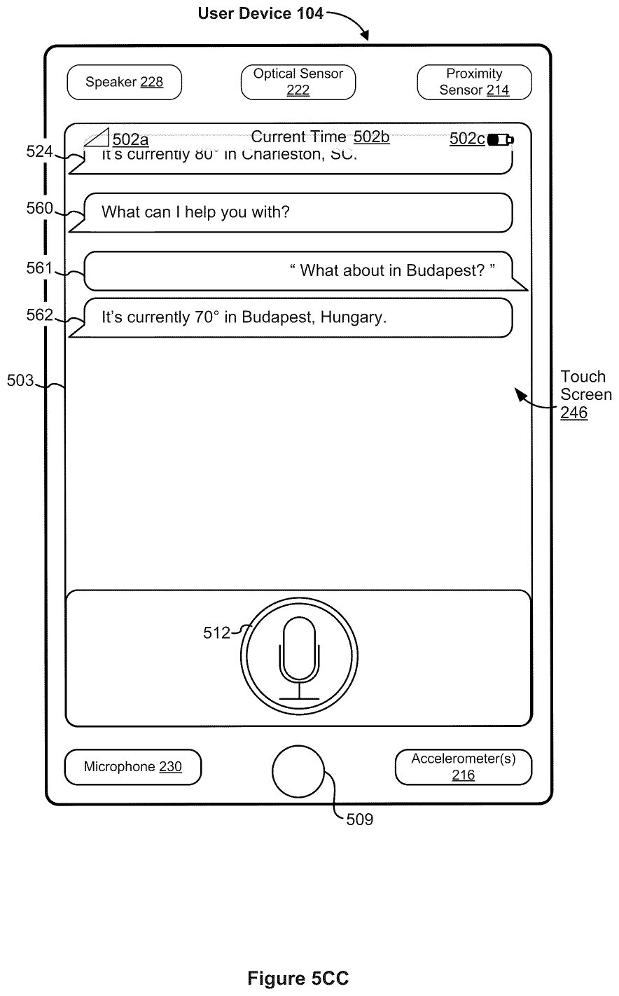

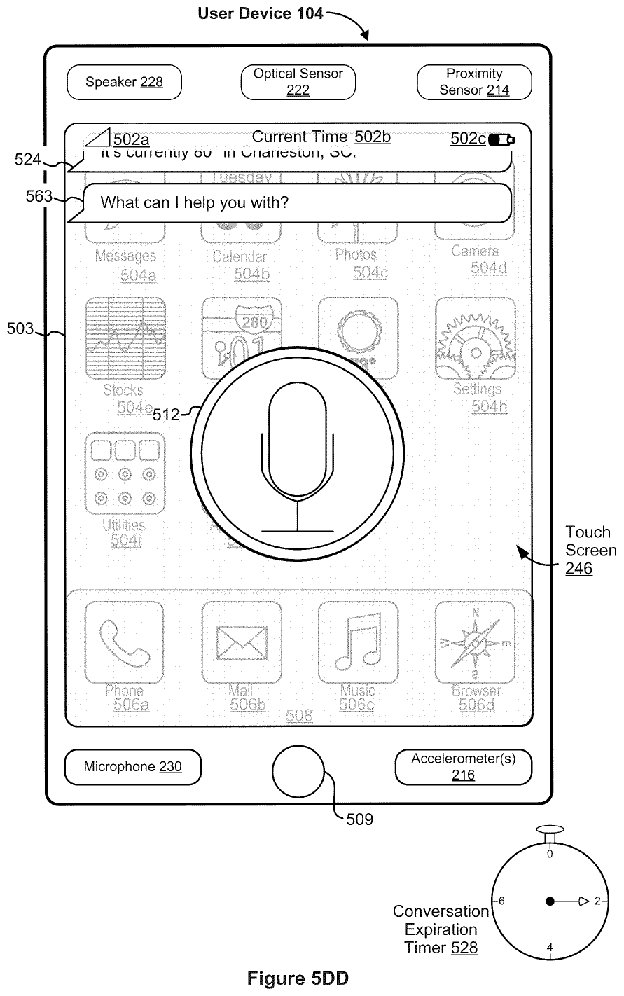

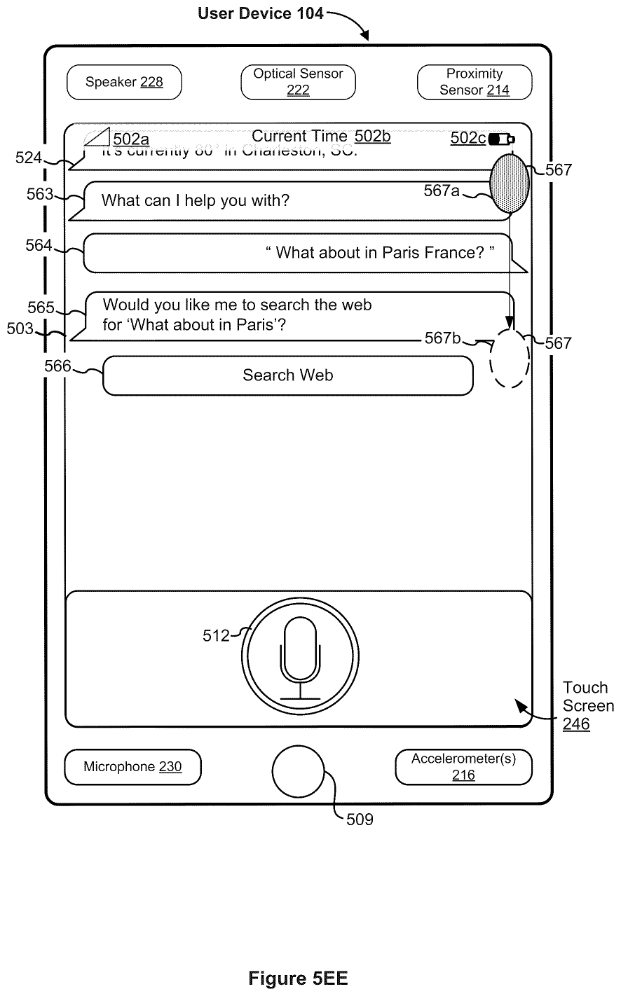

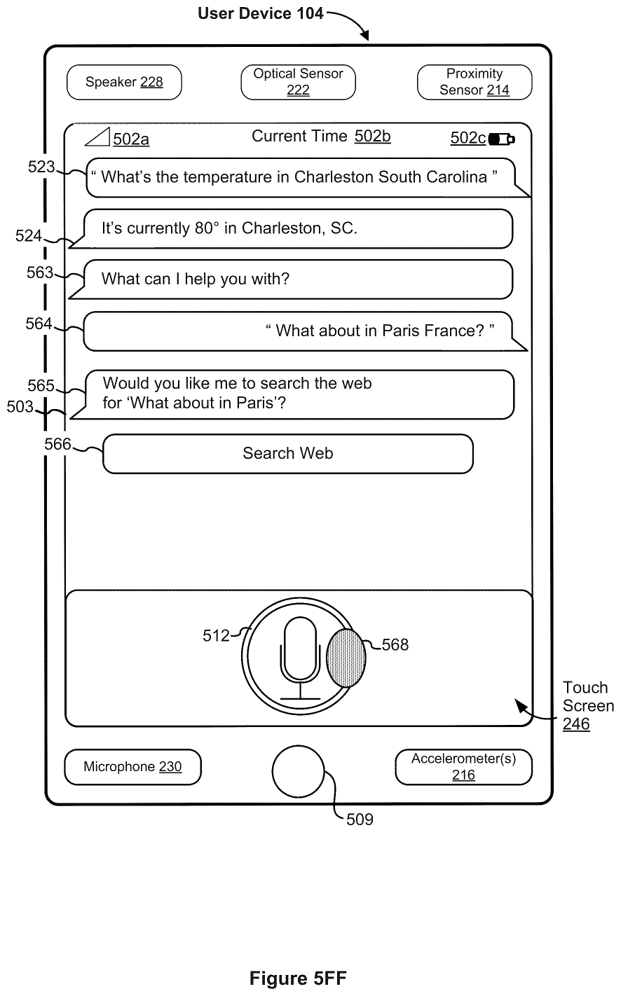

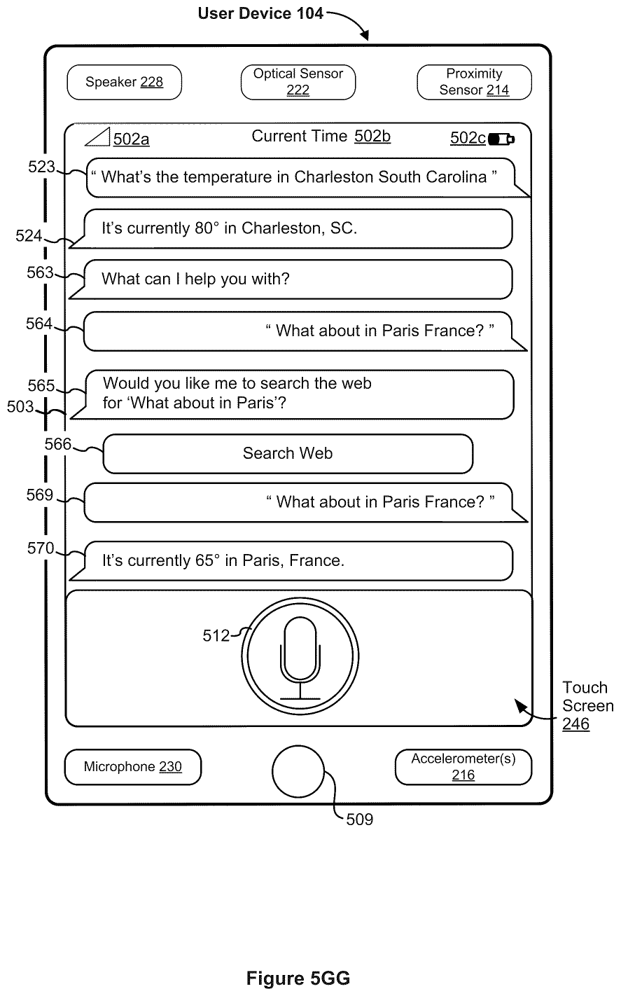

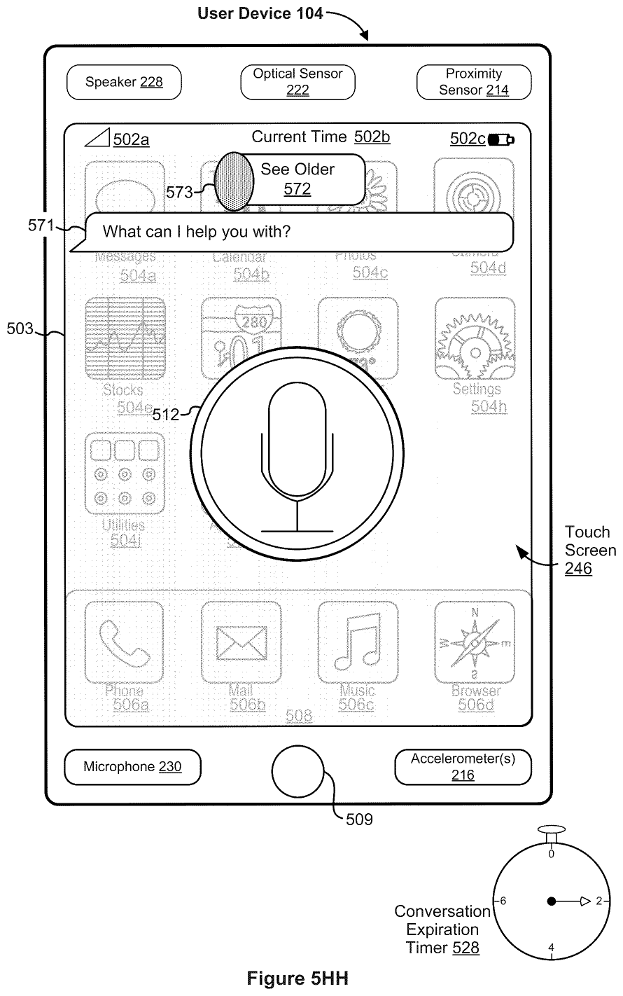

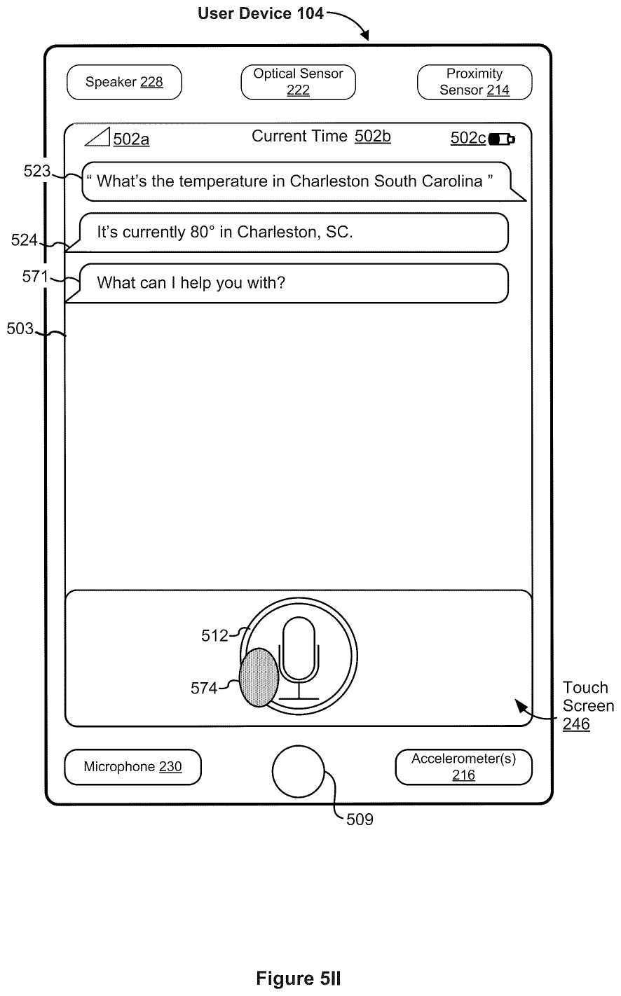

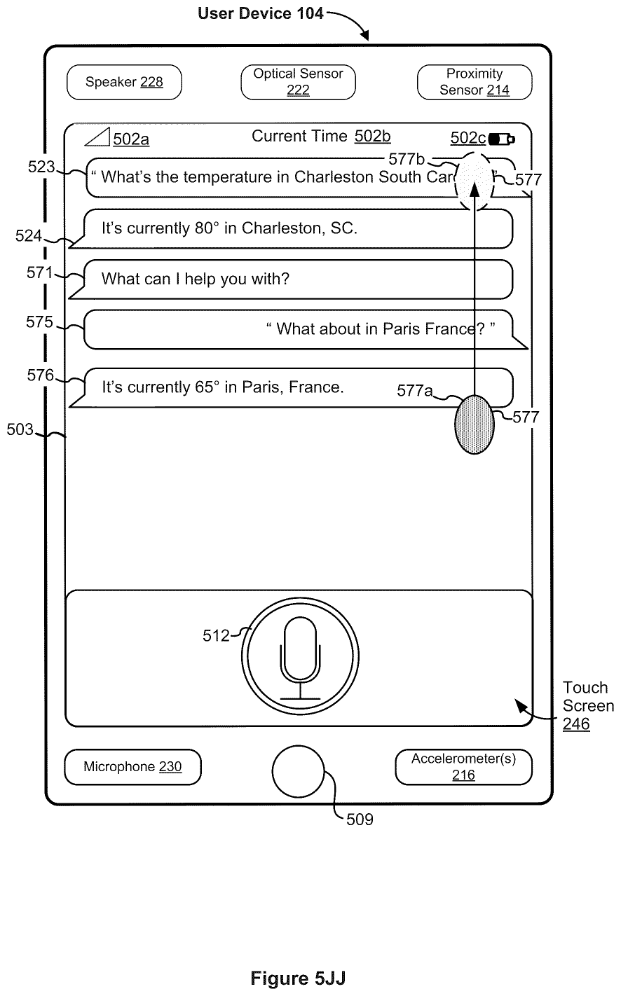

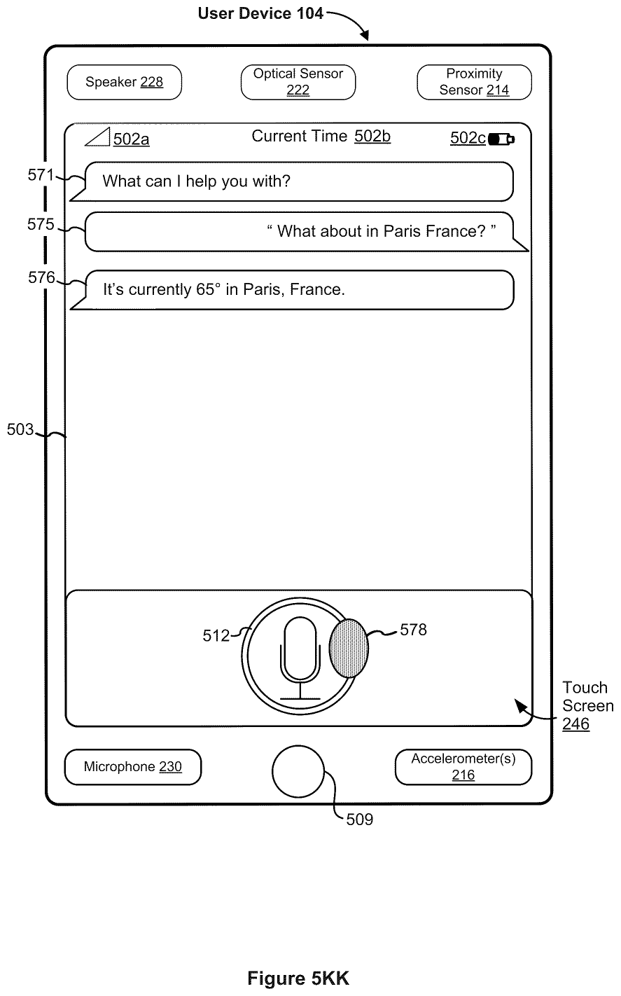

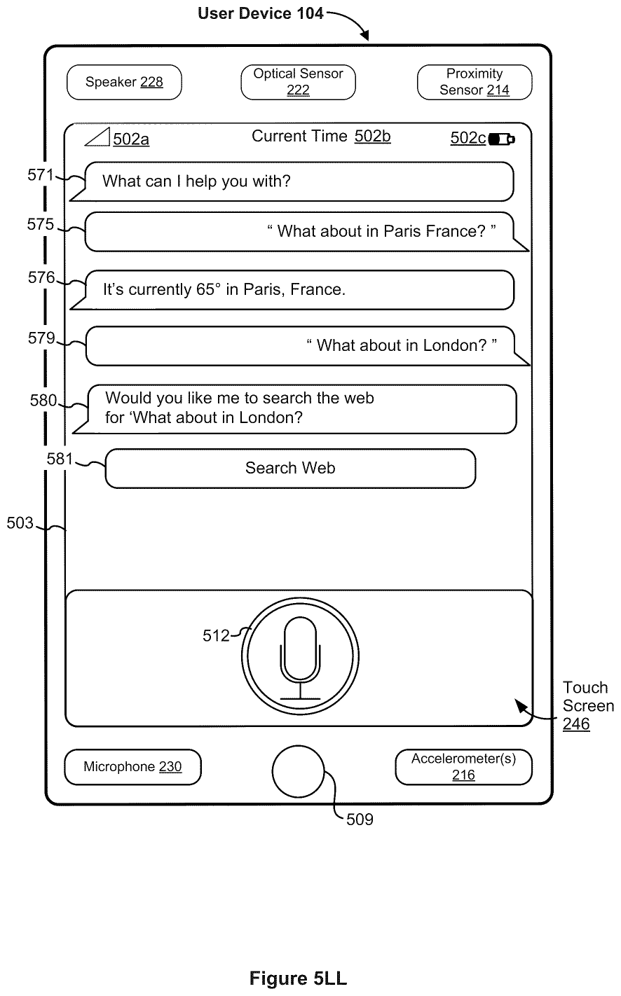

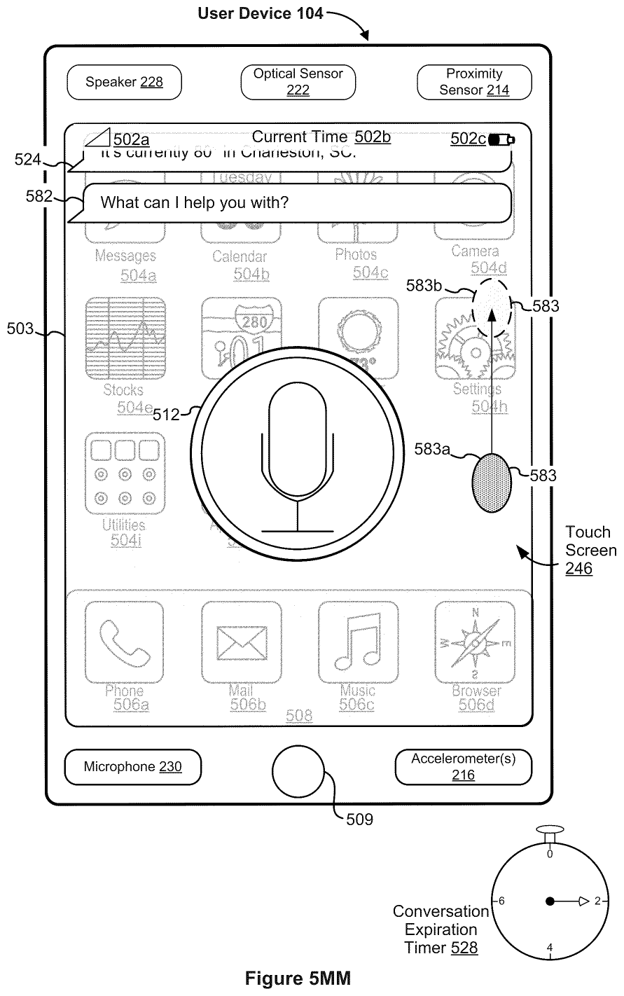

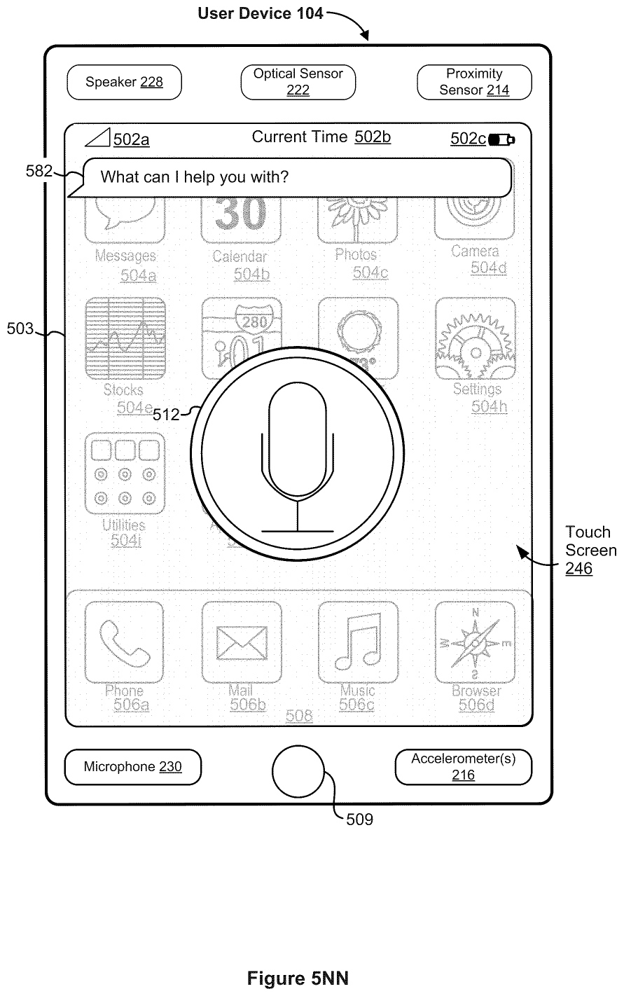

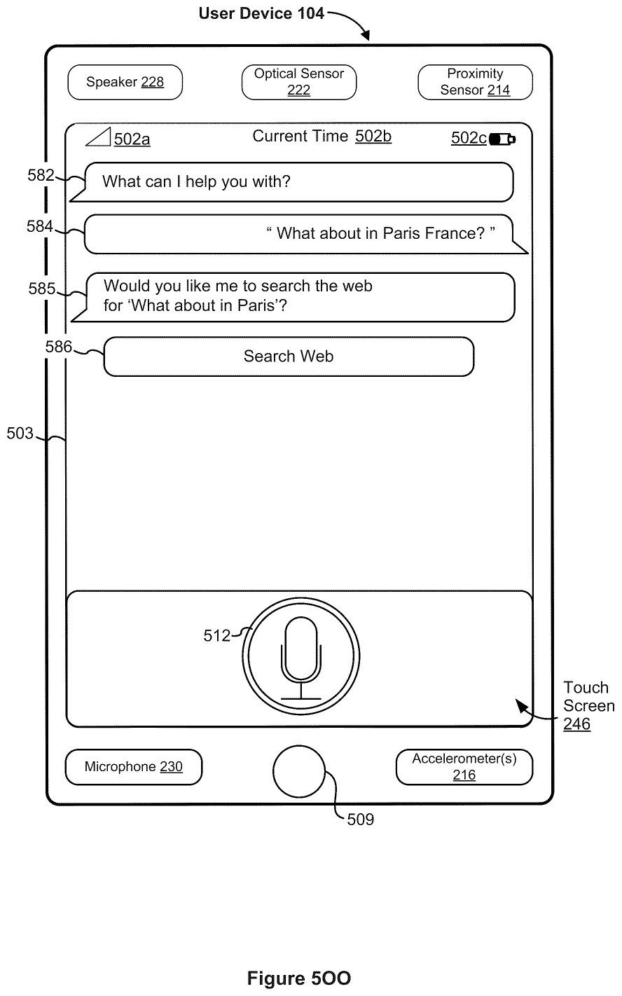

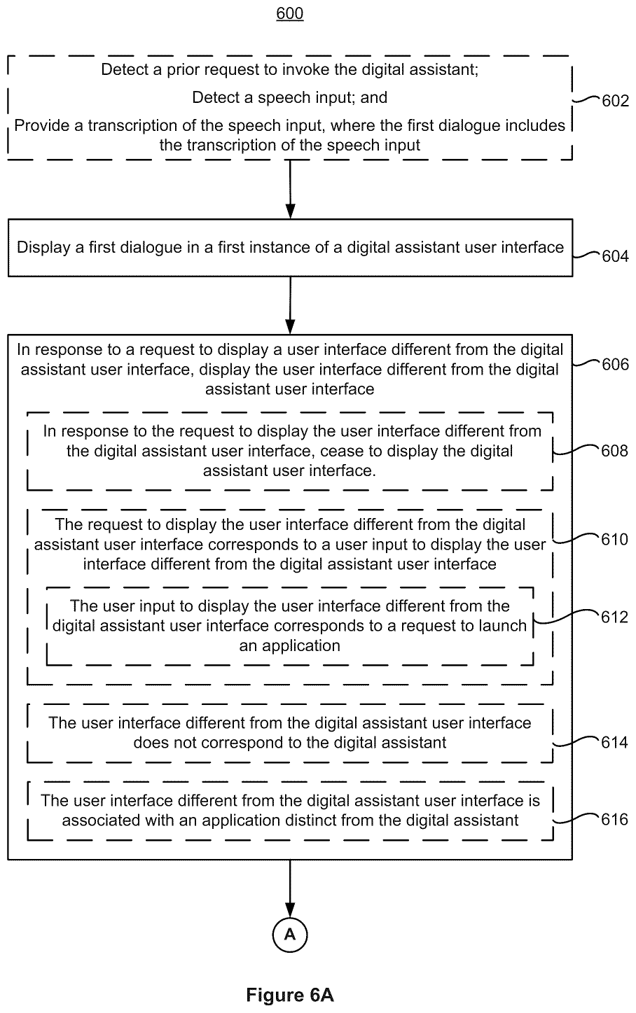

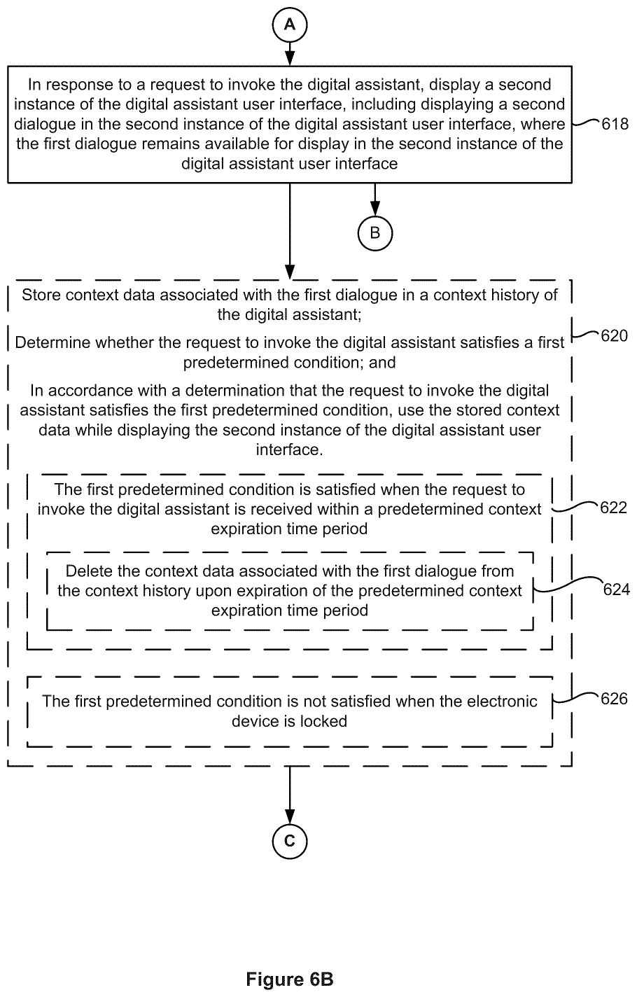

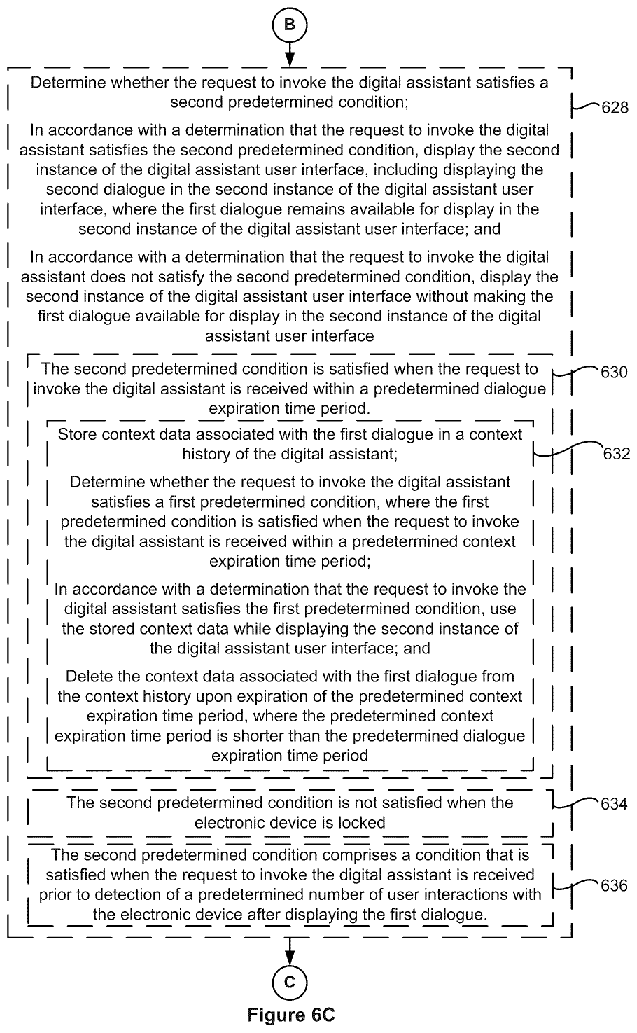

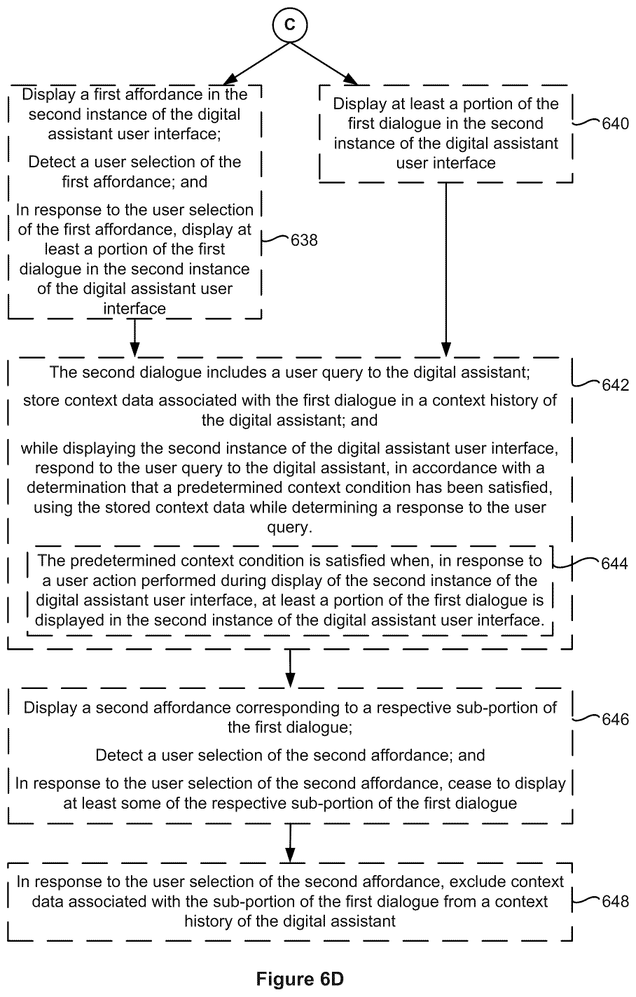

FIGS. 5A-OO illustrate exemplary user interfaces for enabling context and/or conversation persistence. FIGS. 6A-D are flow diagrams illustrating a method of enabling context and/or conversation persistence. The user interfaces in FIGS. 5A-OO are used to illustrate the processes illustrated in FIGS. 6A-D.

FIGS. 5A-OO illustrate a user device 104 with a touch screen 246 configured to display a user interface 503 and to receive touch input, a proximity sensor 214, other sensors 216 (e.g., one or more accelerometers), optical sensor 222 (a component of camera subsystem 220), a speaker 228 configured to generate sound, and a microphone 230 configured to receive sound input (e.g., speech input). User device 104, optionally, includes one or more physical buttons, such as “home” or menu button 509. Home button 509 is, optionally, used to navigate to a home screen or any application in a set of applications that are, optionally executed on user device 104. Alternatively, in some embodiments, the home button is implemented as a soft key (e.g., a user interface object, sometimes herein called an affordance, or user interface affordance) in a user interface displayed on touch screen 246.

FIG. 5A illustrates an exemplary user interface for a menu of applications on user device 104 in accordance with some embodiments. In some embodiments, user interface 503 includes the following elements, or a subset or superset thereof:
Signal strength indicator(s) 502a for wireless communication(s), such as cellular and Wi-Fi signals;
Current time indicator 502b;
Battery status indicator 502c;
Tray 508 with icons for frequently used applications, such as:
   Icon 506a for a telephone module, labeled “Phone”;
   Icon 506b for an e-mail client module, labeled “Mail”;
   Icon 506c for a video and music player module, labeled “Music”; and
   Icon 506d for an Internet browser module, labeled “Browser.”
Icons for other applications, such as:
   Icon 504a for a messages module, which provides access to SMS and MMS messages, labeled “Messages”;
   Icon 504b for a calendar module, labeled “Calendar”;
   Icon 504c for an image management module, labeled “Photos”;
   Icon 504d for a camera module, labeled “Camera”;
   Icon 504e for a stocks widget, labeled “Stocks”;
   Icon 504f for a map module, labeled “Maps”;
   Icon 504g for a weather widget, labeled “Weather”;
   Icon 504h for a settings application or module, which provides access to settings for user device 104, labeled “Settings”;
   Icon 504i for a utilities module, which provides access to one or more utility applications, labeled “Utilities”; and
   Icon 504j for an application store module, which provides access to a marketplace for applications, labeled “App Store.”

It should be noted that the icon labels illustrated in FIG. 5A are merely exemplary. For example, icon 506c for the video and music player module is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 5A illustrates user device 104 displaying user interface 503 on touch screen 246 with a plurality of application icons 504 and tray icons 506 in tray 508. FIG. 5A further illustrates detecting a user touch input 510 over home button 509.

FIG. 5B illustrates invoking a first instance of a digital assistant (DA) in response to detecting the long press with user touch input 510 over home button 509 in FIG. 5A. In some embodiments, a long press is a stationary touch contact held for more than a predetermined amount of time (e.g., 500 ms, 750 ms, 1 second, etc.). In response to invoking the DA, the DA audibly prompts the user by asking, “What can I help you with?” The DA's question is also transcribed in user interface 503. FIG. 5B further illustrates a digital assistant (DA) button 512. In some embodiments, DA button 512 is implemented as a soft key (e.g., a user interface object) in user interface 503. In some embodiments, in response to detecting a touch input over DA button 512, user device 104 is configured to activate (e.g., turn microphone 230 on) and enable the DA to receive an additional question. For example, in response to the DA's prompt, the user asks the DA, “What's the temperature in Palo Alto?”

FIG. 5C illustrates the DA's response to the user's question within a DA user interface. The DA responds to the user's question by stating, “It's currently 77° in Palo Alto,” which is transcribed in box 513a. The DA also displays a weather outlook 513b for the next twenty hour hours, three days, week, or the like. FIG. 5C further illustrates detecting a downward dragging gesture of user touch input 511 from position 511a to 511b.

FIG. 5D illustrates scrolling up a transcription (e.g., a speech to text transcription) of the current dialogue (or conversation) between the user and the DA within the DA user interface in response to detecting the downward dragging gesture in FIG. 5C. FIG. 5D shows a transcription of the user's question in box 514 and a partially displayed transcription of the DA's prompt in box 515. FIG. 5D further illustrates detecting a downward dragging gesture of user touch input 511 from position 511b to 511c.

FIG. 5E illustrates scrolling to the top of the transcription of the current dialogue (or conversation) between the user and the DA within the DA user interface in response to detecting the downward dragging gesture in FIG. 5D. FIG. 5E shows box 515 fully displayed in user interface 503. FIG. 5E further illustrates detecting a user touch input 516 over DA button 512. In response to user touch input 516 over DA button 512, the DA is activated (e.g., microphone 230 is turned on) and enabled to receive an additional question or request from the user. For example, after user device 104 detects touch input 516, the user asks the DA, “Show me nearby restaurants.”

FIG. 5F illustrates the DA's response to the user's request within the DA user interface. The DA responds to the user's request by stating, “I found fifteen restaurants . . . Fourteen of them are fairly close to you,” which is transcribed in box 516. The DA also displays a list 517 of fourteen restaurants nearby the user's current location including information container 517a pertaining to restaurant 1, information container 517b pertaining to restaurant 2, and information container 517c pertaining to restaurant 3. FIG. 5C further illustrates detecting a user touch input 518 over information container 517a pertaining to restaurant 1.

FIG. 5G illustrates displaying a break out of detailed information 519 related to “Restaurant 1” within the DA user interface. Detailed information 519 is displayed in response to detecting touch input 518 over the information container 517a pertaining to “Restaurant 1” in FIG. 5F. Detailed information 519 optionally includes one or more of: photos of Restaurant 1, Restaurant 1's hours of operation, Restaurant 1's phone number and website, the distance from the user's current location to Restaurant 1, and a map marking Restaurant 1's location relative to the user's current location. FIG. 5G shows “restaurants” button 520a configured to take the user back to list 517 of restaurants and “done” button 520b configured to exit the DA user interface and take the user to a home screen (e.g., done button 520b functions similarly to home button 509). FIG. 5G further illustrates detecting a user touch input 521 over restaurants button 520a.

More details on the display of related information within an instance of a DA user interface are described in U.S. Provisional Application Ser. No. 61/657,736 (Attorney Docket No. P10575USXP1/063266-5693-PR), filed on Jun. 8, 2012, entitled “Intelligent Automated Assistant,” the entire disclosure of which is incorporated herein by reference.

FIG. 5H illustrates displaying the transcription of the current dialogue (or conversation) between the user and the DA in response to detecting user touch input 521 over restaurants button 520a in FIG. 5G. The displayed transcription includes the same information as in FIG. 5F. FIG. 5H further illustrates detecting user touch input 522 over DA button 512. In response to user touch input 522 over DA button 512, the DA is activated and enabled to receive an additional question or request from the user. For example, after user device 104 detects touch input 522, the user asks the DA, “What's the temperature in Charleston South Carolina.”

FIG. 5I illustrates the DA's response to the user's request, which is transcribed in box 523, within the DA user interface. The DA responds to the user's request by stating, “It's currently 80° in Charleston, SC,” which is transcribed in box 524. FIG. 5I further illustrates detecting a user touch input 525 over home button 509.

FIG. 5J illustrates displaying a user interface (e.g., a home screen) different from the DA user interface in response to detecting user touch input 525 over home button 509 in FIG. 5I. FIG. 5J further illustrates detecting a user touch input 526 over home button 509.

FIG. 5K illustrates invoking a second instance of a digital assistant (DA) in response to detecting the long press with user touch input 526 over home button 509 in FIG. 5J. FIG. 5K further illustrates a context expiration timer 527 and a conversation expiration timer 528. In some implementations, context expiration timer 527 is a sixty second timer that starts upon the user exiting the DA user interface. In some other implementations, context expiration timer 527 is a predetermined duration (e.g., 0, 2, 3, 4, 5, 6, 7, 8, etc. minutes) or a user defined duration. If the user invokes a subsequent instance of the DA within sixty seconds of exiting the DA user interface (or, more generally, before context expiration timer 527 expires), contextual information from the previous instance of the DA is enabled for use by the natural language processor for intent inference in the subsequent instance of the DA. If the user does not invoke a subsequent instance of the DA before context expiration timer 527 expires, contextual information from the previous instance of the DA is deleted from a context history memory.

In some implementations, conversation expiration timer 528 is an eight minute timer that starts upon the user exiting the DA user interface. In some other implementations, conversation expiration timer 528 is a predetermined duration (e.g., 0, 2, 4, 6, 8, 10, etc. minutes) or a user defined duration. If the user invokes a subsequent instance of the DA within eight minutes second of exiting the DA user interface (or, more generally, before conversation expiration timer 528 expires), a portion of the transcript of the dialogue (or conversation) between the user and the DA from the previous instance of the DA is available for display in the subsequent instance of the DA user interface. If the user does not invoke a subsequent instance of the DA before conversation expiration timer 528 expires (e.g., within eight minutes second of exiting the DA user interface), the aforementioned portion of the transcript of the dialogue (or conversation) between the user and the DA from the previous instance of the DA is not available for display in the subsequent instance of the DA user interface.

FIG. 5K further illustrates that the invocation of the second instance of a digital assistant (DA) occurs, in this example, approximately thirty seconds after exiting the first instance of the DA user interface in response to detecting user touch input 525 over home button 509 in FIG. 5I. Therefore, neither context expiration timer 527 nor conversation expiration timer 528 has expired, and both context and conversation information from the first instance of the DA user interface persists in the second instance of the DA user interface. In response to invoking the second instance of the DA, the DA audibly prompts the user by asking, “What can I help you with?” For example, in response to the prompt, the user asks the DA, “What about in Paris France?”

FIG. 5L illustrates the second instance of the DA user interface in an embodiment including a scrollable transcript where at least a portion of the dialogue (or conversation) from the first instance of the DA user interface is available for display. FIG. 5L further illustrates the response to the user's question, which is transcribed in box 530, within the second instance of the DA user interface. The DA responds to the user's question by stating that, “It's currently 65° in Paris France,” which is transcribed in box 530a. The DA responds to the user's question with the aid of contextual information from the first instance of the DA user interface (e.g., weather context). Furthermore, a transcription of the DA's prompt is displayed in box 529, and a portion of the transcription of the dialogue (or conversation) between the user and the DA from the first instance of the DA user interface is partially displayed in box 524. FIG. 5L further illustrates detecting a downward dragging gesture (sometimes also herein called a “swipe gesture”) of user touch input 531 from position 531a to 531b.

FIG. 5M illustrates scrolling down a transcription (e.g., a speech to text transcription) of the dialogue (or conversation) between the user and the DA within the second instance of the DA user interface in response to detecting the downward dragging gesture detected in FIG. 5L. The displayed transcription includes dialogue from the current (second) instance of the DA user interface and dialogue from the previous (first) instance of the DA user interface. The displayed transcription includes the dialogue from the second instance of the DA user interface displayed in FIG. 5L. In box 524, the displayed transcription includes the user's question from the first instance of the DA user interface, “What's the temperature in Charleston South Carolina?” In box 523, the displayed transcription also includes the DA's response, “It's currently 80° in Charleston, SC,” to the user's question. The displayed transcription further includes the list 517 of restaurants from the first instance of the DA user interface including information container 517n pertaining to Restaurant 14 and a portion of information container 517m pertaining to Restaurant 13.

FIG. 5N illustrates the second instance of the DA user interface in another embodiment including a collapsible directory structure for a transcript of a dialogue between the user and the DA. In some embodiments, the directory structure divides question and answer pairs from the transcript into respective partitions. In some other embodiments, the directory structure divides the transcript into similar topics. FIG. 5N shows the dialogue from the first and second instances of the DA user interface divided into a dining topic 532 and a weather topic 533.

As shown in FIG. 5N, dining topic 532 is currently minimized (or collapsed), and button 534 is configured to maximize dining topic 532 so as to show at least a portion of the dialogue corresponding to the dining topic 532. Weather topic 533 is currently maximized and displays at least a portion of the dialogue related to weather from the first and second instances of the DA user interface. Button 535 is configured to minimize weather topic 533 so as to cease displaying the portion of the dialogue related to weather from the first and second instances of the DA user interface. FIG. 5N further illustrates detecting a user touch input 536 over button 535. Each user interface button is sometimes herein called an affordance, or user interface affordance, or user interface objection.

FIG. 5O illustrates minimizing weather topic 533 in response to detecting user touch input 536 over button 535 in FIG. 5N. FIG. 5O further illustrates detecting a user touch input 537 over DA button 512. In response to user touch input 537 over DA button 512, the DA is activated (e.g., microphone 230 is turned on) and enabled to receive an additional question or request from the user. For example, after user device 104 detects touch input 5137, the user asks the DA, “What about in Munich?”

In some embodiments, if a respective topic is minimized within the collapsible directory structure, contextual information for portions of the dialogue related to the respective topic are excluded from context history. In turn, the excluded contextual information is not used in intent inference by natural language processor 332 when the DA is attempting to respond to a user's question or request.

FIG. 5P illustrates the DA's response to the user's question, which is transcribed in box 538, within the second instance of the DA user interface. The DA responds to the user's request by stating, “Would you like me to search the web for ‘What about Munich’?” The second instance of the DA user interface also displays a “search the web” button 540 which is configured to execute a web search for ‘What about in Munich.’ In FIG. 5P, the DA does not infer that the user's question “What about in Munich?” refers to weather because contextual information related to weather topic 533 has been excluded from the context history.

FIG. 5Q illustrates invoking a second instance of a digital assistant (DA) in response to detecting the long press with user touch input 526 over home button 509 in FIG. 5J. FIG. 5Q further illustrates that the invocation of the second instance of a digital assistant (DA) occurs, in this example, approximately two minutes (e.g., conversation expiration timer 528 is at the two minute marker) after exiting the first instance of the DA user interface in response to user touch input 525 over home button 509 in FIG. 5I. Therefore, context expiration timer 527 has expired, and only conversation information from the first instance of the DA user interface persists in the second instance of the DA user interface. In response to invoking the second instance of the DA, the DA audibly prompts the user by asking, “What can I help you with?” For example, in response to the prompt, the user asks the DA, “What about in Paris France?”

FIG. 5R illustrates the second instance of the DA user interface in an embodiment where a transcript of the dialogue (or conversation) between the user and the DA from the first instance of the DA user interface is available for display. FIG. 5R also illustrates “see older” button 541 displayed in user interface 503. “See older” button 541 is configured to display at least a portion of the transcript of the dialogue from the first instance of the DA user interface. A transcription of dialogue from the second instance of the DA user interface is displayed below “see older” button 541. The transcription of dialogue from the second instance of the DA user interface includes the DA's prompt displayed in box 542, the user's question displayed in box 543, and the DA's response displayed in box 544.

As transcribed in box 544, the DA responds to the user's question by stating, “Would you like me to search the web for ‘What about in Paris France’?” The second instance of the DA user interface also displays a “search the web” button 545 which is configured to execute a web search for ‘What about in Paris France.’ In FIG. 5R, the DA does not infer that the user's question, transcribed in box 543, refers to weather because contextual information from the first instance of the DA user interface has been deleted from the context history due to context expiration timer expiring prior to invocation of the second instance of the DA. FIG. 5R further illustrates detecting user touch input 546 over “see older” button 541.

FIG. 5S illustrates displaying, in the second instance of the DA user interface, at least a portion of the transcript of the dialogue from the first instance of the DA user interface in response detecting to user touch input 546 over “see older” button 541 in FIG. 5R. The displayed transcription includes dialogue from the current (second) instance of the DA user interface and dialogue from the previous (first) instance of the DA user interface. The displayed transcription includes the dialogue from the second instance of the DA user interface displayed in FIG. 5R. The displayed transcription includes the user's question “What's the temperature in Charleston South Carolina?” and the DA's response “It's currently 80° in Charleston, SC” from the first instance of the DA user interface. The displayed transcription further includes list 517 of restaurants from the first instance of the DA user interface including information container 517n pertaining to Restaurant 14.

FIG. 5T illustrates invoking a second instance of a digital assistant (DA) in response to detecting the long press with user touch input 526 over home button 509 in FIG. 5J. FIG. 5T further illustrates that the invocation of the second instance of a digital assistant (DA) occurs more than eight minutes after exiting the first instance of the DA user interface in response to user touch input 525 over home button 509 in FIG. 5I. Therefore, both context expiration timer 527 and conversation expiration timer 528 have expired, and neither context nor conversation information from the first instance of the DA user interface persists in the second instance of the DA user interface. In response to invoking the second instance of the DA, after the expiration of both context expiration timer 527 and conversation expiration timer 528, the DA audibly prompts the user by asking, “What can I help you with?” For example, in response to the prompt, the user asks the DA, “What about in Paris France?”

FIG. 5U illustrates the second instance of the DA user interface in an embodiment where a transcript of the dialogue (or conversation) between the user and the DA from the first instance of the DA user interface is not available for display. As transcribed in box 549, the DA responds to the user's question by stating, “Would you like me to search the web for ‘What about in Paris France’?” The second instance of the DA user interface also displays “search the web” button 550 which is configured to execute a web search for ‘What about in Paris France.’ In FIG. 5U, the DA does not infer that the user's question, transcribed in box 548, refers to weather because contextual information from the first instance of the DA user interface has been deleted from the context history due to context expiration timer 527 expiring prior to the invocation of the second instance of the DA. FIG. 5U further illustrates detecting a downward dragging gesture of user touch input 551 from position 551a to 551b.

FIG. 5V illustrates scrolling up user interface 503 in response to detecting the downward dragging gesture in FIG. 5U. A portion of the transcript from the first instance of the DA user interface is not available for display even after scrolling upwards because the conversation expiration timer 528 expired before the second instance of the DA was invoked.

FIG. 5W illustrates displaying a user interface (e.g., a lock screen) different from the DA user interface. FIG. 5W further illustrates detecting a user touch input 552 over home button 509.

FIG. 5X illustrates invoking a second instance of a digital assistant (DA) in response to detecting the long press with user touch input 552 over home button 509 in FIG. 5W. FIG. 5X further illustrates that the invocation of the second instance of a digital assistant (DA) occurs, in this example, approximately thirty seconds after exiting the first instance of the DA user interface in response to user touch input 525 over home button 509 in FIG. 5I. In some embodiments, while user device 104 is locked, neither context nor conversation information from the first instance of the DA user interface persists in the second instance of the DA user interface even when neither the context expiration timer 527 nor the conversation expiration timer have expired. In response to invoking the second instance of the DA, the DA audibly prompts the user by asking, “What can I help you with?” For example, in response to the prompt, the user asks the DA, “What about in Budapest?”

FIG. 5Y illustrates the second instance of the DA user interface in an embodiment where a transcript of the dialogue (or conversation) between the user and the DA from the first instance of the DA user interface is not available for display. As transcribed in box 555, the DA responds to the user's question by stating, “Would you like me to search the web for ‘What about in Budapest’?” The second instance of the DA user interface also displays “search the web” button 556 which is configured to execute a web search for ‘What about in Budapest.’ In FIG. 5Y, the DA does not infer that the user's question, transcribed in box 554, refers to weather because contextual information from the first instance of the DA user interface is excluded from context history while user device 104 is locked. FIG. 5Y further illustrates detecting a user touch input 557 over home button 509.

FIG. 5Z illustrates displaying a user interface (e.g., a lock screen) different from the DA user interface in response to detecting the user touch input 557 over home button 509 in FIG. 5Y. FIG. 5Z further illustrates detecting a horizontal dragging gesture of user touch input 558 from position 558a to 558b so as to unlock user device 104.

FIG. 5AA illustrates displaying a user interface (e.g., an unlocked home screen) different from the DA user interface in response to detecting the horizontal dragging gesture in FIG. 5Z. FIG. 5AA further illustrates detecting a user touch input 559 over home button 509.

FIG. 5BB illustrates invoking a second instance of a digital assistant (DA) in response to detecting the long press with user touch input 559 over home button 509 in FIG. 5AA. FIG. 5BB further illustrates that the invocation of the second instance of a digital assistant (DA) occurs approximately fifty seconds (e.g., context expiration timer 527 is at approximately the fifty seconds marker) after exiting the first instance of the DA user interface in response to user touch input 525 over home button 509 in FIG. 5I. Therefore, neither context expiration timer 527 nor conversation expiration timer 528 has expired, and both context and conversation information from the first instance of the DA user interface persists in the second instance of the DA user interface. In response to invoking the second instance of the DA, the DA audibly prompts the user by asking, “What can I help you with?” For example, in response to the prompt, the user asks the DA, “What about in Budapest?”

FIG. 5CC illustrates the second instance of the DA user interface in an embodiment including a scrollable transcript where at least a portion of the dialogue (or conversation) from the first instance of the DA user interface is available for display. FIG. 5CC also illustrates the response to the user's question, which is transcribed in box 561, within the second instance of the DA user interface. As transcribed in box 562, the DA responds to the user's question by stating, “It's currently 70° in Budapest.” The DA responds to the user's question with the aid of contextual information from the first instance of the DA user interface (e.g., weather context). FIG. 5CC further illustrates partially displaying a portion of the transcription of the dialogue (or conversation) between the user and the DA from the first instance of the DA user interface in box 524.

FIG. 5DD illustrates invoking a second instance of a digital assistant (DA) in response detecting to the long press with user touch input 526 over home button 509 in FIG. 5J. FIG. 5DD further illustrates a conversation expiration timer 528. In some embodiments, conversation expiration timer 528 is a predetermined time period (e.g., 2, 4, 6, 8, 10 minutes, etc.) or a user defined time period. In one implementation, conversation expiration timer 528 is an eight minute timer that starts upon the user exiting the DA user interface. If the user invokes a subsequent instance of the DA within eight minutes second of exiting the DA user interface (or, more generally, before conversation expiration timer 528 expires), a portion of the transcript of the dialogue (or conversation) between the user and the DA from the previous instance of the DA is available for display in the subsequent instance of the DA user interface. If the user does not invoke a subsequent instance of the DA before conversation expiration timer 528 expires (e.g., within eight minutes second of exiting the DA user interface), the aforementioned portion of the transcript of the dialogue (or conversation) between the user and the DA from the previous instance of the DA is not available for display in the subsequent instance of the DA user interface. In addition, if the user does not invoke a subsequent instance of the DA before conversation expiration timer 528 expires, user device 104 deletes stored contextual information corresponding to the dialogue (or conversation) between the user and the DA from the previous instance of the DA from context history.

FIG. 5DD illustrates a prophetic example in which the invocation of the second instance of a digital assistant (DA) occurs, in this example, approximately two minutes after exiting the first instance of the DA user interface in response to user touch input 525 over home button 509 in FIG. 5I. Therefore, conversation expiration timer 528 has not expired, and conversation information from the first instance of the DA user interface persists in the second instance of the DA user interface. Furthermore, FIG. 5DD illustrates partially displaying a portion of the transcription of the dialogue (or conversation) between the user and the DA from the first instance of the DA user interface in box 524, and a transcription of the DA's prompt is displayed in box 563 (e.g., “What can I help you with?”). In response to invoking the second instance of the DA, the DA audibly prompts the user by asking, “What can I help you with?” For example, in response to the prompt, the user asks the DA, “What about in Paris France?” In some embodiments, portions of the home screen that are visible when the DA user interface is displayed in user interface 503 are blurred, shaded, or otherwise made visually less distinct. For example, in FIG. 5DD, a portion of the home screen (e.g., including application icons 504a, 504b, 504c, 504d, 504c, 504f, 504g, 504h, 504i, 504j and tray icons 506a, 506b, 506c, 506d) is partially displayed or blurred beneath the second instance of the DA user interface in user interface 503.

FIG. 5EE illustrates the second instance of the DA user interface in an embodiment where a transcript of the dialogue (or conversation) between the user and the DA from the first instance of the DA user interface is available for display. As transcribed in box 565 of FIG. 5EE, the DA responds to the user's question by stating, “Would you like me to search the web for ‘What about in Paris France’?” The second instance of the DA user interface also displays a “search the web” button 545 which is configured to execute a web search for ‘What about in Paris France.’

In some embodiments, contextual information from the first instance of the digital user interface is invoked when at least a portion of the first dialogue between the DA and the user from the first instance of the DA user interface is displayed in user interface 503 on touch screen 112 in response to a user action (e.g., a tap or swipe gesture on touch screen 112). In FIG. 5EE, the DA does not infer that the user's query, transcribed in box 564, refers to weather when responding to the user's query because contextual information from the first instance of the DA user interface has not been invoked at or before receiving user query 564. The DA does not invoke contextual information from the first instance of the DA user interface when responding to user query 564 because user device 104 has not detected a user action (e.g., a tap or swipe gesture on touch screen 112) to display at least a portion of the first dialogue between the DA and the user from the first instance of the DA user interface at or before receiving user query 564. FIG. 5EE further illustrates detecting a downward dragging gesture (sometimes also called a “swipe gesture”) of user touch input 567 from position 567a to 567b on touch screen 112.

FIG. 5FF illustrates scrolling down a transcription (e.g., a speech to text transcription) of the dialogue (or conversation) between the user and the DA within the second instance of the DA user interface in response to detecting the downward dragging gesture detected in FIG. 5EE. The transcription displayed in FIG. 5FF includes dialogue from the current (second) instance of the DA user interface and dialogue from the previous (first) instance of the DA user interface. The transcription displayed in FIG. 5FF includes the dialogue from the second instance of the DA user interface (e.g., the DA's prompt 563, user query 564, and the DA's response 565, 566). In box 523, the transcription displayed in FIG. 5FF includes the user's question from the first instance of the DA user interface, “What's the temperature in Charleston South Carolina?” In box 524, the transcription displayed in FIG. 5FF also includes the DA's response, “It's currently 80° in Charleston, SC,” to the user's question in the first instance of the DA user interface.

FIG. 5FF further illustrates detecting a user touch input 568 over DA button 512 on touch screen 112. In response to user touch input 568 over DA button 512, the DA is activated (e.g., microphone 230 is turned on) and enabled to receive an additional question (also sometimes herein called a “query”) or request from the user. For example, after user device 104 detects user touch input 568, the user asks the DA, “What about in Paris?”

FIG. 5GG illustrates the DA's response to the user's query within the DA user interface. In FIG. 5GG, the DA responds to the user's question by stating, “It's currently 65° in Paris France,” which is transcribed in box 670. In FIG. 5GG, the DA infers that the user's query, transcribed in box 569, refers to weather when responding to the user's query because the contextual information from the first instance of the DA user interface has been invoked at or before receiving user query 569. The DA invokes contextual information from the first instance of the DA user interface when responding to user query 569 because user device 104 has detected a user action (e.g., the dragging gesture detected in FIG. 5EE) to display at least a portion of the first dialogue between the DA and the user from the first instance of the DA user interface (e.g., user query 523 and the DA's response 524 to the user query 523) at or before receiving user query 569.

FIG. 5HH illustrates invoking a second instance of a digital assistant (DA) in response to detecting the long press with user touch input 526 over home button 509 in FIG. 5J. FIG. 5HH also illustrates a conversation expiration timer 528. In some implementations, conversation expiration timer 528 is an eight minute timer that starts upon the user exiting the DA user interface. FIG. 5HH further illustrates that the invocation of the second instance of a digital assistant (DA) occurs, in this example, approximately two minutes after exiting the first instance of the DA user interface in response to user touch input 525 over home button 509 in FIG. 5I. Therefore, conversation expiration timer 528 has not expired, and conversation information from the first instance of the DA user interface persists in the second instance of the DA user interface.

FIG. 5HH also illustrates displaying “see older” button 572 within the DA user interface. “See older” button 572 is configured to display at least a portion of the transcript of the dialogue from the first instance of the DA user interface. FIG. 5HH also illustrates detecting user touch input 573 over “see older” button 572 on touch screen 112. Furthermore, in FIG. 5HH, a portion of the home screen (e.g., including application icons 504a, 504b, 504c, 504d, 504c, 504f, 504g, 504h, 504i, 504j and tray icons 506a, 506b, 506c, 506d) is partially displayed or blurred beneath the second instance of the DA user interface in user interface 503.

FIG. 5II illustrates displaying, in the second instance of the DA user interface, at least a portion of the transcript of the dialogue from the first instance of the DA user interface in response to detecting user touch input 573 over “see older” button 572 in FIG. 5HH. The transcription displayed in FIG. 5II includes dialogue from the current (second) instance of the DA user interface and dialogue from the previous (first) instance of the DA user interface. The transcription displayed in FIG. 5II includes the dialogue from the second instance of the DA user interface displayed (e.g., the DA's prompt “What can I help you with” transcribed in box 571). The transcription displayed in FIG. 5II also includes the user's query (transcribed in box 523) and the DA's response (transcribed in box 524) to user query 523 from the first instance of the DA user interface.

FIG. 5II further illustrates detecting user touch input 574 over DA button 512. In response to user touch input 574 over DA button 512, the DA is activated (e.g., microphone 230 is turned on) and enabled to receive an additional query or request from the user. For example, after user device 104 detects user touch input 574, the user asks the DA, “What about in Paris?”

FIG. 5JJ illustrates the DA's response to the user's query within the DA user interface. In FIG. 5JJ, the DA responds to the user's question by stating, “It's currently 65° in Paris France,” which is transcribed in box 576. In FIG. 5JJ, the DA infers that the user's query, transcribed in box 576, refers to weather when responding to the user's query because contextual information from the first instance of the DA user interface has been invoked at or before receiving user query 576. The DA invokes contextual information from the first instance of the DA user interface when responding to user query 576 because user device 104 has detected a user action (e.g., user touch input 573 detected over “see older” button 572 in FIG. 5HH) to display at least a portion of the first dialogue between the DA and the user from the first instance of the DA user interface (e.g., user query 523 and DA response 524) at or before receiving user query 576. FIG. 5JJ further illustrates detecting an upward dragging gesture (sometimes also called a “swipe gesture”) of user touch input 577 from position 577a to 577b on touch screen 112.

FIG. 5KK illustrates ceasing to display the portion of the transcription (e.g., boxes 523 and 524) of the dialogue (or conversation) between the user and the DA from the first instance of the DA user interface in the second instance of a digital assistant (DA) in response to detecting the upward dragging gesture in FIG. 5JJ. In some embodiments, conversation information (or the transcription of the dialogue) from the first instance of the DA user interface is deleted (or excluded) from conversation history 354 in response to detecting an upward dragging gesture that scrolls displayed portions of the transcription of the dialogue (or conversation) between the user and the DA from the first instance of the DA user interface off of user interface 503. Furthermore, in some embodiments, context information from the first instance of the DA user interface is deleted (or excluded) from context history 352 in response to detecting an upward dragging gesture that scrolls displayed portions of the transcription of the dialogue (or conversation) between the user and the DA from the first instance of the DA user interface off of user interface 503.

FIG. 5KK further illustrates detecting a user touch input 578 over DA button 512 on touch screen 112. In response to user touch input 578 over DA button 512, the DA is activated (e.g., microphone 230 is turned on) and enabled to receive an additional question (also sometimes herein called a “query”) or request from the user. For example, after user device 104 detects user touch input 578, the user asks the DA, “What about in London?”

FIG. 5LL illustrates the second instance of the DA user interface in an embodiment where conversation and context information from the first instance of the DA has been deleted or excluded from conversation history 354 and context history 352, respectively. As transcribed in box 580 of FIG. 5LL, the DA responds to the user's question by stating, “Would you like me to search the web for ‘What about in London?’” The second instance of the DA user interface also displays a “search the web” button 581 which is configured to execute a web search for ‘What about in London.’

In FIG. 5LL, the DA does not infer that the user's query, transcribed in box 579, refers to weather when responding to the user's query because contextual information from the first instance of the DA user interface has been deleted (or excluded) from context history 352 at or before receiving user query 579. The DA does not invoke contextual information from the first instance of the DA user interface when responding to user query 579 because user device 104 detected a user action in FIG. 5JJ (e.g., the upward swipe gesture with user touch input 577) to cease to display the first dialogue (e.g., boxes 523 and 524) between the DA and the user from the first instance of the DA user interface at or before receiving user query 579.

FIG. 5MM illustrates invoking a second instance of a digital assistant (DA) in response to detecting the long press with user touch input 526 over home button 509 in FIG. 5J. FIG. 5MM also illustrates a conversation expiration timer 528. In some implementations, conversation expiration timer 528 is an eight minute timer that starts upon the user exiting the DA user interface. FIG. 5MM further illustrates that the invocation of the second instance of a digital assistant (DA) occurs, in this example, approximately two minutes after exiting the first instance of the DA user interface in response to user touch input 525 over home button 509 in FIG. 5I. Therefore, conversation expiration timer 528 has not expired, and conversation information from the first instance of the DA user interface persists in the second instance of the DA user interface. Furthermore, FIG. 5MM illustrates partially displaying a portion of the transcription of the dialogue (or conversation) between the user and the DA from the first instance of the DA user interface in box 524, and a transcription of the DA's prompt is displayed in box 582 (e.g., “What can I help you with?”).

FIG. 5MM further illustrates detecting an upward dragging gesture (sometimes also called a “swipe gesture”) of user touch input 583 from position 583a to 583b on touch screen 112. Furthermore, in FIG. 5MM, a portion of the home screen (e.g., including application icons 504a, 504b, 504c, 504d, 504c, 504f, 504g, 504h, 504i, 504j and tray icons 506a, 506b, 506c, 506d) is partially displayed or blurred beneath the second instance of the DA user interface in user interface 503.

FIG. 5NN illustrates ceasing to display any portion of the transcription (e.g., box 524) of the dialogue (or conversation) between the user and the DA from the first instance of the DA user interface in the second instance of a digital assistant (DA) in response to detecting the upward dragging gesture in FIG. 5MM. In some embodiments, conversation information (or the transcription of the dialogue) from the first instance of the DA user interface is deleted (or excluded) from conversation history 354 in response to detecting an upward dragging gesture that scrolls displayed portions of the transcription of the dialogue (or conversation) between the user and the DA from the first instance of the DA user interface off of user interface 503. Furthermore, in some embodiments, context information from the first instance of the DA user interface is deleted (or excluded) from context history 352 in response to detecting an upward dragging gesture that scrolls displayed portions of the transcription of the dialogue (or conversation) between the user and the DA from the first instance of the DA user interface off of user interface 503. For example, in response to the prompt transcribed in box 582, the user asks the DA, “What about in Paris France?”

FIG. 5OO illustrates the second instance of the DA user interface in an embodiment where the transcript of the dialogue (or conversation) between the user and the DA from the first instance of the DA has been deleted or excluded from conversation history 354 and has ceased to be displayed. As transcribed in box 585 of FIG. 5OO, the DA responds to the user's question by stating, “Would you like me to search the web for ‘What about in Paris France’?” The second instance of the DA user interface also displays a “search the web” button 586 which is configured to execute a web search for ‘What about in Paris France.’

In FIG. 5OO, the DA does not infer that the user's query, transcribed in box 584, refers to weather when responding to the user's query because contextual information from the first instance of the DA user interface has been deleted (or excluded) from context history 352 at or before receiving user query 584. The DA does not invoke contextual information from the first instance of the DA user interface when responding to user query 584 because user device 104 has not detected a user action (e.g., a tap or swipe gesture on touch screen 112) to display at least a portion of the first dialogue between the DA and the user from the first instance of the DA user interface at or before receiving user query 584. Instead, user device 104 detected a user action in FIG. 5MM (e.g., the upward swipe gesture with user touch input 583) to cease to display the first dialogue (e.g., box 524) between the DA and the user from the first instance of the DA user interface at or before receiving user query 584.

FIGS. 6A-D illustrate a flow diagram of a method 600 of operating a digital assistant in accordance with some embodiments. In some embodiments, method 600 is performed at an electronic device (e.g., user device 104) including a display, one or more processors and memory (e.g., a respective DA-client 102 or DA-server 106). In some embodiments, portions of method are performed at the electronic device (e.g., a respective DA-client 102), while other portions are performed at a server (e.g., DA-server 106). In some embodiments, method 600 is performed at the digital assistant 326 illustrated in FIGS. 3A-B and 4. In some embodiments, method 600 is governed by a set of instructions stored in memory (e.g., a non-transitory computer readable storage media) that are executed by the one or more processors of the electronic device.

In some embodiments, prior to displaying the first instance of the digital assistant user interface, the electronic device: detects (602) a prior request to invoke the digital assistant; detects a speech input; and provides a transcription of the speech input, where the first dialogue includes the transcription of the speech input. FIGS. 5A-B, for example, show a user invoking a first instance of a digital assistant (DA) in response to a long press with user touch input 510 over home button 509 of user device 104. FIGS. 5B-D, for example, show user device 104 detecting a speech input from a user asking “What's the temperature in Palo Alto?” and converting said speech input to text for display in box 514 of FIG. 5D. FIG. 5E, for example, shows user device 104 displaying a transcription of a dialogue (or conversation) between the user and the DA in boxes 515, 514, and 513a.

The electronic device displays (604) a first dialogue (e.g., a transcription of interactions between the user of user device 104 and the DA) in a first instance of a digital assistant user interface. In some embodiments, a user interface is an application environment. In some embodiments, the DA user interface occupies the entirety of touch screen 246 of user device 104. FIG. 5E, for example, shows user device 104 displaying a transcription of a dialogue between the user and the DA in boxes 515, 514, and 513a displayed in a first instance of a digital assistant user interface.

In response to a request to display a user interface different from the digital assistant user interface, the electronic device displays (606) the user interface different from the digital assistant user interface. FIG. 5J, for example, shows user device 104 displaying a user interface (e.g., a home screen) different from the DA user interface in response to user touch input 525 over home button 509 in FIG. 5I. In some embodiments, the user interface different from DA user interface occupies the entirety of touch screen 246 of user device 104.

In some embodiments, in response to the request to display the user interface different from the digital assistant user interface, the electronic device ceases (608) to display the digital assistant user interface (e.g., all vestiges of the DA user interface are removed from touch screen 246). FIG. 5J, for example, shows user device 104 displaying a user interface (e.g., a home screen) different from the DA user interface where no portion of the first instance of the DA user interface from FIGS. 5C-I remains on touch screen 246.

In some embodiments, the request to display the user interface different from the digital assistant user interface corresponds (610) to a user input to display the user interface different from the digital assistant user interface (e.g., the user touches or clicks the home button). FIG. 5J, for example, shows user device 104 displaying a user interface (e.g., a home screen) different from the DA user interface in response to user touch input 525 over home button 509 in FIG. 5I.

In some embodiments, the user input to display the user interface different from the digital assistant user interface corresponds (612) to a request to launch an application.

In some embodiments, the user interface different from the digital assistant user interface does not correspond (614) to the digital assistant (e.g., the user interface different from the DA user interface is not suggested or linked by the DA). In FIG. 5J, for example, the home screen does not correspond to the digital assistant. In contrast, in FIG. 5G, the break out of detailed information 519 related to Restaurant 1, for example, corresponds to the DA because Restaurant 1 was suggested by the DA in FIG. 5F. Furthermore, the break out of detailed information 519 is displayed in response to user input 518 over information container 517a in FIG. 5F.

In some embodiments, the user interface different from the digital assistant user interface is associated with (616) an application distinct from the digital assistant (e.g., a programmatic boundary is crossed). For example, in response to user input 525 over home button 509 in FIG. 5I, user device 104 ceases to display the DA user interface and displays the home screen in user interface 503 in FIG. 5J.

In response to a request to invoke the digital assistant, the electronic device displays (618) a second instance of the digital assistant user interface, including displaying a second dialogue in the second instance of the digital assistant user interface, where the first dialogue remains available for display in the second instance of the digital assistant user interface. In some embodiments, the second instance of the DA user interface is displayed at a time following (or later than) exiting the first instance of the DA user interface. For example, in response to the long press with user touch input 526 over home button 509 in FIG. 5J, user device 104 displays (as shown in FIG. 5L) a second instance of the DA user interface with scrollable a transcript where at least a portion of the dialogue (or conversation) from the first instance of the DA user interface is available for display. In FIG. 5L, a portion of the transcription of the dialogue (or conversation) between the user and the DA from the first instance of the DA user interface is partially displayed in box 524. For example, in FIG. 5M, a further portion of the transcript of the dialogue from the first instance of the DA user interface is displayed in response to the dragging gesture illustrated in FIG. 5L.

In some embodiments, the electronic device (620): stores context data (sometimes herein called “contextual information” or “context information”) associated with the first dialogue in a context history of the digital assistant; determines whether the request to invoke the digital assistant satisfies a first predetermined condition; and in accordance with a determination that the request to invoke the digital assistant satisfies the first predetermined condition, uses the stored context data while displaying the second instance of the digital assistant user interface. For example, while in the first instance of the DA user interface, a user asks the DA, “What's the weather in New York City,” receives a response, and exits the first instance of the DA user interface. Thereafter, the user invokes a second instance of the DA and asks the DA, “How about in San Francisco.” In this example, the DA stores the weather topic (or context) from the first instance of the DA user interface in the DA's context history for the user and utilizes the weather context in the context history when responding to the user's question in the second instance of the DA user interface as long as the request to invoke the second instance of the DA satisfies a first predetermined condition.

In another example, while in the first instance of the DA user interface, a user asks the DA, “What is the weather in New York City,” receives a response, and exits the first instance of the DA user interface. Thereafter, the user invokes a second instance of the DA and asks the DA, “Show me pizzerias.” In this example, the DA stores the geographic (e.g., New York City) context from the first instance of the DA user interface in the DA's context history for the user and utilizes the geographic context in the context history when responding to the user's question in the second instance of the DA user interface as long as the request to invoke the second instance of the DA satisfies a first predetermined condition.

In some embodiments, the first predetermined condition is satisfied (622) when the request to invoke the digital assistant is received within a predetermined context expiration time period. For example, while in the first instance of the DA user interface, user device 104 stores contextual information corresponding to the dialogue related to the weather context displayed in FIG. 5I. Then, in response to a request to invoke a second instance of the DA (e.g., a long press over home button 509 with user touch input 526 in FIG. 5J), user device 104 displays a second instance of the DA user interface in FIG. 5K. FIG. 5K, for example, shows the device determining whether the request to invoke the second instance of the DA satisfies a predetermined context expiration time period. In some embodiments, the predetermined context expiration time period is satisfied when the request to invoke the second instance of the DA occurs within sixty seconds of exiting the first instance of the DA. For example, in FIG. 5K, context expiration timer 527 shows that the request to invoke the second instance of the DA occurred approximately thirty seconds after exiting the first instance of the DA user interface.

In the second instance of the DA user interface, for example, the user asks the DA, “What about in Paris France?” FIG. 5L, for example, shows the DA's response to the user's question stating, “It's currently 65° in Paris France.” The DA responds to the user's question with the aid of contextual information from the first instance of the DA user interface (e.g., weather topic or context).

In some embodiments, the electronic device deletes (624) the context data associated with the first dialogue from the context history upon expiration of the predetermined context expiration time period. In some embodiments, the predetermined context expiration time period expires about sixty seconds after the user device exits the first instance of the DA. For example, in FIG. 5Q, context expiration timer 527 indicates that the request to invoke the second instance of the DA occurred more than sixty seconds after exiting the first instance of the DA user interface.

In the second instance of the DA user interface, for example, the user asks the DA, “What about in Paris France?” FIG. 5R, for example, shows the DA responding to the user's question by stating, “Would you like me to search the web for ‘What about in Paris France’?” and displaying “search the web” button 545 which is configured to execute a web search for ‘What about in Paris France.’ In FIG. 5R, the DA does not infer that the user's question “What about in Paris France?” refers to weather because contextual information from the first instance of the DA user interface has been deleted from the context history due to the context expiration timer expiring prior to the invocation of the second instance of the DA.

In some embodiments, the first predetermined condition is not satisfied (626) when the electronic device is locked. In some embodiments, contextual information from a previous instance of a DA user interface does not persist when the device is locked. Even though the DA can be accessed while the device is locked, context and conversation information does not persist from a previous instance of the DA user interface. Typically, this is for security or privacy reasons because a user of user device 104 may not want context or conversation information from a previous instance of the DA user interface to be available to a third party who cannot unlock user device 104.

FIG. 5W, for example, shows a user invoking the DA while user device 104 is in a locked mode. Then, in response to a request to invoke a second instance of the DA (e.g., a long press over home button 509 with user touch input 552 in FIG. 5W), user device 104 displays a second instance of the DA user interface in FIG. 5X. FIG. 5X, for example, shows the device determining whether the request to invoke the second instance of the DA satisfies a first predetermined condition. For example, in FIG. 5X, context expiration timer 527 shows that the request to invoke the second instance of the DA occurred approximately thirty seconds after exiting the first instance of the DA user interface. In the second instance of the DA user interface, for example, the user asks the DA “What about in Budapest?” FIG. 5Y, for example, shows the DA responding to the user's question by stating, “Would you like me to search the web for ‘What about in Budapest’?” and displaying “search the web” button 556, which is configured to execute a web search for ‘What about in Budapest.’ In FIG. 5Y, the DA does not infer that the user's question “What about in Budapest?” refers to weather because contextual information from the first instance of the DA user interface has been excluded from the context history because the second instance of the DA was invoked while user device 104 was in the locked mode.

In some embodiments, the electronic device (628): determines whether the request to invoke the digital assistant satisfies a second predetermined condition; in accordance with a determination that the request to invoke the digital assistant satisfies the second predetermined condition, displays the second instance of the digital assistant user interface, including displaying the second dialogue in the second instance of the digital assistant user interface, where the first dialogue remains available for display in the second instance of the digital assistant user interface; and in accordance with a determination that the request to invoke the digital assistant does not satisfy the second predetermined condition, displays the second instance of the digital assistant user interface without making the first dialogue available for display in the second instance of the digital assistant user interface. In a first example, in response to a request to invoke a second instance of the DA (e.g., a long press over home button 509 with user touch input 526 in FIG. 5J), user device 104 displays a second instance of the DA user interface in FIG. 5Q. FIG. 5Q, for example, shows the user device 104 determining whether the request to invoke the second instance of the DA satisfies a second predetermined condition. In some embodiments, the second predetermined condition is satisfied when the request to invoke the second instance of the DA occurs within eight minutes of exiting the first instance of the DA. In FIG. 5Q, conversation expiration timer 528 indicates that the request to invoke the second instance of the DA occurred approximately two minutes after exiting the first instance of the DA user interface. FIG. 5R, for example, shows user device 104 displaying the second instance of the DA user interface including “see older” button 541 configured to display at least a portion of the transcript of the dialogue from the first instance of the DA user interface in accordance with the determination that the second predetermined condition is satisfied.

In a second example, in response to a request to invoke a second instance of the DA (e.g., a long press over home button 509 with user touch input 526 in FIG. 5J), user device 104 displays a second instance of the DA user interface in FIG. 5T. FIG. 5T, for example, shows the user device 104 determining whether the request to invoke the second instance of the DA satisfies a second predetermined condition (e.g., an eight minute time period). In FIG. 5T, conversation expiration timer 528 indicates that the request to invoke the second instance of the DA occurred more than eight minutes after exiting the first instance of the DA user interface. FIG. 5T, for example, shows user device 104 displaying the second instance of the DA user interface where a transcript of the dialogue (or conversation) between the user and the DA from the first instance of the DA user interface is not available for display.

In some embodiments, the second predetermined condition is satisfied (630) when the request to invoke the digital assistant is received within a predetermined conversation expiration time period. In some embodiments, the conversation expiration time period begins once the user exits the first instance of the DA user interface. In some embodiments, the conversation expiration time period is a predetermined amount of time (e.g., 3, 5, 8, 10, 15, or 30 minutes). Typically, the conversation expiration time period is 8 minutes. In some other embodiments, the conversation expiration time period is a user defined time period.

In some embodiments, the electronic device (632): stores context data associated with the first dialogue in a context history of the digital assistant; determines whether the request to invoke the digital assistant satisfies a first predetermined condition, where the first predetermined condition is satisfied if the request to invoke the digital assistant is received within a predetermined context expiration time period; in accordance with a determination that the request to invoke the digital assistant satisfies the first predetermined condition, uses the stored context data while displaying the second instance of the digital assistant user interface; and deletes the context data associated with the first dialogue from the context history upon expiration of the predetermined context expiration time period, where the predetermined context expiration time period is shorter than the predetermined dialogue expiration time period. In some embodiments, the displayed dialogue is not tied to the context data stored in a context history (e.g., stored on a remote server). Typically, the context expiration time period is sixty seconds and the conversation expiration time period is eight minutes.

In one example, in response to a request to invoke a second instance of the DA (e.g., a long press over home button 509 with user touch input 526 in FIG. 5J), user device 104 displays a second instance of the DA user interface in FIG. 5Q. FIG. 5Q, for example, shows the user device 104 determining whether the request to invoke the second instance of the DA satisfies a predetermined context expiration time period and a predetermined conversation expiration time period. For example, the predetermined context expiration time period is satisfied when the request to invoke the second instance of the DA occurs within sixty seconds of exiting the first instance of the DA user interface, and the predetermined conversation expiration time period is satisfied when the request to invoke the second instance of the DA occurs within eight minutes of exiting the first instance of the DA user interface. In FIG. 5Q, context expiration timer 527 indicates that the request to invoke the second instance of the DA occurred more than sixty seconds after exiting the first instance of the DA user interface, and conversation expiration timer 528 indicates that the request to invoke the second instance of the DA occurred approximately two minutes after exiting the first instance of the DA user interface.

In the second instance of the DA user interface, for example, the user asks the DA “What about in Paris France?” FIG. 5R, for example, shows the DA responding to the user's question by stating “Would you like me to search the web for ‘What about in Paris France’?” and displaying “search the web” button 545 which is configured to execute a web search for ‘What about in Paris France.’ In FIG. 5R, the DA does not infer that the user's question refers to weather because contextual information from the first instance of the DA user interface has been deleted from the context history in accordance with a determination that the context expiration timer expired before the second instance of the DA was invoked. On the other hand, FIG. 5R, for example, shows user device 104 displaying the second instance of the DA user interface including “see older” button 541 configured to display at least a portion of the transcript of the dialogue from the first instance of the DA user interface in accordance with the determination that the conversation expiration timer has not expired.

In some embodiments, the second predetermined condition is not satisfied (634) when the electronic device is locked. In some embodiments, conversation information (or a portion of the dialogue) from a previous instance of a DA user interface does not persist when the device is locked (e.g., for security reasons). Even though the DA can be accessed while the device is locked, context and conversation information does not persist from a previous instance of the DA user interface. However, if the user device enters a locked state, the user subsequently unlocks the user device, and the user invokes a second instance the DA within conversation expiration time period, then context and conversation information persist in the second instance of the DA.

For example, after user device 104 displays a first instance of the DA user interface in FIG. 5I, user device enters a locked state as shown in FIG. 5W. As shown in FIGS. 5X-Y, context and conversation information do not persist while the device is locked even though an instance of the DA is invoked before both context expiration timer 527 and conversation expiration timer 528 have expired. After exiting the DA user interface in response to user touch input 557 over home button 509 in FIG. 5Y, FIG. 5Z shows the user unlocking user device 104 via a dragging gesture, and FIG. 5BB shows user device 104 invoking a second instance of a digital assistant in response to the long press with user touch input 559 over home button 509 in FIG. 5AA. In this example, FIG. 5BB further shows that the invocation of the second instance of a digital assistant occurs approximately fifty seconds after exiting the first instance of the DA user interface in response to user touch input 525 over home button 509 in FIG. 5I. Therefore, neither context expiration timer 527 nor conversation expiration timer 528 has expired, and both context and conversation information from the first instance of the DA user interface persists in the second instance of the DA user interface as shown in FIG. 5CC.

In some embodiments, the second predetermined condition comprises a condition that is satisfied (636) when the request to invoke the digital assistant is received prior to detection of a predetermined number of user interactions (e.g., touch events or user-requested application changes) with the electronic device after displaying the first dialogue. In some embodiments, the conversation expiration timer (e.g., conversation time-out), discussed above, and a predetermined number of touch events (e.g., conversation touch-out) are alternative sufficient conditions for not displaying a portion of the conversation (or dialogue) from the first instance of the DA user interface in the second instance of the DA user interface.

In some embodiments, the electronic device (638): displays a first affordance (affordances are sometimes herein called user interface objects or buttons) in the second instance of the digital assistant user interface (e.g., a “see more” button or an “older” button); detects a user selection of the first affordance; and in response to the user selection of the first affordance, displays at least a portion of the first dialogue in the second instance of the digital assistant user interface. FIG. 5R, for example, shows a “see older” button 541 displayed in the second instance of the DA user interface. FIG. 5R, for example, also shows user device 104 detecting a user touch input 546 over “see older” button 541. FIG. 5S, for example, shows user device 104 displaying, in the second instance of the DA user interface, at least a portion of the transcript of the dialogue from the first instance of the DA user interface in response to user touch input 546 over “see older” button 541 in FIG. 5R.

In some embodiments, the electronic device displays (640) at least a portion of the first dialogue in the second instance of the digital assistant user interface. In some embodiments, the last line or a fraction of the first dialogue (e.g., a peek through) is displayed at the top of the screen or underneath a semi-transparent top banner (e.g., the top banner includes a carrier, signal strength, battery life and time). For example, in FIG. 5L, a portion of the transcription of the dialogue (or conversation) between the user and the DA from the first instance of the DA user interface is partially displayed in box 524.

In some embodiments, the second dialogue includes (642) a user query to the digital assistant, and the electronic device: stores context data associated with the first dialogue in a context history of the digital assistant; and while displaying the second instance of the digital assistant user interface, and in accordance with a determination that a predetermined context condition has been satisfied, responds to the user query to the digital assistant, in accordance with a determination that a predetermined context condition has been satisfied, using the stored context data while determining a response to the user query. In a first instance of a DA user interface, FIG. 5I, for example, shows the user asking the DA, “What's the temperature in Charleston South Carolina,” transcribed in box 523. In response to user query 523, the DA responds stating, “It's currently 80° in Charleston, SC,” as transcribed in box 524 in FIG. 5I. For example, user device 104 stores contextual information corresponding to a weather topic or context for user request 523 and the DA's response 524 in FIG. 5I.

FIG. 5J, for example, shows user device 104 displaying a home screen in user interface 503 (e.g., including application icons 504a, 504b, 504c, 504d, 504c, 504f, 504g, 504h, 504i, 504j and tray icons 506a, 506b, 506c, 506d) in response to detecting user touch input 525 over home button 509 in FIG. 5I. FIG. 5DD, for example, shows user device 104 displaying a second instance of a digital assistant (DA) in user interface 503 in response to a long press with user touch input 526 over home button 509 in FIG. 5J. FIG. 5GG, for example, shows the second instance of the DA user interface including a user query (e.g., “What about in Paris France” transcribed in box 569).

FIG. 5GG, for example, shows the DA using the stored contextual information corresponding to the weather topic from the first instance of the DA user interface when responding to user query 569 by stating, “It's currently 65° in Paris France,” transcribed in box 570. In FIG. 5GG, the DA uses contextual information from the first instance of the DA user interface when responding to user query 569 in accordance with a determination that a predetermined context condition has been satisfied.

In some embodiments, the predetermined context condition is satisfied (644) when, in response to a user action performed during display of the second instance of the digital assistant user interface, at least a portion of the first dialogue is displayed in the second instance of the digital assistant user interface. In one example, FIG. 5FF shows user device 104 displaying boxes 523 and 524 (e.g., a user query and the DA's response to the user query, respectively) corresponding to a portion of a first dialogue from the first instance of the DA user interface in user interface 503 in response to detecting the dragging gesture in FIG. 5EE. FIG. 5GG, for example, further shows the DA invoking contextual information from the first instance of the DA user interface (e.g., the weather topic or context) when responding to user query 569 in accordance with a determination that at least a portion (e.g., boxes 523 and 524) of the first dialogue is displayed in the second instance of the digital assistant user interface (e.g., boxes 523 and 524) in response to a user action (e.g., the dragging gesture detected in FIG. 5EE). For example, the DA responds to the user's query “What about in Paris France?” by using the weather topic from the first instance of the DA user interface and stating “It's currently 65° in Paris France.”

In another example, FIG. 5II shows user device 104 displaying boxes 523 and 524 (e.g., a user query and the DA's response to the user query, respectively) corresponding to a portion of a first dialogue from the first instance of the DA user interface in user interface 503 in response to detecting user touch input 573 over “see older” button 572 on touch screen 112 in FIG. 5HH. FIG. 5JJ, for example, further shows the DA invoking contextual information from the first instance of the DA user interface (e.g., the weather topic or context) when responding to user query 575 in accordance with a determination that at least a portion of the first dialogue is displayed in the second instance of the digital assistant user interface (e.g., boxes 523 and 524) in response to a user action (e.g., user touch input 573 detected in FIG. 5HH). For example, the DA responds to the user's query “What about in Paris France?” by using the weather topic from the first instance of the DA user interface and stating “It's currently 65° in Paris France.”

In a further example, FIG. 5EE shows user device 104 displaying a transcription of the second dialogue in the second instance of the DA user interface (e.g., the DA's prompt 563, user query 564, and the DA's response 565, 566 to user query 564) and a portion of the transcription of the first dialogue (or conversation) between the user and the DA from the first instance of the DA user interface in box 524. However, FIG. 5EE, for example, shows the that the DA does not invoke contextual information from the first instance of the DA user interface (e.g., the weather topic or context) when responding to user query 564 because user device 104 has not detected a user action (e.g., a tap or swipe gesture on touch screen 112) to display at least a portion of the first dialogue between the DA and the user from the first instance of the DA user interface at or before receiving user query 564. Instead, in FIG. 5EE, the DA responds to user query 564 by stating, “Would you like me to search the web for ‘What about in Paris France’?” because the DA does not infer that user request 564 is related to weather. The second instance of the DA user interface also displays a “search the web” button 545 which is configured to execute a web search for ‘What about in Paris France.’

In some embodiments, the electronic device (646): displays a second affordance corresponding to a respective sub-portion of the first dialogue (e.g., a sub-portion is an idea/topic, sentence, phrase, or word); detects a user selection of the second affordance; and in response to the user selection of the second affordance, ceases to display at least some of the respective sub-portion of the first dialogue. In some embodiments, a collapsible directory-like structure is provided in the second instance of the DA user interface whereby a user is enabled to minimize portions of the displayed dialogue. However, after minimization of a respective sub-portion, a title/topic name for the respective sub-portion remains displayed. FIG. 5N, for example, shows user device 104 displaying the transcription of the dialogue from the first and second instances of the DA user interface divided into a dining topic 532 and a weather topic 533. Button 535 is configured to minimize weather topic 533 to cease to display the portion of the dialogue from the first and second instances of the DA user interface related to weather. FIG. 5O, for example, shows user device 104 minimizing weather topic 533 in response to user touch input 536 over button 535 in FIG. 5N. FIG. 5O, for example, shows user device 104 ceasing to display at least some of weather topic 533.

In some embodiments, in response to the user selection of the second affordance, the electronic device excludes (648) context data associated with the sub-portion of the first dialogue from a context history of the digital assistant. In some embodiments, when a user minimizes a sub-portion of the first dialogue, contextual information corresponding to that sub-portion is not utilized when the DA infers user intent for a subsequent request. After the user minimizes weather topic 533 in FIG. 5N, FIG. 5P, for example, shows the DA responding to the user's question, “What about in Munich?” The DA responds to the user's question by stating, “Would you like me to search the web for ‘What about Munich’?” Furthermore, a “search the web” button 540, which is configured to execute a web search for ‘What about in Munich’ is also displayed. In FIG. 5P, for example, the DA fails to infer that the user's question refers to weather even though the user's previous questions concerned weather. The DA does not infer the “weather” topic because contextual information related to weather topic 533 has been excluded from context history in response to user touch input 536 minimizing (or collapsing) weather topic 533 in FIG. 5N.

It should be understood that the particular order in which the operations in FIGS. 6A-D have been described is merely exemplary and is not intended to indicate that the described order is the only order in which the operations could be performed. One of ordinary skill in the art would recognize various ways to reorder the operations described herein.

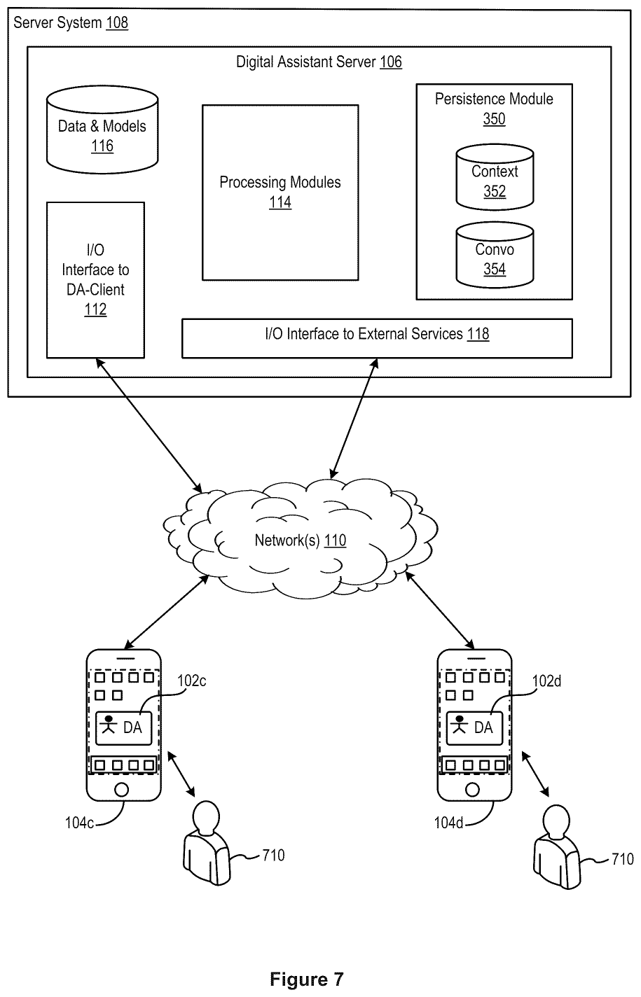

FIG. 7 illustrates a block diagram of a system including two or more electronic devices for enabling context and/or conversation persistence in accordance with some embodiments. In some embodiments, the multi-device system illustrated in FIG. 7 is configured to execute the functions described in FIGS. 6A-D with reference to a single device. Devices 104c and 104d are distinct devices that are both associated with user 710. In some embodiments, a first instance of a DA includes a dialogue between user 710 and DA-client 102c on device 104c. During the first instance of the DA user interface, context and conversation information related to the dialogue between user 710 and DA-client 102c is stored in context history 352 and conversation history 354, respectively, of persistence module 350. In some embodiments, persistence module 350 is a component of server system 108. Furthermore, in some implementations, DA 326 stores context history 352 and conversation history 354 on a per-user basis, and thus the same context history 352 and conversation history 354 of a respective user 710 is available to DA 326 for use when providing services to user 710, regardless of which device 104 (of the devices associated with the user 710) user 710 is currently using.

In some embodiments, after user 710 exits the first instance of the DA on device 104c, user 710 invokes a second instance of the DA on device 104d. The second instance of the DA includes a dialogue between user 710 and DA-client 102d. In some embodiments, during the second instance of the DA, DA-client 102d is enabled to access context and conversation information from the first instance of the DA that is stored in server system 108. In some embodiments, DA-client 102d is enabled to utilize the stored context information for intent inference and the stored conversation information for display in the second instance of the DA.

Although FIG. 7 does not explicitly show the communication interfaces between all components of the DA-server 106, it is to be understood that the components shown in FIG. 7 are capable of communicating with other components of the DA-server 106 either directly or through one or more other interfaces, such as application programming interfaces (APIs), database query interfaces, and/or other interfaces, protocols, and/or communication channels.

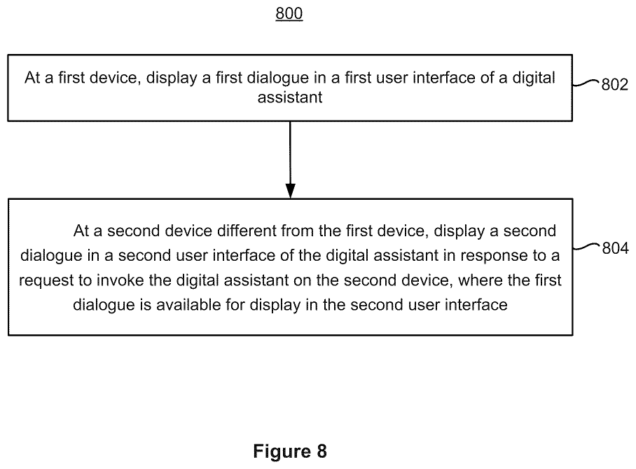

FIG. 8 illustrates a flow diagram of a method 800 of operating a digital assistant in accordance with some embodiments. In some embodiments, method 800 is performed at two or more electronic devices each including a display, one or more processors and memory (e.g., a respective DA-client 102 or DA-server 106). In some embodiments, method 800 is performed at the digital assistant 326 illustrated in FIGS. 3A-B and 4. In some embodiments, method 800 is governed by a set of instructions stored in memory (e.g., a non-transitory computer readable storage medium) that are executed by the one or more processors of an electronic device.

At a first device, the first device displays (802) a first dialogue in a first user interface of a digital assistant. For example, device 104c, shown in FIG. 7, is configured to display a first dialogue between user 710 and DA-client 102c in a first user interface of the DA.

At a second device different from the first device, in response to a request to invoke the digital assistant on the second device, the second device displays (804) a second dialogue in a second user interface of the digital assistant, where the first dialogue is available for display in the second user interface. For example, in response to a request from user 710 to invoke the DA on device 104d, device 104d, shown in FIG. 7, is configured to display a second dialogue between user 710 and DA-client 102d. In some embodiments, the second dialogue between user 710 and DA-client 102d is displayed on device 104d at the same time or a later time as the first dialogue between user 710 and DA-client 102c is displayed on device 104c. DA-client 702d is configured to have access to conversation information from the first dialogue between the same user 710 and DA-client 102c stored in conversation history 354 of server system 108 so as to display at least a portion the first dialogue. DA-client 702d is further configured to have access to contextual information from the first dialogue between user 710 and DA-client 102c stored in conversation history 352 of server system 108 for use in intent inference.

It should be understood that the particular order in which the operations in FIG. 8 have been described is merely exemplary and is not intended to indicate that the described order is the only order in which the operations could be performed. One of ordinary skill in the art would recognize various ways to reorder the operations described herein.

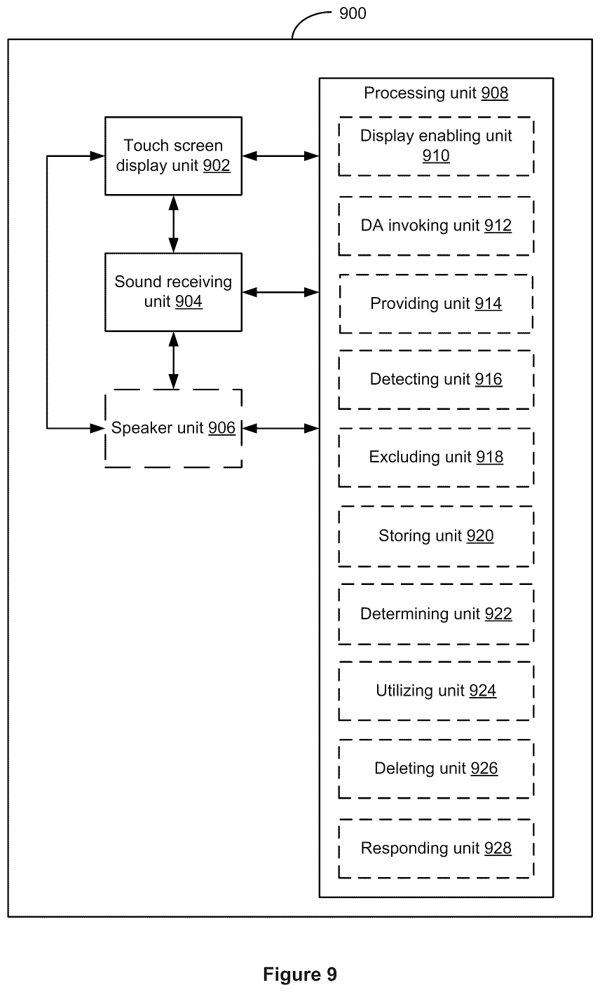

In accordance with some embodiments, FIG. 9 shows a functional block diagram of an electronic device 900 configured in accordance with the principles of the various described embodiments. The functional blocks of the device are, optionally, implemented by hardware, software, or a combination of hardware and software to carry out the principles of the various described embodiments. It is understood by persons of skill in the art that the functional blocks described in FIG. 9 are, optionally, combined or separated into sub-blocks to implement the principles of the various described embodiments. Therefore, the description herein optionally supports any possible combination or separation or further definition of the functional blocks described herein.

As shown in FIG. 9, an electronic device 900 includes a touch screen display unit 902 configured to display a user interface and to receive touch input, and a sound receiving unit 904 configured to receive sound input. In some embodiments, electronic device 900, optionally, includes a speaker unit 906 configured to generate sound. Electronic device 900 also includes a processing unit 908 coupled to touch screen display unit 902 and sound receiving unit 904 (and, optionally, coupled to speaker unit 906). In some embodiments, processing unit 908 includes a display enabling unit 910, a digital assistant (DA) invoking unit 912, a providing unit 914, a detecting unit 916, an excluding unit 918, a storing unit 920, a determining unit 922, a utilizing unit 924, a deleting unit 926, and a responding unit 928.

Processing unit 908 is configured to enable display of (e.g., with display enabling unit 910) a first dialogue in a first instance of a digital assistant user interface on touch screen display unit 902. In response to a request to enable display of a user interface different from the digital assistant user interface, processing unit 908 is configured to enable display of (e.g., with display enabling unit 910) the user interface different from the digital assistant user interface on touch screen display unit 902. In response to a request to invoke the digital assistant, processing unit 908 is further configured to enable display of (e.g., with display enabling unit 910) a second instance of the digital assistant user interface on touch screen display unit 902, including enabling display of a second dialogue in the second instance of the digital assistant user interface, where the first dialogue remains available for display in the second instance of the digital assistant user interface.

In some embodiments, prior to enabling display of the first instance of the digital assistant user interface, processing unit 908 is further configured to detect (e.g., with DA invoking unit 912) a prior request to invoke the digital assistant. Prior to enabling display of the first instance of the digital assistant user interface, sound receiving unit 904 is configured to detect a speech input. Prior to enabling display of the first instance of the digital assistant user interface, processing unit 908 is further configured to provide (e.g., with providing unit 914) a transcription of the speech input, where the first dialogue includes the transcription of the speech input.

In some embodiments, in response to the request to enable display of the user interface different from the digital assistant user interface, processing unit 908 is configured to cease display (e.g., with display enabling unit 910) of the digital assistant user interface on touch screen display unit 902.

In some embodiments, processing unit 908 is configured to: enable display (e.g., with display enabling unit 910) of a first affordance in the second instance of the digital assistant user interface on touch screen display unit 902; detect (e.g., with detecting unit 916) a user selection of the first affordance on the touch screen display unit 902; and in response to the user selection of the first affordance, processing unit 908 is configured to enable display (e.g., with display enabling unit 910) of at least a portion of the first dialogue in the second instance of the digital assistant user interface on touch screen display unit 902.

In some embodiments, processing unit 908 is configured to enable display (e.g., with display enabling unit 910) of at least a portion of the first dialogue in the second instance of the digital assistant user interface on touch screen display unit 902.

In some embodiments, processing unit 908 is configured to enable display (e.g., with display enabling unit 910) of a second affordance corresponding to a respective sub-portion of the first dialogue on touch screen display unit 902; detect (e.g., with detecting unit 916) a user selection of the second affordance on touch screen display unit 902; and in response to the user selection of the second affordance, cease display (e.g., with display enabling unit 910) of at least some of the respective sub-portion of the first dialogue on touch screen display unit 902.

In some embodiments, in response to the user selection of the second affordance, processing unit 908 is configured to exclude (e.g., with excluding unit 918) context data associated with the sub-portion of the first dialogue from a context history of the digital assistant.

In some embodiments, processing unit 908 is configured to: store (e.g., with storing unit 920) context data associated with the first dialogue in a context history of the digital assistant; determine (e.g., with determining unit 922) whether the request to invoke the digital assistant satisfies a first predetermined condition; and in accordance with a determination that the request to invoke the digital assistant satisfies the first predetermined condition, use (e.g., with utilizing unit 924) the stored context data while enabling display of the second instance of the digital assistant user interface.

In some embodiments, the first predetermined condition is satisfied when the request to invoke the digital assistant is received within a predetermined context expiration time period.

In some embodiments, processing unit 908 is configured to delete (e.g., with deleting unit 926) the context data associated with the first dialogue from the context history upon expiration of the predetermined context expiration time period.

In some embodiments, the first predetermined condition is not satisfied when the electronic device is locked.

In some embodiments, the second dialogue includes a user query to the digital assistant, and processing unit 908 is configured to: store (e.g., with storing unit 920) context data associated with the first dialogue in a context history of the digital assistant; and while displaying the second instance of the digital assistant user interface, respond (e.g., with responding unit 928) to the user query to the digital assistant, in accordance with a determination that a predetermined context condition has been satisfied, using the stored context data while determining a response to the user query.

In some embodiments, the predetermined context condition is satisfied when, in response to a user action performed during display of the second instance of the digital assistant user interface, at least a portion of the first dialogue is displayed in the second instance of the digital assistant user interface.

In some embodiments, processing unit 908 is configured to: determine (e.g., with determining unit 922) whether the request to invoke the digital assistant satisfies a second predetermined condition; in accordance with a determination that the request to invoke the digital assistant satisfies the second predetermined condition, enable display (e.g., with display enabling unit 910) of the second instance of the digital assistant user interface on touch screen display unit 902, including enabling display of the second dialogue in the second instance of the digital assistant user interface, where the first dialogue remains available for display in the second instance of the digital assistant user interface; and in accordance with a determination that the request to invoke the digital assistant does not satisfy the second predetermined condition, enable display (e.g., with display enabling unit 910) of the second instance of the digital assistant user interface without making the first dialogue available for display on touch screen display unit 902.

In some embodiments, the second predetermined condition is satisfied when the request to invoke the digital assistant is received within a predetermined conversation expiration time period.

In some embodiments, processing unit 908 is configured to: store (e.g., with storing unit 920) context data associated with the first dialogue in a context history of the digital assistant; determine (e.g., with determining unit 922) whether the request to invoke the digital assistant satisfies a first predetermined condition, where the first predetermined condition is satisfied when the request to invoke the digital assistant is received within a predetermined context expiration time period; in accordance with a determination that the request to invoke the digital assistant satisfies the first predetermined condition, use (e.g., with utilizing unit 924) the stored context data while displaying the second instance of the digital assistant user interface; and delete (e.g., with deleting unit 926) the context data associated with the first dialogue from the context history upon expiration of the predetermined context expiration time period, where the predetermined context expiration time period is shorter than the predetermined conversation expiration time period.

In some embodiments, the second predetermined condition is not satisfied when electronic device 900 is locked.

In some embodiments, the second predetermined condition comprises a condition that is satisfied when the request to invoke the digital assistant is received prior to detection of a predetermined number of user interactions with the electronic device after displaying the first dialogue.

In some embodiments, the request to display the user interface different from the digital assistant user interface corresponds to a user input to display the user interface different from the digital assistant user interface.

In some embodiments, the user input to display the user interface different from the digital assistant user interface corresponds to a request to launch an application.

In some embodiments, the user interface different from the digital assistant user interface does not correspond to the digital assistant.

In some embodiments, the user interface different from the digital assistant user interface is associated with an application distinct from the digital assistant.

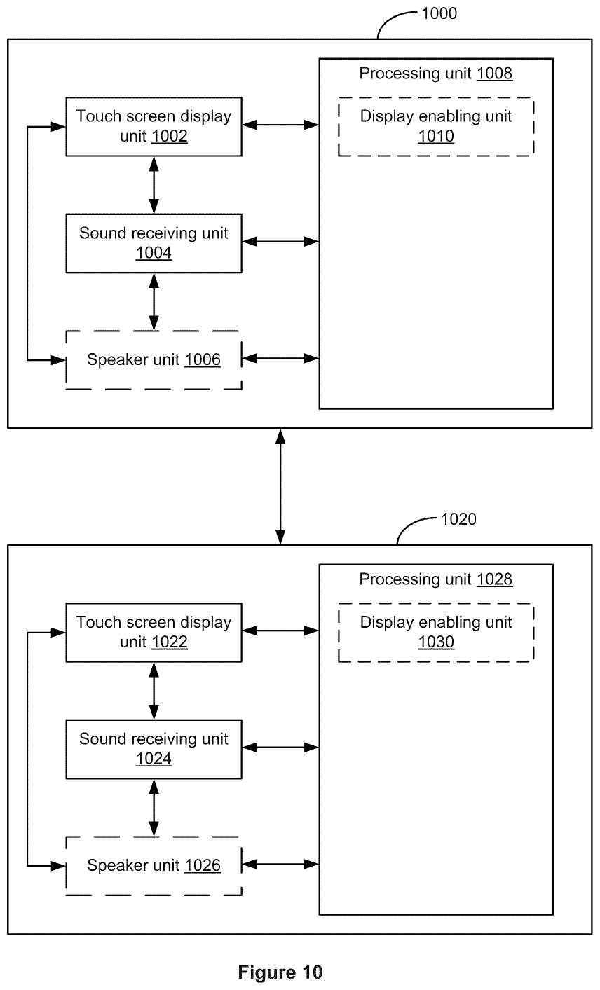

In accordance with some embodiments, FIG. 10 shows a functional block diagram of a first electronic device 1000 and a second electronic device 1020 configured in accordance with the principles of the various described embodiments. The functional blocks of the device are, optionally, implemented by hardware, software, or a combination of hardware and software to carry out the principles of the various described embodiments. It is understood by persons of skill in the art that the functional blocks described in FIG. 10 are, optionally, combined or separated into sub-blocks to implement the principles of the various described embodiments. Therefore, the description herein optionally supports any possible combination or separation or further definition of the functional blocks described herein.

As shown in FIG. 10, a first electronic device 1000 includes a touch screen display unit 1002 configured to display a user interface and to receive touch input, and a sound receiving unit 1004 configured to receive sound input. In some embodiments, first electronic device 1000, optionally, includes a speaker unit 1006 configured to generate sound. First electronic device 1000 also includes a processing unit 1008 coupled to touch screen display unit 1002 and sound receiving unit 1004 (and, optionally, coupled to speaker unit 1006). In some embodiments, processing unit 1008 includes a display enabling unit 1010.

A second electronic device 1020 includes a touch screen display unit 1022 configured to display a user interface and to receive touch input, and a sound receiving unit 1024 configured to receive sound input. In some embodiments, second electronic device 1020, optionally, includes a speaker unit 1026 configured to generate sound. Second electronic device 1020 also includes a processing unit 1028 coupled to touch screen display unit 1022 and sound receiving unit 1024 (and, optionally, coupled to speaker unit 1026). In some embodiments, processing unit 1028 includes a display enabling unit 1030.

Processing unit 1008 of first electronic device 1000 is configured to enable display (e.g., with display enabling unit 1010) of a first dialogue in a first user interface of a digital assistant on touch screen display unit 1002. In response to a request to invoke the digital assistant on second electronic device 1020, processing unit 1028 of second electronic device 1020 is configured to enable display of (e.g., with display enabling unit 1030) a second dialogue in a second user interface of the digital assistant on touch screen display unit 1022, where the first dialogue is available for display in the second user interface.

The foregoing description, for purpose of explanation, has been described with reference to specific implementations. However, the illustrative discussions above are not intended to be exhaustive or to limit the disclosed implementations to the precise forms disclosed. Many modifications and variations are possible in view of the above teachings. The implementations were chosen and described in order to best explain the principles and practical applications of the disclosed ideas, to thereby enable others skilled in the art to best utilize them with various modifications as are suited to the particular use contemplated.

Although the terms “first,” “second,” etc. may be used herein to describe various elements, these elements should not be limited by these terms. These terms are only used to distinguish one element from another. For example, a first speech input could be termed a second speech input, and, similarly, a second speech input could be termed a first speech input, without changing the meaning of the description, so long as all occurrences of the “first speech input” are renamed consistently and all occurrences of the “second speech input” are renamed consistently. The first speech input and the second speech input are both speech inputs, but they are not the same speech input.

The terminology used herein is for the purpose of describing particular implementations only and is not intended to be limiting of the claims. As used in the description of the implementations and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “upon a determination that” or “in response to determining” or “in accordance with a determination” or “upon detecting” or “in response to detecting” that the stated condition precedent is true, depending on the context.

1. (canceled)

2. A method, comprising:
at an electronic device:
while displaying a first user interface, receiving a user request to initiate an interactive session;
in response to receiving the user request to initiate the interactive session, initiating a current interactive session of an interactive user interface, including:
displaying the interactive user interface, different from the first user interface; and
obtaining a user input including a query;
determining whether the user request satisfies a first predetermined condition, wherein:
the user request to initiate the interactive session satisfies the first predetermined condition if the user request is received within a predetermined duration after a previous interactive session of the interactive user interface ends; and
the previous interactive session of the interactive user interface ends by ceasing to display the interactive user interface; and
in accordance with a determination that the user request to initiate the interactive session-satisfies the first predetermined condition:
using context data from the previous interactive session to determine a response to the query; and
providing the response to the query.

3. The method of claim 2, wherein the previous interactive session was initiated on the electronic device prior to displaying the first user interface.

4. The method of claim 2, further comprising:
at the electronic device:
in accordance with a determination that the user request to initiate the interactive session does not satisfy the first predetermined condition:
determining a second response to the query without using the context data; and
providing the second response to the query.

5. The method of claim 2, wherein prior to displaying the first user interface, the electronic device causes the context data to be stored in a context history, and wherein the method further comprises:
at the electronic device:
in accordance with a determination that the user request to initiate the interactive session does not satisfy the first predetermined condition, causing the stored context data to be removed from the context history.

6. The method of claim 2, wherein the user request to initiate the interactive session does not satisfy the first predetermined condition if the electronic device is in a locked state while receiving the user request to invoke the digital assistant.

7. The method of claim 2, further comprising:
at the electronic device:
determining whether the user request to initiate the interactive session satisfies a second predetermined condition; and
in accordance with a determination that the user request to initiate the interactive session satisfies the second predetermined condition:
enabling the displayed interactive user interface to display previous dialogue from the previous interactive session.

8. The method of claim 7, wherein the user request to initiate the interactive session satisfies the second predetermined condition if the user request is received within a second predetermined duration after the previous interactive session ends.

9. The method of claim 8, wherein the first predetermined duration is shorter than the second predetermined duration.

10. The method of claim 7, wherein prior to displaying the first user interface, the electronic device causes the previous dialogue to be stored in a conversation history, the method further comprising:
at the electronic device:
in accordance with a determination that the user request to initiate the interactive session does not satisfy the second predetermined condition, causing the previous dialog to be removed from the conversation history.

11. The method of claim 7, further comprising:
at the electronic device:
detecting user input via the displayed interactive user interface;
in accordance with detecting the user input and in accordance with the determination that the user request to initiate the interactive session satisfies the second predetermined condition, displaying the previous dialogue in the displayed interactive user interface.

12. The method of claim 11, further comprising:
at the electronic device:
while displaying the previous dialogue, receiving a user request to activate a microphone of the electronic device;
in accordance with receiving the user request to activate the microphone, obtaining second audio data containing a second spoken query;
in accordance with detecting the user input and in accordance with the determination that the user request to initiate the interactive session does not satisfy the first predetermined condition and satisfies the second predetermined condition:
using the context data from the previous interactive session to determine a response to the second query; and
providing, by the digital assistant, the response to the second query.

13. A non-transitory computer-readable storage medium storing instructions for operating a digital assistant, wherein the instructions, when executed by one or more processors of an electronic device, cause the electronic device to perform operations comprising:
while displaying a first user interface, receive a user request to initiate an interactive session;
in response to receiving the user request to initiate the interactive session, initiate a current interactive session of an interactive user interface, including:
display the interactive user interface, different from the first user interface; and
obtain a user input including a query;
determine whether the user request satisfies a first predetermined condition, wherein:
the user request to initiate the interactive session satisfies the first predetermined condition if the user request is received within a predetermined duration after a previous interactive session of the interactive user interface ends; and
the previous interactive session of the interactive user interface ends by ceasing to display the interactive user interface; and
in accordance with a determination that the user request to initiate the interactive session satisfies the first predetermined condition:
use context data from the previous interactive session to determine a response to the query; and
provide the response to the query.

14. An electronic device comprising:
one or more processors; and
memory storing instructions for operating a digital assistant, wherein the instructions, when executed by the one or more processors, cause the one or more processors to perform operations comprising:
while displaying a first user interface, receiving a user request to initiate an interactive session;
in response to receiving the user request to initiate the interactive session, initiating a current interactive session of an interactive user interface, including:
displaying the interactive user interface, different from the first user interface; and
obtaining a user input including a query;
determining whether the user request satisfies a first predetermined condition, wherein:
the user request to initiate the interactive session satisfies the first predetermined condition if the user request is received within a predetermined duration after a previous interactive session of the interactive user interface ends; and
the previous interactive session of the interactive user interface ends by ceasing to display the interactive user interface; and
in accordance with a determination that the user request to initiate the interactive session-satisfies the first predetermined condition:
using context data from the previous interactive session to determine a response to the query; and
providing the response to the query.
